(19) United States
(12) Patent Application Publication
(10) Pub. No.: US 2007/0079787 A1
(43) Pub. Date: Apr. 12, 2007

(54) Internal combustion engine

(76) Inventors: Peter Robert Raffaele, Killarney Heights (AU); Michael John Raffaele, Killarney Heights (AU)

Correspondence Address: GREENBERG TRAURIG, LLP, 77 WEST WACKER DRIVE, SUITE 2500, CHICAGO, IL, 60601-1732, US

(21) Appl. No.: 11/526,344

(22) Filed: Sep. 25, 2006

Related U.S. Application Data
(63) Continuation of application No. 10/381,953, filed on Aug. 22, 2003, now abandoned.

(30) Foreign Application Priority Data
Sep. 29, 2000 (AU) PR0456

(51) Int. Cl. F02F 3/00

(52) U.S. Cl. 123/193.6; 123/193.1

(57) ABSTRACT

The invention has many aspects. One aspect is that of an internal combustion engine (8010) that has a piston (8020) within a cylinder (8022) and has a crankcase (8012), defining a combustion chamber (8024) and crank volume (8026). A passageway (8032 and 8034) links the combustion chamber (8024) and the crank volume (8026). There is provided valve means (8038) for selectively closing the linking passageway and valve means (8030) for selectively closing and inlet to the crank volume (8026). In another aspect, there is an improvement to a scotch yoke fluid device. A displaceable member for relieving pressure in a variable volume chamber in the cylinder where combustion is occurring is provided. The invention includes a method of varying power output of a scotch yoke device, by choosing cylinder angle, pin angle and firing order in various ways. The invention also deals with other aspects of scotch yoke designs.

This application claims priority of the filing date of U.S. Ser. No. 10/381,953, presently pending, which is a US national phase application under 35 U.S.C. §371 of PCT/AU01/01214, filed Sep. 28, 2001, the complete disclosures of which are both hereby expressly incorporated herein by reference.

### BACKGROUND OF THE INVENTION

1. The Technical Field

This invention relates to different aspects of reciprocating fluid devices, including those colloquially called “scotch yoke” devices.

2. The Prior Art

Known scotch yoke devices include one or more pairs of horizontally opposed pistons reciprocating in respective cylinders. Each piston of a pair is rigidly attached to the other so the pair of pistons move as a single unit. The pistons reciprocate along parallel axes which may be coaxial or which may be offset. A crank is provided centrally of the pair of pistons with an offset mounted in a slider. The slider in turn is mounted in the piston assembly between opposing sliding surfaces, which extend perpendicularly to the axes of the pistons. The slider is thus constrained to move perpendicularly to the piston axes and so, as the crank rotates, the pistons are caused to reciprocate along the piston axis, with a true sinusoidal motion. In certain circumstances the provision of a true sinusoidal motion is preferable to the quasi-sinusoidal motion provided by a crank and connecting rod arrangement found in most internal combustion engines or pumps. However such devices have certain drawbacks. Neither the slider, which reciprocates in a vertical plane, nor the pistons, can be dynamically balanced by a rotating mass. Whilst this can be partially compensated for in a multi-pair device, this still leaves rocking couples.

Further in the conventional arrangement the slider slides between a single pair of opposed surfaces which lie on either side of the big end axis. The pistons must be arranged along parallel axes and the distance between the sliding surfaces of the slider and the guide surfaces of the pistons must be larger than the diameter of the big end on the crank.

The present invention aims to at least ameliorate some of the disadvantages of the prior art and, in preferred forms, provides devices in which paired pistons are not rigidly connected together, are not necessarily coaxial and in which better dynamic balancing is achieved. The invention also allows use of uneven numbers of pistons mounted on a single big end axis.

In one broad form the invention in effect decouples the pistons from each other and provides each piston with its own pair or group of sliding surfaces and its own slider. The sliding surfaces for each piston do not lie on either side of the big end axis but are positioned remote from the big end axis. The sliding surfaces may be compound surfaces. This decoupling means that each piston is not relying on the coupling with the other piston or pistons to move in both directions and allows each piston to move along a separate axis and at a different phase to all other pistons. Whilst pistons may be interconnected via a common linkage which carries the various sliding surfaces, the pistons are not rigidly connected together. Thus a V-configuration may be achieved with a pair of pistons or a 120° layout with three pistons, for instance.

### SUMMARY OF THE INVENTION

In one broad form the invention provides a fluid device, which includes:

a crank including a big end axis which orbits about a main axis;

connecting means rotatably mounted on the big end axis;

at least two pistons, each mounted for reciprocal motion in a respective cylinder along a respective piston axis which is perpendicular to the big end axis, each piston including guide means which engages a respective engagement means on the connecting means, said guide means including a pair of guide surfaces, the guide means of the pistons all being disposed on the same side of the big end axis.

Preferably, the guide means include surfaces which extend substantially perpendicularly to the respective piston axis. However, the guide surfaces may extend at other than 90° to the respective piston axis. Even when the guide surfaces are “perpendicular” to the piston axis, the guide surfaces may deviate from the perpendicular by up to 5° either way. The engagement means may be two or more parallel linear surfaces which correspond and slide relative to the guide surfaces. Alternatively, the engagement means may include two or more roller bearings or the like.

In an alternate form of the invention, the linear parallel opposed guide surfaces may be located on the connecting means and the engagement means may be mounted on the piston. In preferred forms there are two or three pistons mounted on slider means on each big end axis. The pistons may be arranged at equal angles about the main axis if desired.

The guide means may be integral with the piston or may be located on a separate structure attached to the piston. Where a separate structure is provided, it may be pivotably mounted to the piston, preferably using a gudgeon pin arrangement. This allows one to use conventional pistons with connecting rods incorporating the guide means.

The crankshaft may be fixed relative to the cylinders or may be movable so as to alter the compression ratio and/or the timing of the pistons in the cylinders. In a V configuration, movement of the crankshaft along the bisector of the included angle between the cylinders results in a change in compression ratio without any change in phase. An alternate arrangement provides for the crankshaft axis to rotate about a distant axis, so raising or lowering the crankshaft. These arrangements may be used with a single piston engine. If desired, the crank may be moveable in a plane perpendicular to at least one piston axis. In the case of an in-line engine, the crank may be moved up or down (relative to the line of pistons) to change compression.

When two pistoris per big end axis are utilized, the pistons may be arranged in a V-configuration. The V-configuration may be at any angle, such as 90°, 60°, 72° or any other desired angle. The number of pistons per big end axis is only constrained by physical size limitations. Each big end axis may have a single connecting means upon which multiple pistons are mounted or there may be a multiple connecting means mounted on each big end axis with each connecting means having an associated piston mounted upon it.

When multiple pistons are mounted to one big end axis, they may be located the same distance from the main axis or different pistons may be at different distances from the main axis. The pistons may be disposed axially around the big end axis, or may be offset from each other in this respect.

Whilst the guide means and complementary engagement means are preferably simple planar surfaces in cross section, other configurations may be possible.

The invention, in another broad form, also provides a fluid device, which includes:

a crank including a big end axis which orbits about a main axis;

connecting means rotatably mounted on the big end axis;

at least one piston mounted for reciprocal motion in a cylinder along a piston axis which is perpendicular to the big end axis, the at least one piston engaging an engagement means on the connecting means whereby the connecting means may have non-rotary movement relative to the at least one piston; and,

stabilizing means engaging the connecting means to limit the connecting means to a single orientation as it orbits the main axis.

The stabilizing means may include the engagement of the connecting means with the at least one piston. The stabilizing means may include a separate linkage pivotably mounted to both the connecting means and the crankcase.

The crank may be a simple crank with an offset big end axis or it may be a compound mechanism which provides for other than simple circular motion of the big end at a constant angular velocity. Examples of compound crank mechanisms are disclosed in PCT International Patent Application Nos. PCT/AU97/00030 and PCT/AU98/00287, the disclosures of which are incorporated herein.

The invention, in another broad form, also provides a fluid device, which includes:

a crank including a big end axis which orbits about a main axis;

connecting means rotatably mounted on the big end axis;

at least one piston mounted for reciprocal motion in a respective cylinder along a piston axis which is perpendicular to the big end axis, the at least one piston engaging engagement means on the connecting means;

wherein said main axis of the crank is movable along at least one path relative to said cylinder or cylinders and said engagement means is configured such that said at least one piston is neither substantially retarded or advanced.

Where the device includes pistons arranged in a V configuration, the main axis of the crank mechanism preferably moves along a linear path which bisects the included angle of the V. Alternatively, the main axis of the crank mechanism may move along an arc.

The invention, in another broad form, also provides a fluid device, which includes:

a crank including a big end axis which orbits about a main axis;

connecting means rotatably mounted on the big end axis; and

at least one piston mounted for reciprocal motion in a respective cylinder along a piston axis which is perpendicular to the big end axis, the at least one piston engaging engagement means on the connecting means;

wherein said connecting means has a centre of mass located on or adjacent to the big end axis.

Preferably the crank includes a counter weight which substantially and/or dynamically balances the mass of the connecting means relative to the crank axis.

The invention, in another broad form, also provides a fluid device, which includes:

a crank including a big end axis which orbits about a main axis;

connecting means rotatably mounted on the big end axis; and

at least one piston mounted for reciprocal motion in a respective cylinder along a piston axis which is perpendicular to the big end axis, the at least one piston engaging engagement means on the connecting means;

wherein the crank has an effective centre of mass which, together with the connecting means and the at least one piston, remains stationary or substantially stationary relative to the main axis as the crank rotates.

In an alternate form of the invention, the effective centre of mass can describe an orbit, being a circle or ellipse, as the crank rotates.

The invention, in another broad form, also provides a fluid device, which includes:

a crank including a big end having a big end axis which orbits about a main axis;

connecting means rotatably mounted on the big end axis; and

at least one pair of non opposed pistons, each piston being mounted for reciprocal motion in a respective cylinder along a respective piston axis which is perpendicular to the big end axis, each piston engaging engagement means on the connecting means;

wherein the configuration of the connecting means and the engagement means is such that the motion of each piston is simple harmonic motion.

The invention, in another broad form, also provides a fluid device, which includes:

a crank including a big end axis which orbits about a main axis;

connecting means rotatably mounted on the big end axis; and

at least one pair of non opposed pistons, each piston being mounted for reciprocal motion in a respective cylinder along a respective piston axis which is perpendicular to the big end axis, each piston engaging engagement means on the connecting means;

wherein each pair of pistons has a mass and motion equivalent to a single body orbiting in an orbit.

Preferably the orbit is a circle, but it may be elliptical or of another shape, such as pear-shaped.

Preferably the motion of each of the pistons is simple harmonic motion.

The invention, in another broad form, also provides a fluid device, which includes:

a crank including a big end which orbits about a main axis, the big end having a big end axis;

connecting means rotatably mounted on the big end axis; and

at least one pair of pistons, each piston being mounted for reciprocal motion in a respective cylinder along a respective piston axis which is perpendicular to the big end axis, the piston axes of each pair being at a chosen angle to each other, each piston engaging engagement means on the connecting means;

wherein each pair of pistons has a mass and motion equivalent to a single body describing an orbit;

the centre of mass of the connecting means is located on or adjacent the big end axis; and

the crank includes a counter weight located generally diametrically opposite the big end and having a centre of mass remote from the main axis, the counter weight including the equivalent of:

a first mass to statically and/or dynamically balance all or part of the mass of the big end relative to the main axis;

a second mass to statically and/or dynamically balance all or part of the mass of the connecting means relative to the main axis; and,

a respective third mass to statically and/or dynamically balance all or part of the mass of each piston relative to the main axis.

Preferably, the chosen angle is 90°, but is not limited to this. Some other preferred angles are 45°, 60°, 72° and 120°.

Preferably, the orbit is a circle and the third mass preferably statically and/or dynamically balances the mass of the pistons.

Where the orbit is not a circle, the third mass may balance the mass of the pistons in a first direction. The first direction is preferably parallel or perpendicular to a bisector of the axes of each pair of pistons.

In all forms of the invention the connecting means may have non-rotary motion relative to the piston. Preferably there is no rotary motion whatsoever, except as allowed by clearances.

The invention also provides, in one broad form, a fluid device having:

at least one piston assembly reciprocating along a piston axis;

a crank rotating about an axis and having a big end offset from the crank axis, the big end having a big end axis perpendicular to the piston axis; and

at least one intermediate member located between the big end and the piston for transferring motion of the big end to the piston assembly.

In the device, each piston assembly may have at least two surfaces with the big end bearing on one surface and an intermediate member or follower bearing on the another surface.

The device may have at least one follower which bears on both surfaces or it may have two followers each of which bears on one of the respective surfaces.

Each piston assembly may have one piston or it may have two pistons. Where two pistons per assembly are provided, preferably the at least one follower is located between the pistons.

The follower is preferably a circular cam having its centre offset from the crank axis.

The device may have one or more piston assemblies for each follower.

Where two or more pistons assemblies for each big end are provided, they may reciprocate along piston axes extending at any angle to each other. Preferably there are two piston assemblies per big end extending at 90° to each other.

Where two piston assemblies extending at 90° to each other are provided, preferably there are provided two followers, each of which engages both piston assemblies.

Preferably, the device includes constraining means which guide the respective piston assembly to limit or substantially prevent movement of the respective piston assembly transversely of its respective piston axis.

The constraining means may be mounted on or be integral with the crankcase. The constraining means may include a slot or elongate recess in the piston assembly. The slot or recess may engage a member on the crankcase or it may engage the crankshaft itself, directly or indirectly. If the slot or recess engages the crankshaft, preferably there is provided a follower intermediate the crankshaft and the slot or recess.

The device may include one or more subsidiary fluid pumps for pumping lubricating fluid or the like to specific locations of the device. Each fluid pump may be mounted on the crankcase, the crank assembly, the drive mechanism mounted on the crank or on a piston assembly. Any combination of these positions is possible. The fluid pump may be used to cause secondary movement of the piston assembly relative to the drive member and/or the crank.

The crank may include a secondary drive member which engages the at least one follower or the piston assembly. The secondary drive member may contact either continuously or intermittently as the crank rotates. The secondary drive member may drive one or more of the aforesaid secondary fluid pumps.

The invention, in another broad form, also provides a fluid device which includes:

a crank including a big end axis which orbits about a main axis;

connecting means rotatably mounted on the big end axis;

at least one piston mounted for reciprocal motion in a cylinder along a piston axis, the piston having a cross-sectional area perpendicular to the piston axis which is perpendicular to the big end axis, the piston having guide means which engage engagement means on the connecting means; and

at least one restricting means for constraining the piston to move along the piston axis;

wherein the piston guide means bisect the piston cross-sectional area and optionally at least part of each restricting means is located within a volume defined by the piston cross-sectional area but not along the centre line of the bisection formed by the piston guide means.

In preferred embodiments, the guide means include surfaces which extend substantially perpendicularly to the respective piston axis, as already discussed.

The restricting means is intended to alleviate “jamming” of the piston in the cylinder, which can provide a problem at high temperature. It is desirable to maintain the piston so that it is aligned with the piston axis. Several preferred embodiments of the restricting means are described in connection with the drawings. It will be appreciated that when the restricting means is located within the “footprint” of the piston, metallic mass of the fluid device is minimized.

As will be seen from the drawings, in some embodiments, the restricting means is formed in pairs and a line drawn from one member to the other of the pair would be perpendicular to the centre line of the bisection of the piston formed by the piston guide means. In other embodiments, the restricting means includes members which are located on either side of the bisection formed by the first piston guide means but not along the centre line.

Each restricting means may be integral with the piston or formed separately from and attached to the piston. The restricting means may be slidably engaged in slideways which may be substantially fixed to the engine block or other suitable purchase point.

Slideways for the restricting means may be mounted to the block within the footprint of the piston, thus minimizing the size of the device of the invention. Alternatively, the slideways may project wholly or partly outside the footprint of the piston.

For a slightly less compact arrangement, the restricting means may be mounted outside, or partly inside and partly outside, the piston footprint.

Regardless of whether the restricting means is inside or outside the piston footprint, it is to be noted that the restricting means (when more than one) may be disposed symmetrically or asymmetrically of the piston axis. When there is a plurality of restricting means, they may be on one side of the line of bisection of the piston. There may be an odd number of these restricting means.

Reference is made to devices in which piston motion is achieved by sliders mounted on big ends and in which two or more pistons may be mounted on a single slider but each of which moves along a separate path to each other.

It has been found that because each piston is not directly connected to any other piston, there is a tendency for the pistons to rotate in the cylinders about an axis generally parallel the crank axis. This can lead to destructive failure of the device. We have found that providing the restricting means, extending parallel to the cylinder axis, prevents such rotation. In some versions, the restricting means lie above the swept volume of the crank shaft and big end. However, if the restricting means is configured so that at various parts of the cycle the restricting means extends into the volume swept by the crank and slider, a more compact device can result.

Consequently, in one broad form the invention provides a fluid device which includes:

a crank including a big end axis which orbits about a main axis;

connecting means rotatably mounted on the big end axis;

at least one piston mounted for reciprocal motion in a cylinder along a piston axis which is perpendicular to the big end axis, the piston having guide means which engages engagement means on the connecting means; and

at least one restricting means for constraining the piston to move along the piston axis;

wherein, as the crank rotates, the at least one restricting means extends into the swept volume of the crank.

Preferably the restricting means is located within the volume defined by the axial cross-sectional area of the piston.

Preferably each piston has two restricting means and more preferably they are located symmetrically relative to the piston axis.

In conventional scotch yoke type piston fluid machines, a slider is rotatably mounted on the big end of a crank, which orbits about a main axis. The slider is constrained to move along a linear slot in the piston assembly which is generally perpendicular to the cylinder axis. Thus, as the crank rotates, the piston is caused to reciprocate along the cylinder.

In conventional single piston devices, the linear slot is positioned on the cylinder axis and so that at top dead centre the big end lies between the piston and the main axis. This invention includes various novel and inventive configurations which depart from this standard.

Thus, in a further broad form, the invention provides a reciprocating piston fluid device including

a crank including a big end axis which orbits about a main axis;

connecting means rotatably mounted-on the big end axis; and

at least one piston mounted for reciprocal motion in a cylinder and including engagement means for engaging the connecting means, whereby the piston reciprocates in the cylinder as the big end orbits the main axis, the piston having an axis perpendicular to the big end axis;

wherein, at top dead centre, the engagement means lies on one side of the big end axis and the piston lies on the other side of the big end axis.

This, in effect, is the reverse of the norm.

In another form, the invention provides a reciprocating piston fluid device including:

a crank including a big end axis which orbits about a main axis;

at least one connecting means rotatably mounted on the big end axis;

at least one piston mounted in a respective cylinder for reciprocal motion along a piston axis which is perpendicular to the big end axis; and

engagement means interconnecting the at least one piston and the at least one connecting means,

wherein the main axis is not located on the or any of the at least one cylinder axes.

Preferably, when the or one of the pistons is at top or bottom dead centre, a line joining the main and big end axes is parallel to and spaced from the respective cylinder axis of the one piston.

Preferably, the or each engagement means includes restricting means to constrain the respective piston or pistons to move along the respective cylinder axis.

Usually in scotch yoke engines or pumps, two opposed pistons are rigidly connected together about a yoke. A slider, which is rotatably mounted on a big end of a crank, slides within the yoke and causes the pistons to reciprocate.

The present invention aims to provide improved yoke constructions, which allows, in preferred forms, for two identical parts to be utilized to build up the yoke assembly. The assembly may be split generally axially or transversely relative to the cylinder axis. In preferred forms, the number of parts required is reduced whilst allowing for simple manufacture of the parts.

In one broad form the invention provides a yoke assembly for a scotch yoke type fluid device having opposed pistons reciprocating in opposed cylinders having parallel cylinder axes, the yoke assembly attached to the two pistons and including an engagement portion for receiving an engagement member rotatably mounted on a big end axis of a crank shaft and in which the engagement means reciprocates as the crank rotates, said engagement portion being split into two parts, optionally releasably engaged together.

The engagement portion may be split along a plane generally parallel to the cylinder axes or along a plane generally perpendicular to the cylinder axes.

The two parts may be identical or may be dissimilar.

Preferably the two parts may be joined together at only two locations, but more may be used if desired.

The engagement portion preferably includes two opposed channels in which the engagement means reciprocates. Each of the channels may be defined by only one of the parts of the engagement portion or both parts may define part of each channel.

Preferably, where identical parts of the engagement portion define only all or part of one channel each, each part includes legs which extend and engage the other part. These legs may be located at opposite ends of the channel but on the same lateral side, on the same end but opposite lateral sides of the channel, or on opposite ends and opposite lateral sides of the channel. Preferably, a single fastener may hold two legs, one for each part, simultaneously.

Where non-identical parts of the engagement portion are utilized, one part may have two or more spaced-apart legs located adjacent the channel and the other part may have no legs or one leg adjacent the channel.

Preferably, the legs are located at the ends of the channel, but a single leg may be positioned adjacent the channel at a mid-point. In this construction, the crank cannot pass through one side of the engagement portion.

The decoupled, paired piston/s, scotch yoke devices of this invention may be balanced perfectly in that the centre of mass of the moving parts of the engine (the crank, the pistons and their members, and any interconnecting members between the big end and the pistons) remains exactly stationary and centered on the main axis as the device members rotate, orbit and reciprocate through the cycle. A pair of pistons arranged at 90 degrees to each other and sharing the same big end axis may be perfectly balanced. A pair of pistons arranged at 90 degrees to each other and having coaxial big end axes, similarly, may be perfectly balanced (although in this embodiment a rocking couple may be set up).

An engine that is of a V configuration that is other than 90 degrees may be balanced perfectly as well. This may be achieved by splitting the big end so that there are two big end axes per pair of reciprocating masses, i.e., pistons. The two big ends axes are angularly displaced from one another about the main axis.

The adoption of a scotch yoke type connection for the pistons, wherein the sliding surfaces are perpendicular to the piston axis, can eliminate the piston motion normally observed at bottom dead centre in compound crank engines with a pinion wheel to annular gear ratio of 3/2.

While it has been stated that the piston axis is perpendicular to the big end axis, it is to be understood that it is not necessary that the piston axis passes through the big end axis.

In other broad forms, the invention includes the variations disclosed in the following patent specifications, the content of which are imported herein by reference: Australian provisional patent application No. PQ5246, Australian provisional patent specification No. PQ9567 and Australian provisional patent specifications Nos. PQ9143 and PQ9979, also International Patent Application No. PCT/AU00/00281.

Although many broad forms of the invention are disclosed in this specification, either specifically or as imported by reference, it will be appreciated by one skilled in the art that one or more aspects of each embodiment may well be applicable to other forms of the invention and this specification is to be interpreted accordingly.

Without limiting the generality of the above paragraph, specific reference is made to adaptation of the compound crank mechanisms disclosed in International Patent Application Nos. PCT/AU97/00030 and PCT/AU98/00287. In many instances, the broad forms of invention recited herein may be applied to the compound crank mechanisms disclosed in the International applications. The conventional piston arrangement in the International applications may be replaced by the engagement means referred to herein, to form a scotch yoke type engine, for example.

Again, without limiting the generality of the second last paragraph, some of the forms of the invention may be suitable for adoption in two stroke, four stroke or hybrid two stroke four stroke devices.

Manufacturers strive to increase the specific power output and the efficiency of internal combustion engines for various reasons. One technique is to use forced induction, such as by way of super charging or turbo charging.

In another broad form, present invention provides an internal combustion with in-built forced induction without the need for external devices such as supercharging or turbo charging. This is achieved by the combination of two and four stroke techniques.

Thus, in one broad form the invention provides an internal combustion engine having:

at least one piston reciprocating in a respective cylinder/crank case assembly and defining a combustion chamber and a crank volume therein;

at least on passageway linking the combustion chamber and the crank volume;

at least one first valve means for selectively closing the passageway;

at least one inlet to said crank volume;

at least one second valve means for selectively closing the inlet.

The passageway may include a secondary chamber of variable volume.

The engine may be provided with a second inlet which communicates directly with the combustion chamber via third valve means.

The crank volume may communicate with an auxiliary chamber via auxiliary valve means.

The crank volume may include vent means to selectively vent pressure. The vent means may vent to the respective combustion chamber or an a multi cylinder engine may vent to another crank volume or another combustion chamber. Preferably the vent means includes valve means to selectively vent pressure.

The at least one passageway may be external of the combustion chamber and crank volume. Alternatively the passageway may be located in the piston.

Where the passageway is external, the at least one first valve means may include a poppet valve, a reed valve, a sleeve valve, a disc valve or any other suitable valve mechanisms.

The passageway may communicate with the combustion chamber via the cylinder wall or the cylinder head.

Where a sleeve valve is used, it may rotate about the cylinder axis, either continuously or in an oscillating manner, or it may reciprocate axially relative to the cylinder, or with a combination of axial and rotatory oscillatory motion.

The first valve means may include two or more valves located in the passageway distant from each other, so as to define a secondary chamber.

In another broad form, the invention provides, in a scotch yoke fluid device, which includes a piston mounted for reciprocal motion in a cylinder, the improvement which includes a displaceable member for relieving pressure in a variable volume chamber in the cylinder during combustion.

The displaceable member may be part of an assembly for the piston, or part of the piston head, or part of the wall of the cylinder, for example.

The displaceable member may be displaced by displacing means or by variable volume chamber pressure. The displaceable member may be displaced by “inertia”, for example, if the displaceable member oscillates with the piston or if it is mounted in or on the piston or piston assembly.

Motion of the displaceable member may be controlled or modified by such means as damping springs, hydraulics, resilient members, mechanical means, tie rod/s, flexible wire/s, or friction.

The displaceable member may have more than one means influencing its movement during the piston stroke cycle. For example, pressure in the variable volume chamber may influence upward motion of the displaceable member, while downward motion may be influenced by a spring mounted between the displaceable member and the piston (or other part/s in the variable volume chamber).

In the case where the displaceable member is mounted on the piston, it is preferred that the displaceable member is connected to the piston or entrapped or captured in or on the piston and is therefore reliant on the piston for its carriage. For example, the member may be part of or may comprise the piston crown. The member may be within the circumference of the piston crown.

In various embodiments, the displaceable member or part of it may be of a compressible or deformable nature.

In one particular embodiment, the displaceable member is a free piston (i.e., able to “float”) within the piston of the scotch yoke fluid device.

The displaceable member or part of it may be provided with one or more cooling fluids or sumps. It may have sealing means and lubrication.

In a preferred embodiment, the displaceable member may be displaced once only. The purpose of this is to safeguard the engine from a pressure build up beyond a chosen critical point. After the single displacement, the member may be rendered inactive, for example by being crushed irretrievably.

In another embodiment, the member may be designed so that, after relieving excess pressure, it recovers its optimum movement potential only after one or more combustion cycles. One purpose of this is to permit the parts in the variable volume chamber to cool, for example after undesirable events such as knock, pinging or hydraulic lock.

If desired, the displaceable member may be linked or joined to a resilient modifier by suitable means.

In one embodiment, the member includes means to cause the member to move in one direction only. For example, the member may be designed to move in a direction away from the crank, or away from the pressure in the chamber. Once the member has moved in that direction, it may designed to lock at that point, unless the lock is overcome by a force causing the member to move further in the same direction as before. It will be appreciated that this design can enable the invention to be useful in recording maximum pressure or maximum inertia.

If desired, several displaceable members may be incorporated in a single variable volume chamber.

The displaceable member (or part/s of it) may be capable of projecting sound or other detectable energy, such as electromagnetic waves, for example, which can signal stressing of the member. Such emission of sound or other energy may be detectable by suitable means which can be designed to cause the control mechanism for the scotch yoke device to adjust engine settings, such as timing, to alleviate the pressure.

In yet another broad form of this invention, the invention provides a method of varying power output of a scotch yoke device having a plurality of cylinders, the method including the step of choosing the number of cylinders, the angle between cylinders, pin angles and firing order as set out in any of the rows in the Tables herein.

### BRIEF DESCRIPTION OF THE DRAWINGS

The invention shall be better understood from the following, non-limiting description of preferred forms of the invention, in which:

FIG. 1 is a cross-sectional view of a two piston fluid device according to the invention.

FIG. 2 is a partial cutaway perspective view of the FIG. 1 device, with a counterweight added.

FIG. 3 is a perspective view of a three piston fluid device according to the invention, being a three cycle engine.

FIG. 4 is a cross-sectional diagrammatic view of a three piston fluid device similar to that of FIG. 3.

FIG. 5 shows a partial cutaway perspective view of an embodiment of the invention, similar to that of FIG. 2.

FIG. 6 shows an end view of the connecting means of the FIG. 5 device.

FIG. 7 shows a perspective view of the FIG. 6 connecting means.

FIG. 8 shows an end view of a variation of the FIG. 1 embodiment, with stabilizing means.

FIG. 9 shows an end view of a further embodiment of the invention, having a movable crankshaft.

FIG. 10 shows an end view of an embodiment which is a variation of the FIG. 9 embodiment.

FIGS. 11 to 25 show various configurations of the guide surfaces of the invention.

FIG. 26 shows a V-twin engine embodiment of the invention, including constraining means.

FIG. 27 is a schematic layout of a V-twin engine according to the invention, including stabilizing means.

FIGS. 28 to 35 are axial cross-sections through a big end and embodiments of a connecting means according to the invention.

FIGS. 36 to 44 show further variations of the connection between the connecting means and the engagement means of the piston.

FIG. 45 shows an end view of an embodiment of a scotch yoke type engine according to the invention.

FIG. 46 shows a perspective view of a further embodiment of the invention.

FIG. 47 shows a top view of the embodiment of 46.

FIG. 48 shows an end view of a further embodiment of the invention.

FIGS. 49 and 50 show perspective views of the FIG. 48 embodiment.

FIG. 51 shows a perspective view of a further embodiment of the invention.

FIG. 52 shows an end view of the FIG. 51 embodiment.

FIGS. 53 to 57 show end views of further embodiments of the invention.

FIGS. 58 to 69 show end views of a slider arrangements used in embodiments of the invention.

FIG. 70 is an axial end view of a further embodiment of the invention;

FIG. 71 is an axial end view of a further embodiment of the invention;

FIG. 72 is an axial end view of a further embodiment of the invention;

FIG. 73 is an axial end view of a further embodiment of the invention.

FIG. 74 shows an end view of a further embodiment of the invention. For clarity some components are omitted.

FIG. 75 is a perspective view of the FIG. 74 embodiment.

FIG. 76 shows a perspective view of a further embodiment of the invention.

FIG. 77 shows an exploded perspective view of the FIG. 74 embodiment.

FIG. 78 shows a perspective view of a further embodiment of the invention.

FIG. 79 shows an end view of the FIG. 78 embodiment.

FIG. 80 shows an exploded perspective view of the FIG. 78 embodiment.

FIG. 81 is a perspective view of a piston having restriction means and made according to the invention.

FIG. 82 is a perspective view of the FIG. 81 piston taken from a different angle.

FIG. 83 is a perspective view of a fluid device incorporating the piston of FIGS. 81 and 82.

FIG. 84 is a detailed view of a portion of the device of FIG. 83.

FIGS. 85 to 126 show underside plan views of various pistons made according to the invention.

FIGS. 127 to 129 show isometric views of a further piston made according to the invention.

FIGS. 130 to 132 show isometric views of a further piston made according to the invention.

FIGS. 133 to 135 show isometric views of a further piston made according to the invention.

FIGS. 136 to 138 show isometric views of a further piston made according to the invention.

FIGS. 139 to 141 show isometric views of a further piston made according to the invention.

FIGS. 142 to 144 show isometric views of a further piston made according to the invention.

FIGS. 145 to 147 show isometric views of a further piston made according to the invention.

FIGS. 148 to 150 show isometric views of a further piston made according to the invention.

FIGS. 151 to 153 show isometric views of a further piston made according to the invention.

FIGS. 154 to 156 show isometric views of a further piston made according to the invention.

FIGS. 157 to 159 show isometric views of a further piston made according to the invention.

FIGS. 160 to 162 show isometric views of a further piston made according to the invention.

FIGS. 163 to 165 show isometric views of a further piston made according to the invention.

FIGS. 166 to 168 show isometric views of a further piston made according to the invention.

FIGS. 169 to 171 show isometric views of a further piston made according to the invention.

FIGS. 172 to 174 show isometric views of a further piston made according to the invention.

FIGS. 175 to 177 show isometric views of a further piston made according to the invention.

FIGS. 178 to 180 show isometric views of a further piston made according to the invention.

FIGS. 181 to 183 show isometric views of a further piston made according to the invention.

FIGS. 184 to 186 show isometric views of a further piston made according to the invention.

FIGS. 187 to 189 show isometric views of a further piston made according to the invention.

FIGS. 190 to 192 show isometric views of a further piston made according to the invention.

FIGS. 193 to 195 show isometric views of a further piston made according to the invention.

FIG. 196 is an end view of an embodiment of the invention at a first position during its cycle.

FIGS. 197 to 199 are end views of the embodiment of FIG. 196 at different stages of its cycle.

FIG. 200 shows a perspective view of the embodiment of FIG. 196.

FIG. 201 is an expanded view of part of FIG. 200.

FIG. 202 shows a view of the embodiment of FIG. 196 taken perpendicular to one of the cylinder axes at a position corresponding to bottom dead centre for one of the pistons.

FIG. 203 shows a view of the embodiment similar to that of FIG. 202 but at top dead centre.

FIGS. 204 to 207 show perspective conceptual views of various yoke constructions.

FIG. 208 is an isometric view of a crank with a pair of split big ends.

FIG. 209 is an end view of a V scotch yoke device according to the invention wherein the big ends are coaxial and the pistons are disposed for reciprocation at 75 degrees to each other about the main axis.

FIG. 210 is an end view of a V scotch yoke device according to the invention wherein the pistons are disposed for reciprocation at 90 degrees to each other about the main axis.

FIG. 211 is an end view of a V scotch yoke device according to the invention wherein the pistons are disposed for reciprocation at 120 degrees to each other about the main axis.

FIG. 212 is a perspective view of a connecting rod designed to be attached to a single piston assembly.

FIG. 213 is a perspective view of a single piston assembly designed to be attached to the connecting rod of FIG. 212.

FIG. 214 is a perspective view of a block segment useful in conjunction with the invention.

FIG. 215 is an end view of a block incorporating the segment in FIG. 214.

FIG. 216 is a bottom perspective view of the segment of FIG. 214.

FIG. 217 is a schematic cross sectional view of a first embodiment of the invention as it relates to two stroke/four stroke techniques.

FIG. 218 is a schematic cross sectional view of a second embodiment of such invention.

FIG. 219 is a schematic cross sectional view of a third embodiment of such invention.

FIG. 220 is a schematic cross sectional view of a fourth embodiment of such invention.

FIG. 221 is a schematic cross sectional view of a fifth embodiment of such invention.

FIG. 222 is a schematic cross sectional view of a sixth embodiment of such invention.

FIG. 223 is a schematic cross sectional view of a seventh embodiment of such invention.

FIG. 224 is a schematic cross sectional view of a first embodiment of an inlet tract according to the invention.

FIG. 225 is a schematic cross sectional view of a second embodiment of an inlet tract according to the invention.

FIG. 226 is a schematic cross sectional view of a third embodiment of an inlet tract according to the invention.

FIG. 227 is a schematic cross sectional view of a fourth embodiment of an inlet tract according to the invention.

FIG. 228 is a schematic view of first and second embodiments (combined in the one Figure) of the invention so far as it relates to a displaceable member for relieving pressure in a variable volume chamber.

FIG. 229 shows a third embodiment of such invention.

FIG. 230 shows a fourth embodiment of such invention.

FIGS. 231 to 235 are Tables showing the choice of cylinder angle, pin angle and firing order in the method of the invention.

### BEST MODE OF CARRYING OUT THE INVENTION

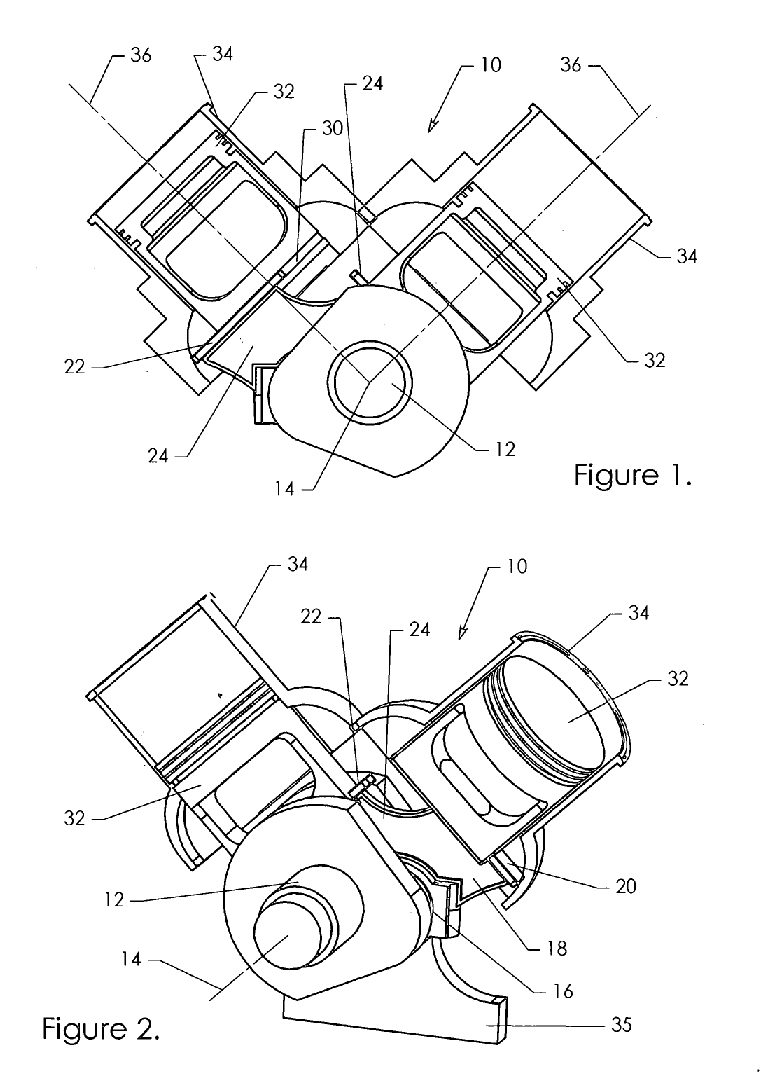

Referring to FIGS. 1 and 2 there is shown a two piston fluid device 10 which includes a crank 12 mounted for rotation about a crank axis 14. The crank 12 has an offset big end 16, radially distant from the axis 14. Thus as the crank 12 rotates about axis 14, big end 16 will describe a circular orbit around axis 14.

Rotatably mounted on big end 16 is a connecting means, being a slider 18. The slider has two tongues 20, 22.

The slider 18 extends generally perpendicular to the axis 14. As best seen in FIG. 2, the sliding surfaces extend axially on either side of the main portion 24 of the slider 18 and so form a T-shaped construction.

Each of the tongues 20, 22 engages in a T-shaped slot 30 of a respective piston 32. Each piston is mounted in a cylinder 34 for linear movement along a respective cylinder axis 36. Each slot 30 preferably extends substantially perpendicular to the cylinder axis 36 and extends diametrically across the centre of the piston. Both ends of the slot 30 are open. The slider 18 can thus move sideways relative to the piston but must move axially with the piston along axis 36. Where the slot 30 does not extend at 90° to the piston axis 36, sideways movement of the tongue 20 or 22 relative to the piston will cause axial motion of the piston 32. This enables one to control the motion of the piston 32 beyond a pure sinusoidal motion.

The piston 32 is constrained to move along its piston axis 36 and as the crank 12 rotates the slider 18 rotates about the crank axis 14. The motion of each tongue 20, 22 has a component parallel to the respective piston axis 36 and a component perpendicular to the respective piston axis 36. Thus, the pistons 32 reciprocate in their respective cylinders 34 with the tongues 20, 22 sliding sideways in their respective slots 30. The combination of the linear movement of the piston 32 and the tongue 20, 22 in the slot 30 maintains the slider 18 in a constant orientation as the crank rotates, irrespective of other pistons. In the embodiment of FIG. 1, there are provided two pistons 32 at 90 to each other, but since the slider 18 maintains its orientation as it orbits the crank axis 14, the angle between the pistons 32 may be other than 90°. Similarly, more pistons may be added.

In the FIG. 2 version, counterweight 35 has been included, to balance the mass of slider 18.

Optionally, the embodiments in FIGS. 1 and 2 may include restricting means, such as those shown with the FIG. 81 piston. (Many features in the various embodiments in the drawings may be combined with each other, even though not all possible combinations are shown).

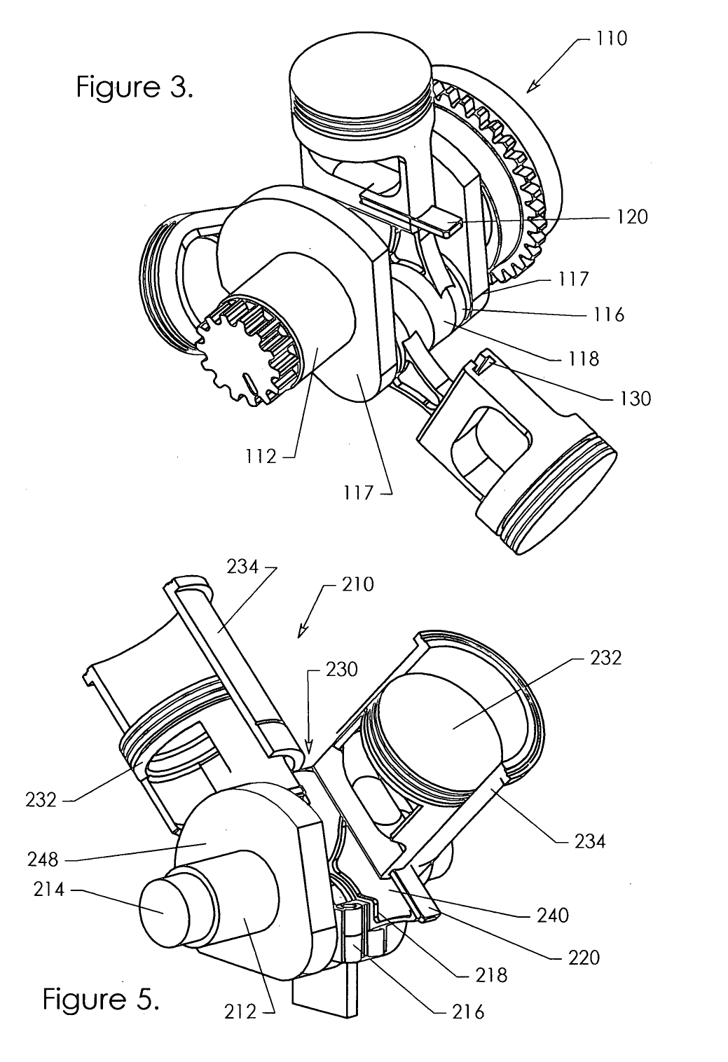

FIG. 3 shows a perspective view of a three piston device. The three piston device may be a three cycle engine such as those disclosed in International Patent Applications Nos. PCT/AU97/00030 and PCT/AU98/00287. The conventional con rod is removed and replaced by scotch yoke features—in particular a slider (tongue device 118).

In this type of engine, the crank axis orbits around the main axis. In FIG. 3, for clarity the cylinder and crank cast assemblies are omitted. As can be seen, the device 110 includes a crank 112 with a bearing pin 116 extending between webs 117. Three pistons are arranged equally about the crank 112 at 120° to each other. Mounted on the bearing pin 116 is a triple tongue device 118. This device may be a unitary structure or it may include three separate components mounted on the pin 116. As seen, each piston is provided with a T-shaped slot 130 into which the respective tongue 120 engages. The pistons are axially offset but, if desired, they may be in a common plane.

Because each of the pistons is decoupled from any other piston, the orientation and position of the pistons may be chosen as desired. There is no need for the piston axes to extend radially from the crank axis. The piston axes may extend radially from an axis, but this axis may be remote from the crank axis. The piston axes may be parallel and spaced from each other on either side of the crank axis.

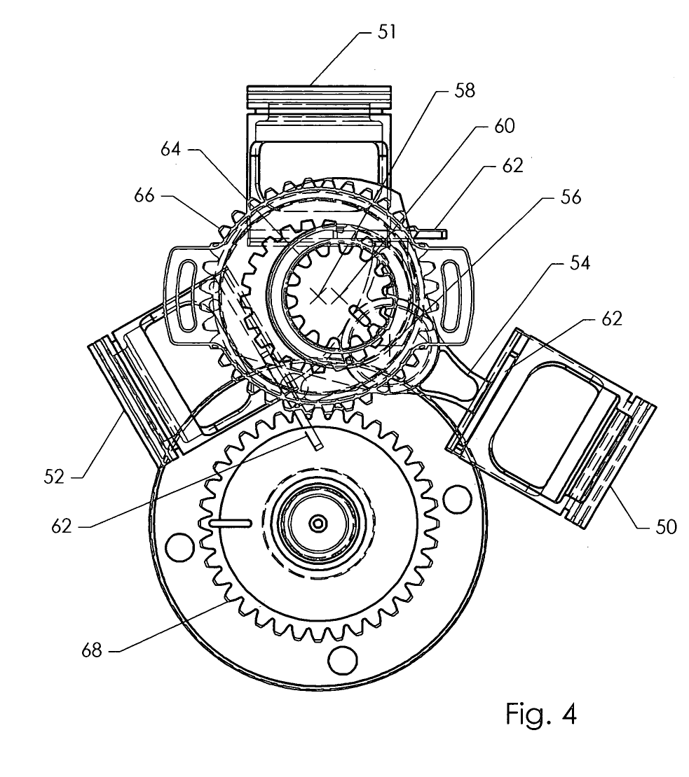

FIG. 4 shows a further version of a compound crank engine having three pistons. It is to be understood that a single piston or a two piston engine (possibly in V configurations) may be made by deleting unwanted pistons.

In FIG. 4, pistons 50, 51 and 52 are shown. Piston 50 is at top dead centre. For each piston 50, 51, 52 conrod 54 connects the piston to a crank big end having axis 56. Primary crank axis 58 orbits main axis 60.

Slides 62 are received in engagement slots (not shown).

Planetary gear 64 at the end of the crankshaft engages annular gear 66 which drives gear 68 in a 2:3 relationship.

The engine of FIG. 4 does not produce a sinusoidal motion of the piston, but rather a motion which is useful in converting fuel to rotational work. This engine has a slower piston motion in the compression and combustion phases of the cycle, compared to conventional engines and also compared to pure sinusoidal devices of this invention.

Note that the engines of FIGS. 3 and 4 may have pistons with restricting means, as illustrated in FIG. 81, for example. In this case, it is preferred that the restricting means extend towards the crank axis beyond the junction of the sliding surfaces (refer 62 in FIG. 4, for instance).

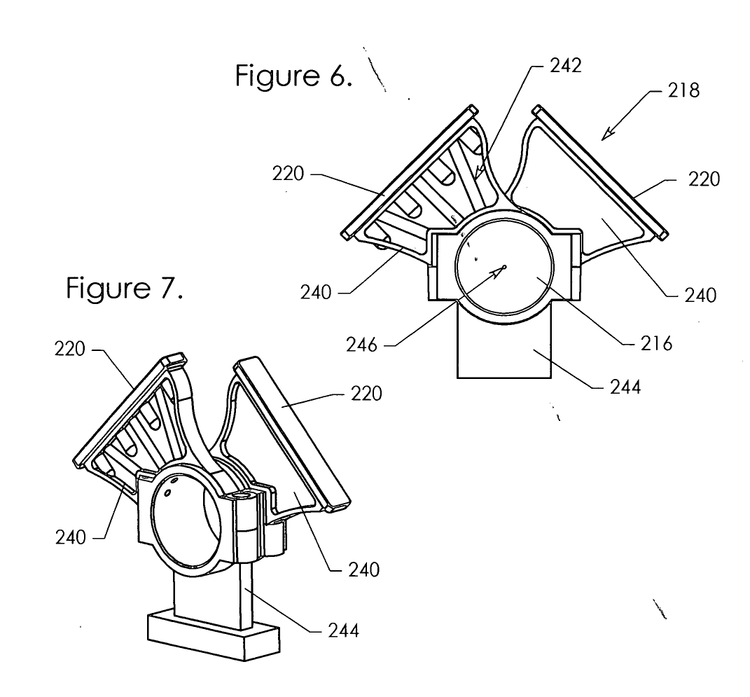

Referring to FIGS. 5 to 7, there is show a reciprocating piston device 210 having two pistons 232 reciprocating in respective cylinders 234 at 90° to each other. A connecting device 218 connects the two pistons to big end pin 216 of crankshaft 212 via tongues 220 and slots 230 in the pistons 232. The connecting device 218 has two webs 240, one for each piston, which are offset axially relative to each other. This allows the pistons 232 to overlap each other and so be brought closer to the crank axis 214. Lubrication ducts 242 are provided to supply pressurized oil from the big end pin 216 to the sliding surfaces of the tongues 220 and slots 230.

The connecting device 218 includes a counter weight 244 extends downwardly on the opposite side of the big end pin 216, to tongues 220 bisecting the angle between the two webs 240. This counter weight 244 may be sized so that the centre of mass of the connecting device 218 lies on the big end axis 246. It will be appreciated that when the pistons are spaced equally about the crank axis 214, the webs 240 will balance each other and therefore a separate counter weight may not be needed.

Providing the connecting device 218 is counterweighted so that its centre of mass is centered on the big end, as the connecting device 218 orbits the crank axis 214, no rotational forces are generated relative to the centre of mass centered on big end axis 246, which would cause the connecting device 218 to attempt to rotate about the big end and which would need counter turning forces to be generated at the slot 230/tongue 220 interface.

This leaves the reciprocating mass of the pistons 232. The velocity of the pistons 232 follows a pure sinusoidal path and in combination the two pistons 232 are the equivalent of a single rotating mass in a circle. This may be balanced by adding an appropriate mass to the crankshaft 212, thereby resulting in a dynamically balanced device. For a V twin configuration, a single piston mass is added to the back of the crankshaft 212.

Referring to FIG. 8, there is shown a fluid device 50 which is a variation on the FIG. 1 embodiment. For clarity the same numbers are used for the same components. The combination of the piston 32 being limited to linear motion along the piston axis 36 and the respective tongue 20 being limited to linear motion relative to the piston 32 theoretically prevents any rotation of the connecting means 18 relative to the piston 32. However, due to the need for manufacturing tolerances, there will inevitably be some free-play and hence turning of the connecting means 18 relative to the pistons 32. This in turn will generate turning forces at the interfaces of the tongues 20 with the slots 30. To alleviate this, the device in FIG. 8 is provided with stabilizing means being a linkage 40. One end of this linkage 40 is pivotably connected to the connecting means 18 at 42 and its other end is pivotably connected to the crankcase (not shown). The linkage 40, connecting means 18, crankshaft 12 and crankcase thus form a four bar linkage. The distance between the two pivot points 42, 44 is the same as the separation of the crank axis 14 from the big end axis 46. Thus, irrespective of the restriction imposed by the engagement of the connecting means 18 with the pistons 32, the connecting means 18 is constrained to orbit about crank axis 14 without changing its orientation.

Referring to FIG. 9, there is shown a twin cylinder fluid device 80 with twin pistons 82 mounted on connecting means 18 in cylinders 84. The connecting means 18 is mounted on a crankshaft 12, but the axis of the crankshaft 12 is not fixed relative to the cylinders 84. Instead, the crankshaft 12, and with it connecting means 18 and pistons 82 may be moved upwards or downwards, as indicated by arrows 86 which lie on the bisector of the included angle. The vertical movement of the crankshaft 12 raises the pistons 82 in the cylinders 84 and thus provides the ability to vary the compression ratio on the fly. Movement of the crankshaft 12 does not affect the timing of the pistons in the cylinders 84 relative to the crankshaft 12 or to each other. This is in contrast to conventional V engines which if provided with movable cranks, causes the timing of the pistons to vary, with one piston being advanced and the other retarded.

Vertical movement of the crankshaft 12 may be achieved utilizing conventional means, such as adjustable screws, hydraulic rams, a pneumatic or cam controller or the like, operating in the region of arrows 87 and 89.

It will be appreciated that a movable crank may be utilized with a single piston. It will be appreciated that the movable crank may be moved along paths other than the bisector in a V-twin engine, for example. The crank may be moved at, say, 15° to the vertical or in another desired way. This may have no effect other than to need more crank movement to achieve the same change in compression ratio.

FIG. 10 shows a variation of the FIG. 9 embodiment, in which the crankshaft 12 is mounted on bearing arms 90. The crank engages a gear 92, which may be connected to a gearbox in the case of an engine. The gear 92 has an axis of rotation 94. The bearing arms 90 are pivotably mounted on the crankcase about axes which are coaxial with the axis 94. The bearing arms may be rotated about the axis 94 by suitable means to raise or lower the crankshaft relative to the cylinders. Whilst this does cause a sideways movement of the crankshaft, and so advancement and retardation of the pistons, this is very slight.

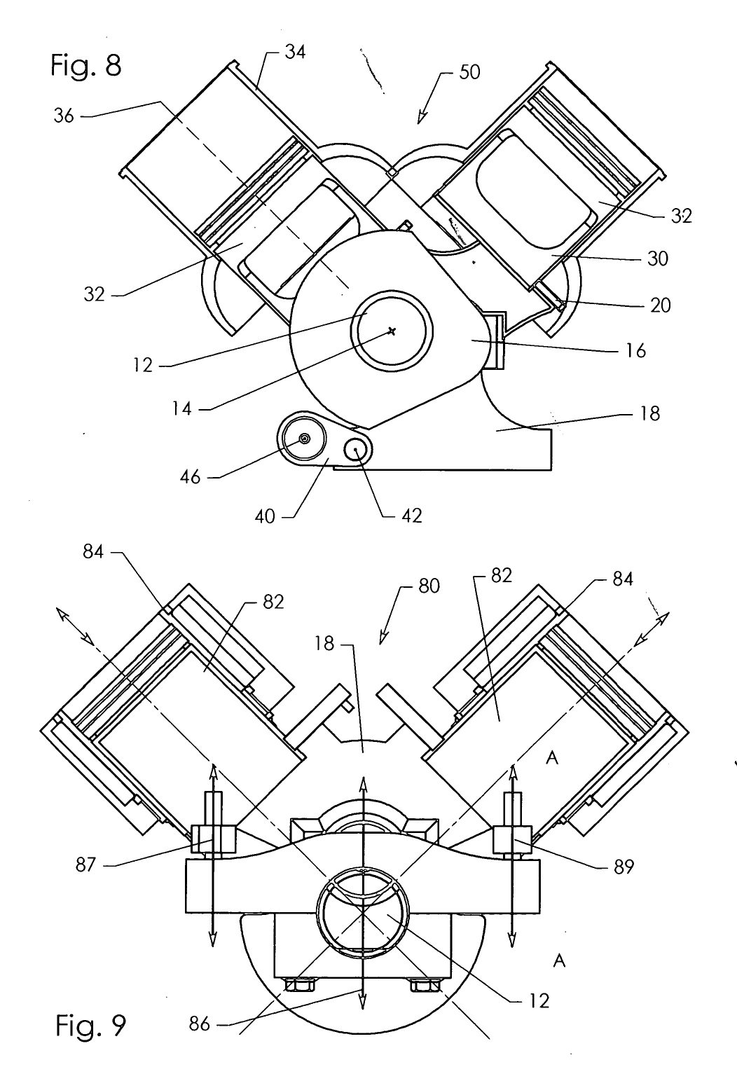

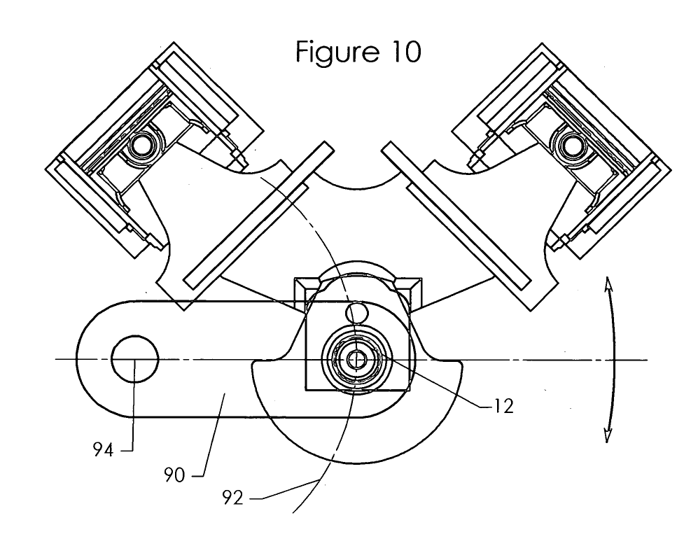

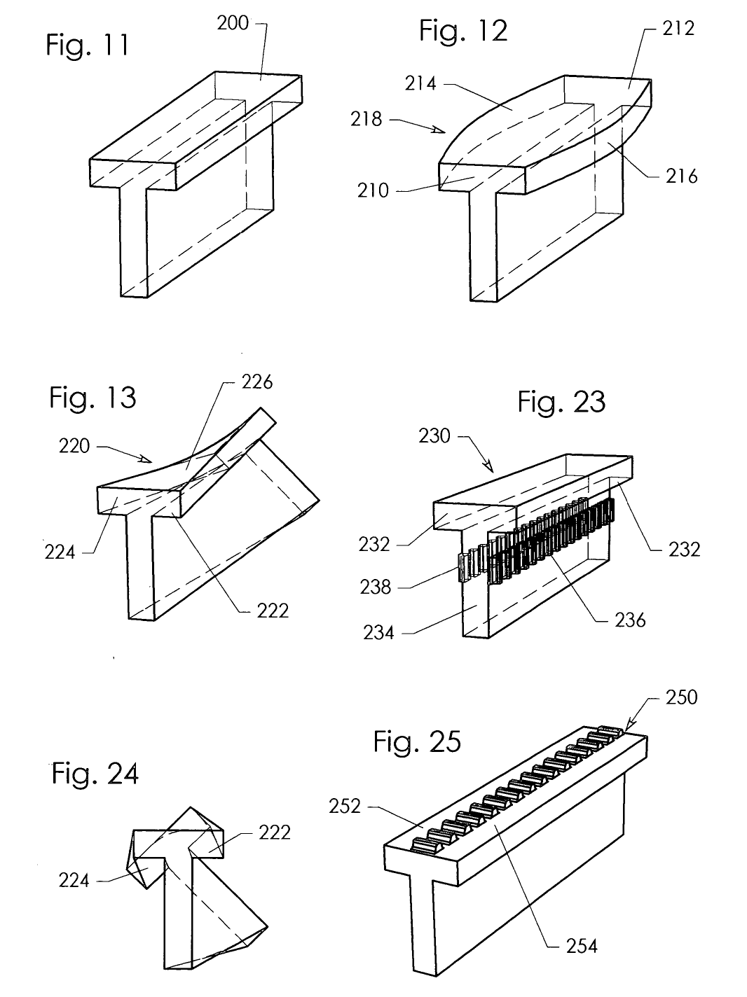

FIGS. 11 to 25 show a number of variations of the guide surfaces of the piston and the corresponding surfaces on the engagement means. At least some of these configurations may be used for the restricting means.

FIG. 11 shows a slider 100 having a Y-shaped engagement surface 102 for engagement with surfaces 104, 106 of a single piston.

FIG. 12 shows a slider 110 having engagement means 112. This surface 112 is Y-shaped and has arms 114, 116 extending from base 118.

FIG. 13 shows a slider 120 having engagement means 122. The engagement means as shown in cross section is T-shaped with two arms 124, 126. These arms 124, 126, in cross section, form a curved upper surface 128.

FIG. 14 shows a slider 130 having an arrow-headed engagement means 132. The engagement means 132 has two downwardly extending and diverging arms 134 which are engaged by the piston.

FIG. 15 shows a W-shaped engagement means 140.

FIG. 16 shows a T-shaped engagement means 150 but the upper and lower surfaces 152, 154 of the arms 156 are provided with V-shaped grooves 158, in which V-shaped protrusions 160 extend. The V-shaped grooves 158 and protrusions 160 may be reversed, as may most of the other embodiments.

FIG. 17 shows a T-shaped engagement means 170 having an upper surface 172 with a slot 173 located centrally therein. The corresponding surface 174 of the piston includes a rectangular shaped protrusion 176 which extends into the slot 173.

FIG. 18 shows a T-shaped engagement means 190 having a semi-circular protrusion 192 located centrally on the upper surface 194. The protrusion 192 need not be located centrally and there may be additional protrusions located on one or both sides of the centre of engagement means 190, either on the upper surface 194, the lower surfaces 196, 198, or both.

The device of FIG. 19 is similar to that of FIG. 14 except that the upper engagement surface 180 of the piston is not continuous but is provided with an opening 182.

FIG. 20 shows a T-shaped engagement means 200.

FIG. 21 shows a T-shaped engagement means 210 having arms 212 and 214. The side surfaces 216, 218 of the arms are curved, so the width between the surfaces 216 and 218 is greater at the centre of the engagement means 210 than at either end. It will be appreciated that the width of the corresponding slot in the piston will need to be at least as wide as the widest part of the two arms 212 and 214.

FIG. 22 shows an engagement means 220 which is T-shaped but in which the arms 222, 224 converge in the longitudinal direction, so as to form a triangular shaped upper surface 226.

FIG. 23 shows a T-shaped engagement means 230 having arms 232 and central leg 234. The leg 234 is provided with linear gears 236, 238 on its two surfaces. These gears 236, 238 may be used to drive, via rotatable gears mounted on the piston, other devices, such as subsidiary fluid pumps for pumping oil to selected locations, such as gaps between slider blocks.

FIG. 24 shows an end view of the FIG. 23 embodiment.

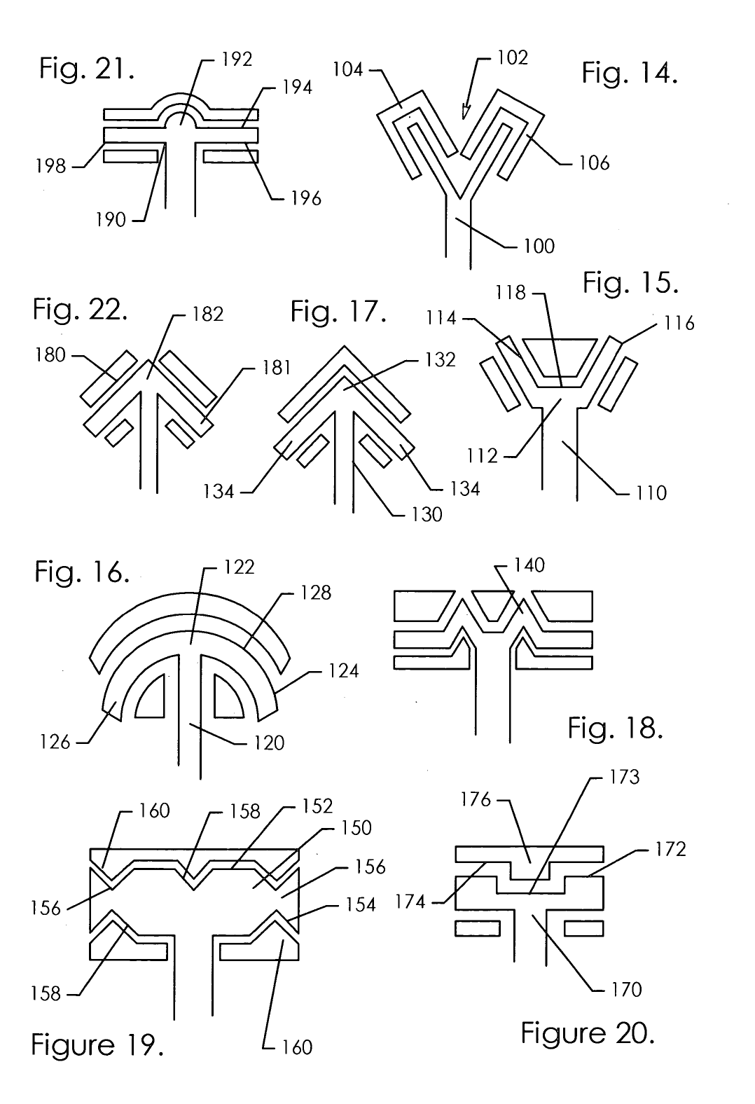

FIG. 25 shows a T-shaped engagement means 250 having a centrally located linear gear 252 on the upper surface 254. As with the FIG. 23 device, this gear may be used to drive devices mounted on or in the piston, such as rotary oil pumps.

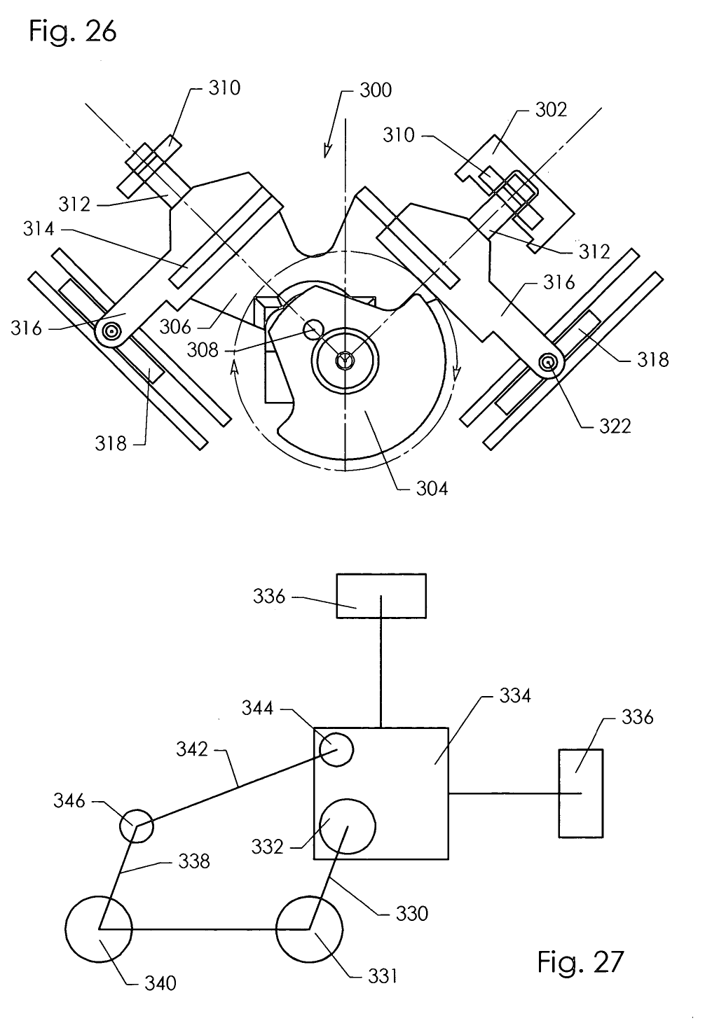

FIG. 26 shows a V-twin engine 300 having pistons 302, crank 304 and connecting means 306 mounted on the big end 308 of the crank 304. The pistons 302 are conventional pistons in having a gudgeon pin 310 on which is rotatably mounted a connecting rod 312. However the connecting rods 312 have a slot 314 at their lower end in which the connecting means 306 engages.

The connecting rods each have a sideways extending arm 316 which engages a slider 318 which slides in guides 320 parallel to the respective cylinder axis. The connecting rod 312 may be integral with the slider 318 or it may be connected by way of a pivotable joint 322, as shown. The joint 322 may be a single axis joint or a ball type joint. In the embodiment shown, the arms 316 extend parallel to the slots 314. However they may extend at any angle.

The guides 320 aid in stabilizing the respective piston 302 because the tolerances required can result in the piston 302 rotating very slightly in the bore and cause seizing or the like. If very tight tolerances are used, the guides 320 may not be needed. The guides 320 may be integral with the crank case or may be separate items attached to the crank case by way of bolts and the like

The gudgeon pins 310 of the pistons 302 may be at 90° to the crank axis as no rotational movement of the connecting rod 312 relative to the piston 302 will occur. Use of the pistons 302 with gudgeon pins 310 allows one to use “off the shelf” pistons. However, piston 302 may be integral with connecting rod 312.

FIG. 27 shows a schematic layout of a V-twin engine having a crank 330, a big end 332 and a connecting means 334 mounted on the big end. Pistons 336 are mounted on the connecting means 334 as in the previous embodiments.

A slave crank, 338 is provided which rotates about an axis 340 parallel to the axis 331 of the primary crank. A link 342 is pivotably mounted on both the connecting means 334 at 344 and the slave crank 338 at 346. The distance of pivot point 346 from the slave axis 340 is the same as that of the big end 332 from the primary axis 331. The slave crank 338 and link 342 thus aid in maintaining the connecting means 334 in a fixed orientation as the primary crank 330 rotates. It will be appreciated that this stabilization technique may be used with any of the embodiments described herein.

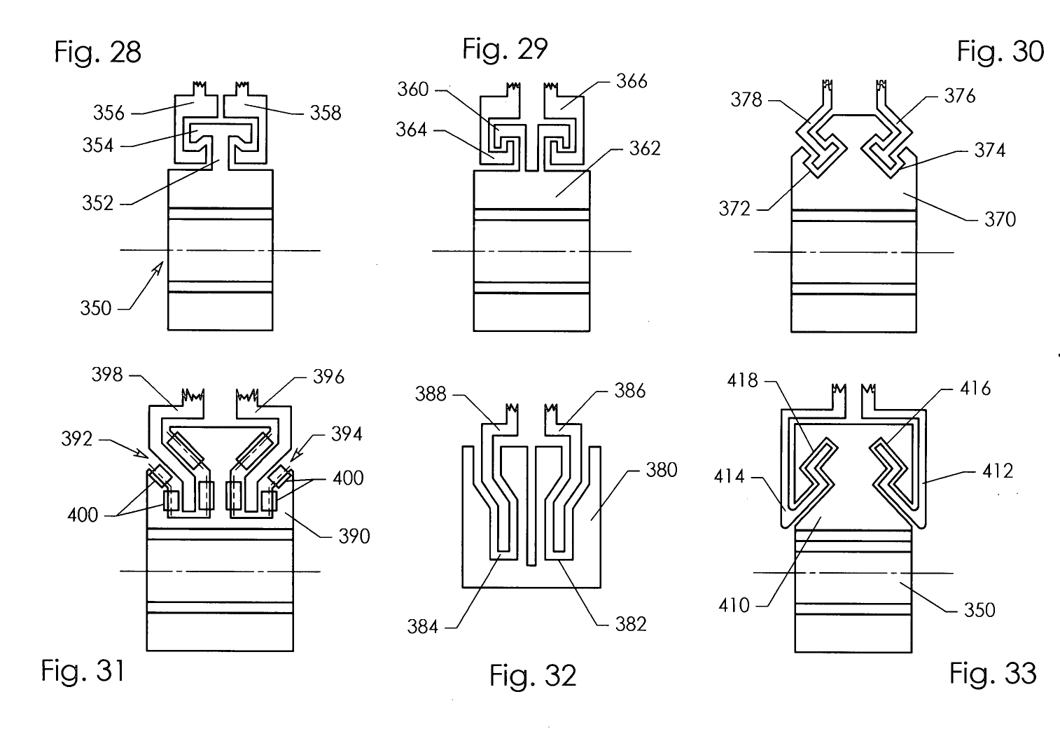

FIG. 28 shows an axial cross-section through a big end 350 and a connecting means 352. The connecting means 352 has engagement means 354 which is engaged by engagement means 356 and 358 of two separate pistons (not shown).

FIG. 29 shows a similar structure to that of FIG. 28 but with a different configuration of the engagement means 360 on the connecting means 362 and the corresponding engagement means 364, 366 of the two pistons.

FIG. 30 shows a connecting means 370 having two slots 372, 374 in each of which is engaged a T-shaped engagement means 376, 378. The engagement means 376, 378 may be attached to a single piston or to separate pistons.

FIG. 31 shows a connecting means 380 having two slots 382, 384. Each slot has a Z-shape which traps the corresponding engagement means 386, 388.

FIG. 32 shows a connecting means 390 having two slots 392, 394 in which are received engagement means 396, 398. Located in the slots are roller bearings 400 to aid movement of the engagement means 396, 398 along the slots 392, 394. It will be appreciated that the bearings 400 will be provided at intervals along the slots.

FIG. 33 shows a connecting means 410 in which the piston engagement means 412, 414 surround the connecting means 410 and engage in downwardly opening slots 416, 418.

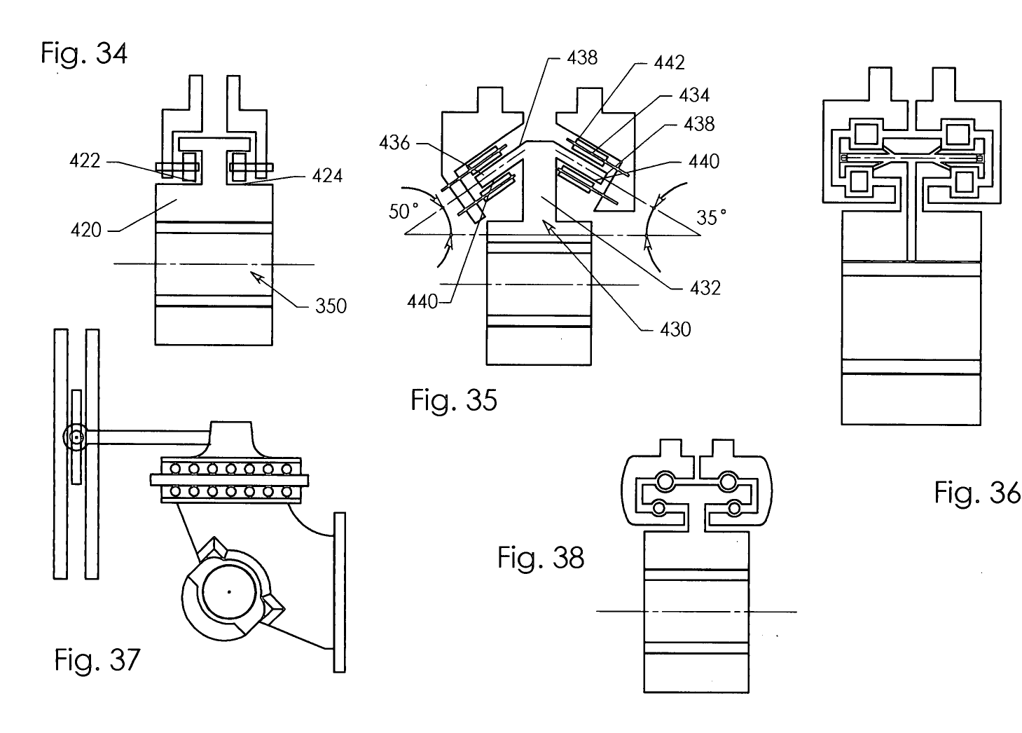

FIG. 34 shows a connecting means 420 having two sideways opening slots 422, 424.

FIG. 35 shows a connecting means 430 having a T-shaped engagement means 432 having arms 434 and 436 which descend divergently. The upper and lower surfaces 438 and 440 may be parallel, as in arms 434 and 436 or divergent (not shown). The Piston has a series of opposed roller bearings 442 which engage the upper and lower surfaces 438 and 440. As examples, the centre line of the arms 434 and 436 may be at between 35° and 50° to the big end axis.

FIGS. 36 to 44 show further variations possible of the connection between the connection means and the engagement means of the piston or pistons mounted thereon.

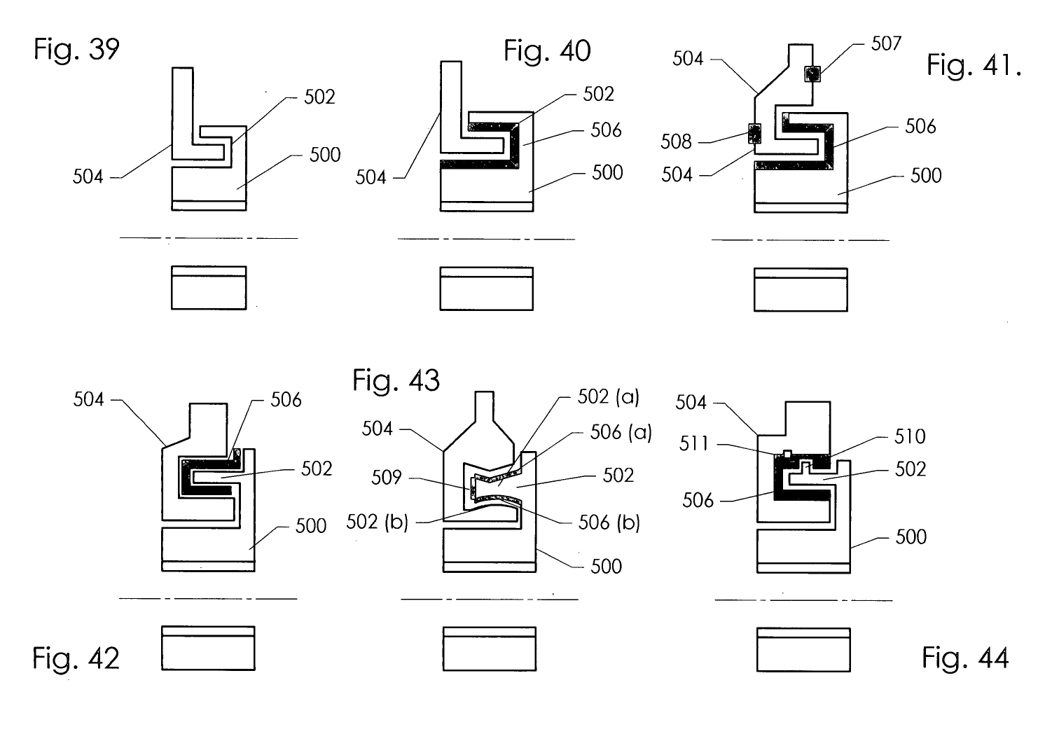

Referring specifically to FIGS. 39 to 44, it is to be understood that these are particularly suitable for use as constraining means or restricting means, as well. For convenience, the description below is in relation to connecting means.

FIG. 39 shows connection means 500 having a J-shaped engagement means 502 adapted to receive an L-shaped engagement means 504 of the piston.

FIG. 40 is a similar view but contains a bearing surface 506 lining engagement surface 502.

The FIG. 41 embodiment includes not only bearing surface 506, which is more expensive than bearing surface 506 in FIG. 40, but also supplementary bearings 507 and 508. These bearings 507 and 508 can bear against faces (not shown) to assist in maintaining alignment.

In the FIG. 42 embodiment, engagement surfaces 502 and 504 are more intricate and bearing 506 lines some of the engagement surfaces.

In connection with the embodiment in FIG. 43, for convenience two different versions of engagement surface 502 have been included. The upper part, 502a, is angular whereas the lower part, 502b, is arcuate. Bearings 506a and 506b follow the respective engagement surfaces. A further bearing is included at 509. In practice, engagement surface 502 would be symmetrical, having either two surfaces 502a or two surfaces 502b and bearings 506a and 506b would be chosen appropriately.

In FIG. 44, bearing 506 is shown attached to piston engagement surface 504 by a screw 511 or similar. Bearing 506 has a recess to accommodate protrusion 510 of connecting means engaging surface 502. Protrusion 510 can assist in maintaining alignment, in a similar way to bearings 507 and 508 in FIG. 41.

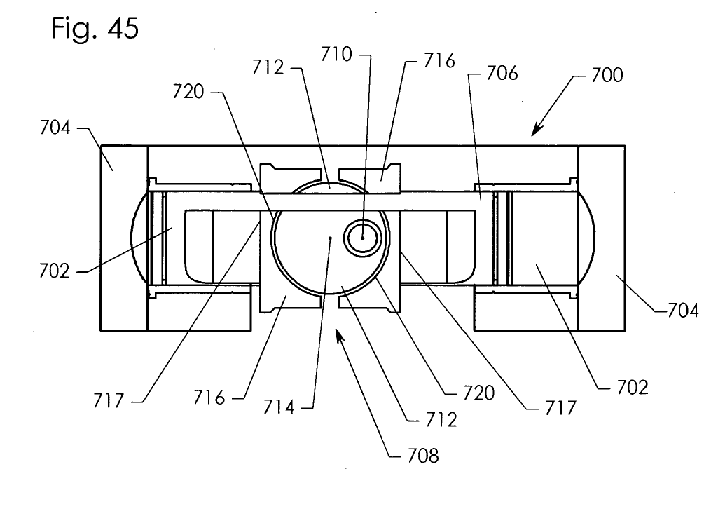

FIG. 45 shows a further embodiment of the invention which includes an opposed piston device 700 having pistons 702 reciprocating in cylinders 704. The pistons 702 are rigidly joined by linkage 706 and so move together. Mounted between the pistons is a crank 708 which rotates about axis 710. The crank 708 has a circular disk 712 which is offset from the axis 710, having its centre at 714. Thus as the crank 708 rotates, the disk 712 oscillates vertically and horizontally. Mounted on the linkage 706 are two followers 716. These followers 716 bear against vertical surfaces 717 of the linkage and may move vertically relative to the linkage 706 but not horizontally. The followers have curved surfaces 720 which engage the circumference of the disk 712.

The FIG. 45 embodiment may be lubricated in a conventional manner. It is also feasible that the space between followers 716 is filled with a rubber seal or similar to elastically connect followers 716 or to retain oil pressure. If followers 716 are separated by an extremely small gap, no seal may be required since surface tension should be adequate to maintain sufficient oil lubrication. As followers 716 wear, the embodiment can ensure that oil is pumped into the gap between the followers and the oil can also assist in transferring energy from one follower to the other.

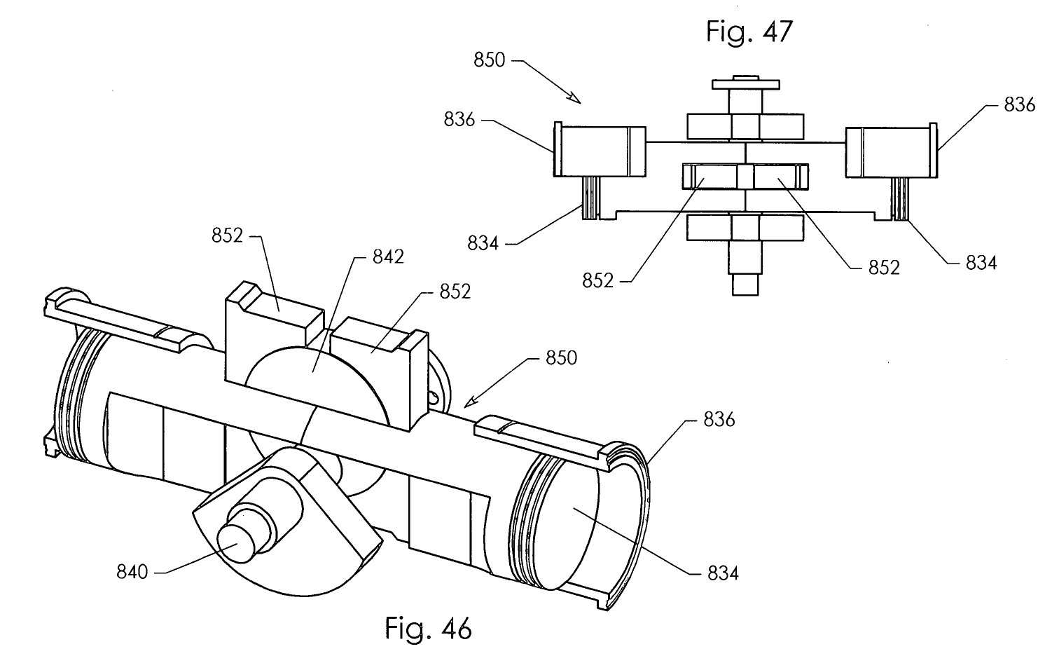

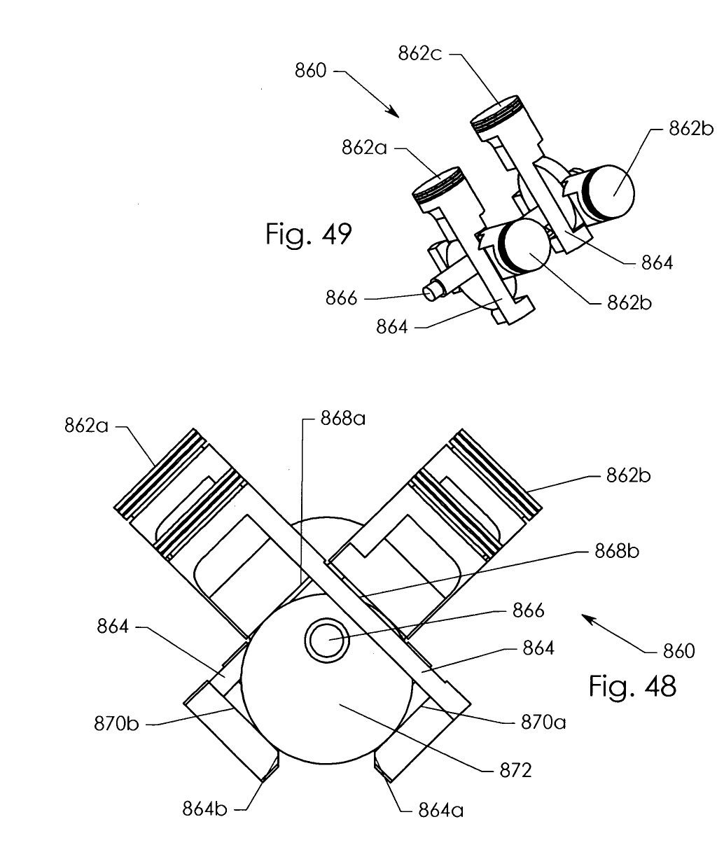

FIGS. 46 and 47 shows a twin piston engine 850. In this embodiment, two sliders 852 are provided, one on each side of the cam 842. Each slider 852 does not contact the other and so each is “floating” relative to the other. The use of a “split” slider as in FIGS. 46 and 47, namely two sliders 852, can prevent jamming of the slider in the slot. If one of the sliders 852 rotates relative to the slot 839, then all it does is rotate around the centre of the cam 842.

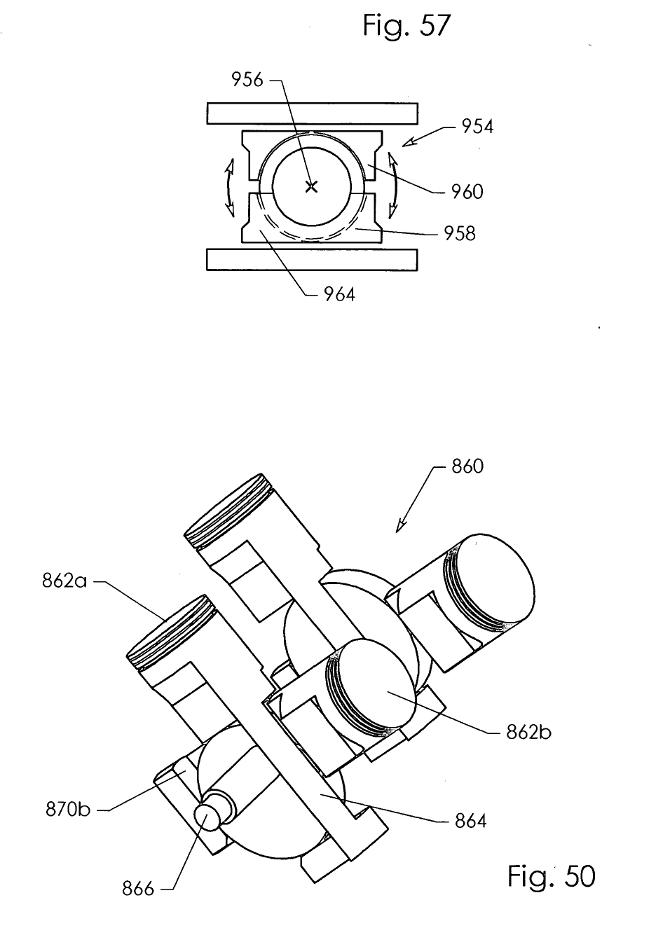

FIGS. 48 to 50 show a four piston device 860 having pairs of pistons 862a,b arranged at 90° to each other. Each piston has an extension 864 having end walls 868 and 870 extending perpendicular to the respective piston axis. The extensions 864 extend to one side of the piston axis, as best seen in FIG. 59, so that the pistons of each pair may be positioned in a common plane perpendicular to the crank 866.

The crank includes an offset circular cam 872 which engages the four walls 868a,b, 870a,b. As the crank rotates, the cam 872 causes both pistons 862a, b to reciprocate in their respective cylinders, not shown.

It will be appreciated that the FIGS. 48 to 50 embodiment show a device which would normally have horizontally opposed, coupled, pistons. The device of the invention, however, has decoupled the piston pairs and has achieved a configuration which is more compact than the conventional configuration. It will also be appreciated that extension 864 may be in one piece or may comprise two or more pieces joined together.

Whilst the FIGS. 48 to 50 embodiment uses a cam bearing directly on the end walls, it will be appreciated that the slider construction of the FIG. 46 or 47 embodiments may be utilized.

FIGS. 51 and 52 show a variation of the FIGS. 48 to 50 embodiment and so like parts are numbered the same.

Two sliders 880 are interposed between the cam 872 and the end walls 868a, b and 870a, b. Each slider bears on the inner face 868 of one piston and the outer face 870 of the other piston. As the crank 866 rotates this causes the sliders 880 to move both pistons. As with the FIG. 47 embodiment, since each slider only bears on one end wall of each piston, the likelihood of jamming is reduced. However, it is an option to join sliders 880 to each other.

FIG. 53 shows a V-twin device 882 similar to that of FIGS. 48 to 50 in which a cam bears directly on end walls of the pistons. As such, like parts have the same numbers. To aid stability of the pistons 862, guides 884 are provided which engage either side of the extensions 864 to prevent sideways motion of the piston relative to the respective piston axis.

FIG. 54 shows a V-twin device 890 in which each extension 864 is provided with a longitudinally extending slot 892 through which the crank 866 extends. The slot 892 allows longitudinal motion but not transverse motion. If desired a slider block may be positioned on the crank to engage the slot walls.

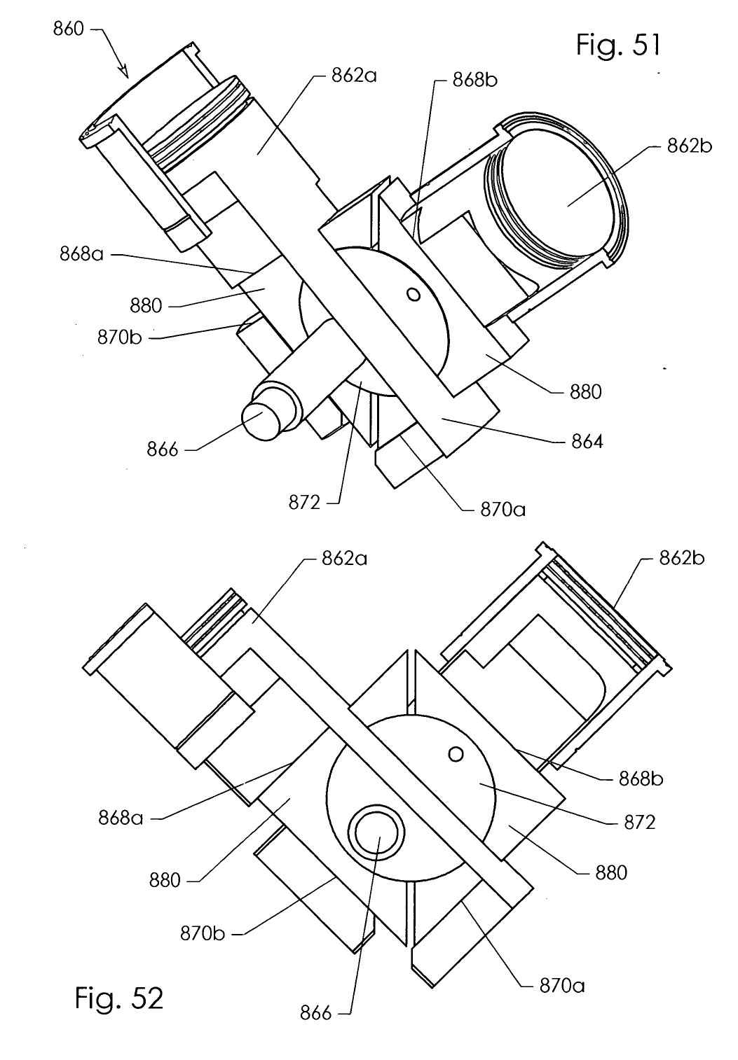

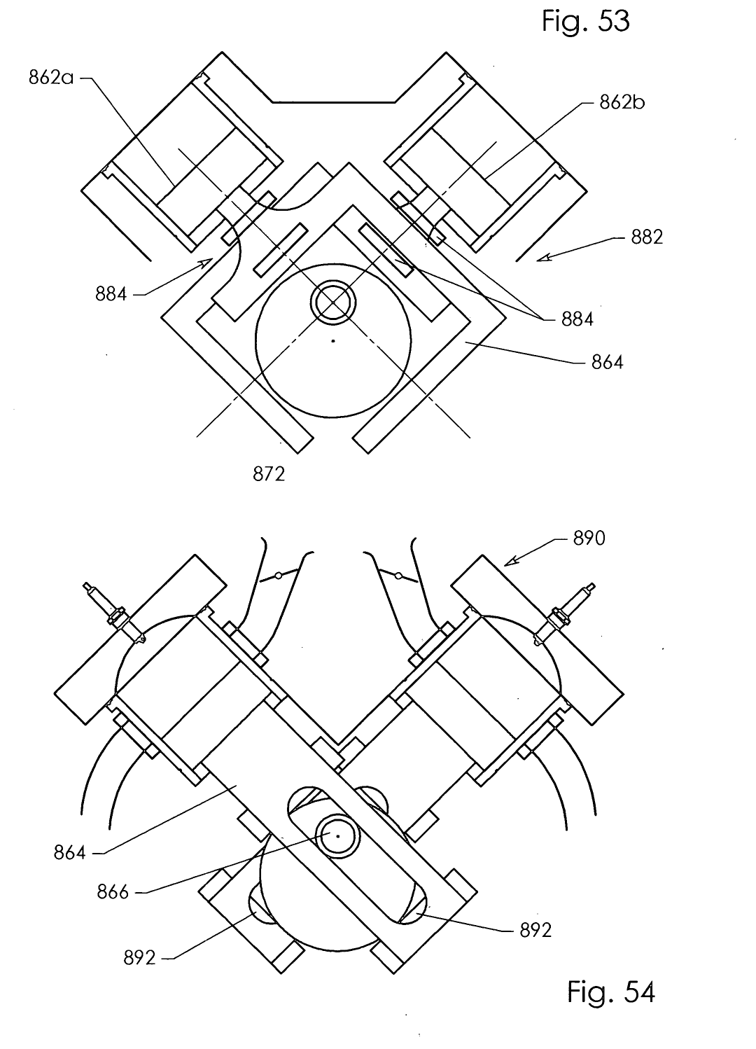

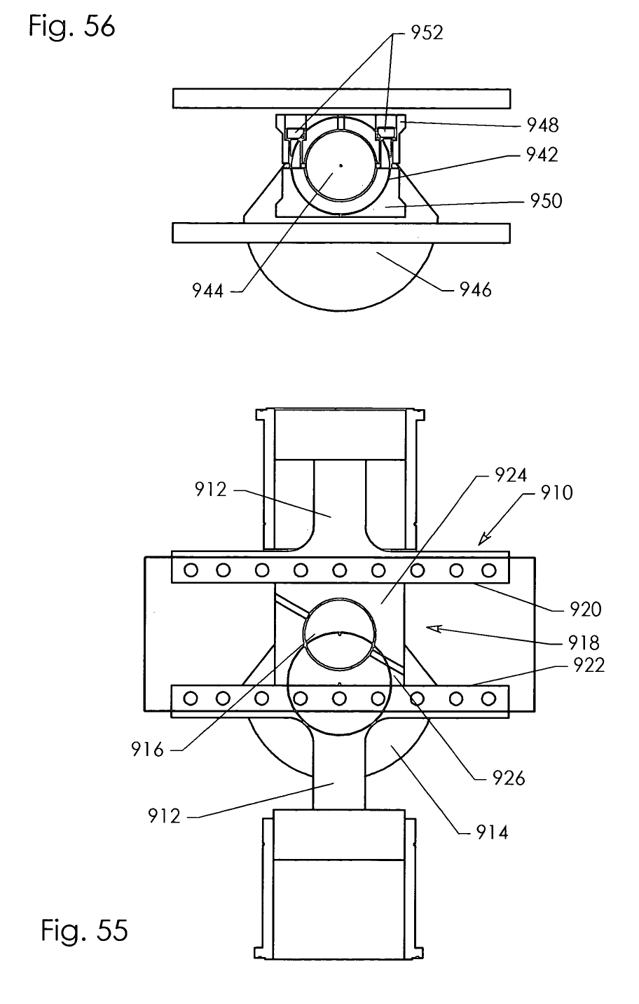

FIG. 55 shows a hybrid slider arrangement which may be utilized for any of the embodiments described herein. In this embodiment there is provided a crank 900 having an offset circular cam 902. The cam 902 is located in a slot 904 of a single or twin piston unit having end walls 906 and 908. The slot is longer than the diameter of the cam 902 and a slider is located between the cam and the end wall 908. The cam bears directly on the end wall 906.

FIG. 55 shows a scotch yoke engine 910 having twin opposed pistons 912. A crank 914 has a big end 916 upon which is mounted a slider structure 918 which slides along guide surfaces 920, 922 as the crank 914 rotates, thereby causing vertical motion of the pistons. This structure includes two independent pieces 924, 926. These two pieces 924, 926 engage surfaces 920, 922 respectively. The split line between the two pieces 924, 926 runs at about 30° but may be at any angle.

FIG. 56 shows a two piece slider assembly 942 mounted on the big end 944 of a crank 946. Whilst the assembly includes parts of 948, 950, they are rigidly joined together by bolts 952, so the structure acts as a unitary structure.

FIG. 57 shows a slider assembly 954 mounted on a big end 956. The assembly has two components 958, 960, each of which bears against one of the sides of a slot of a scotch yoke type engine. Each of the two components has a loop 962 which surrounds the big end and allows the respective component to rotate about the big end independent of the other. It will be appreciated that the loop may be separate from the body 964 of the component and attached by bolts or the like.

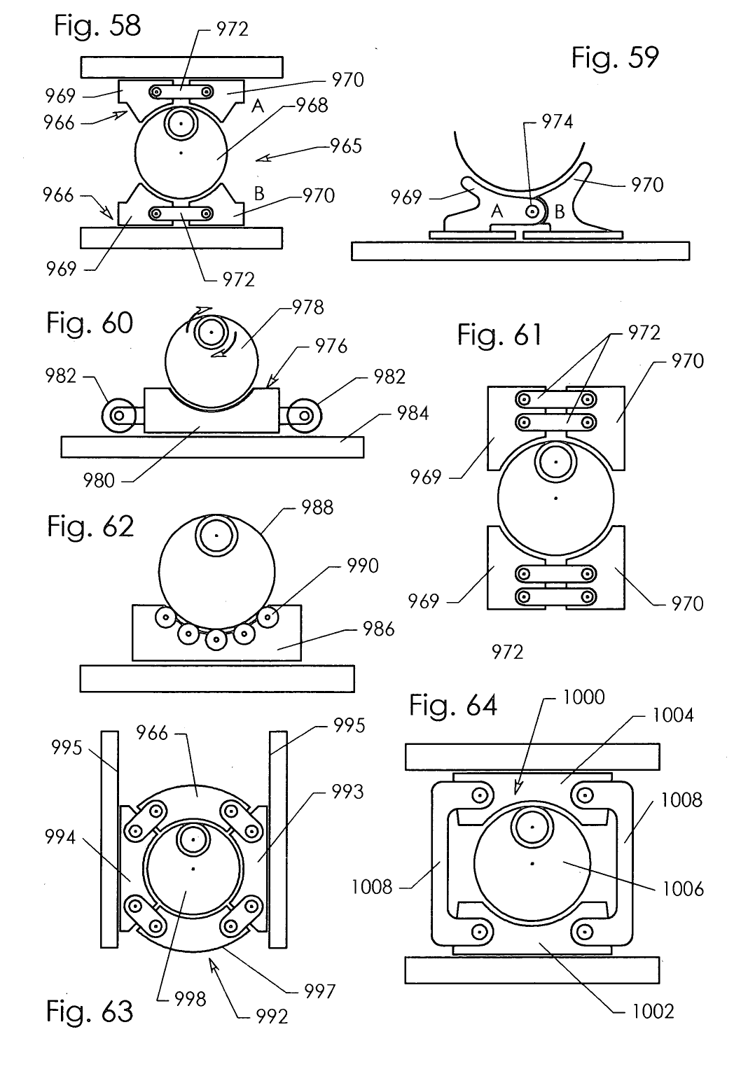

FIG. 58 shows a slider assembly 965 comprised of two slider components 966 mounted on cam 968. Each component 966 engages one side of the guide slot of a piston assembly. Each component 966 in turn is comprised of two parts 969, 970 linked by linkages 972. The linkage 972 may be rigidly attached to each component or pivotably mounted.

FIG. 59 shows a detail of one side of a slider assembly in which two parts 969 and 970 of a slider component are pivotably joined at axis 974.

FIG. 60 shows one part of a slider assembly having a slider component 976 which engages an off centre cam 978. The component has a main body 980 and rollers 982 all of which normally engage surface 984 of the slot and hold the main body 980 just above the surface 984. As the cam 978 rotates, the velocity of the component 976 along the surface 984 changes. The separation of the body 980 from the surface 984 is sufficiently small that at high velocity the body 980 floats on a film of oil and at low velocity it is supported by the rollers 982.

FIG. 61 is similar to the FIG. 58 embodiment, except that slider component parts 969, 970 are linked by two sets of linkages 972.

FIG. 62 shows a slider assembly where the slider component 986 engages the cam 988 by way of rollers 990.

FIG. 63 shows a multi part slider assembly 992 having parts 993, 994 engaging on the sides of slot 995. The two parts are joined by parts 996, 997 which closely follow the surface of the cam 998 to aid in maintaining hydrodynamic lubrication of the slider parts on the cam.

FIG. 64 shows a slider assembly 1000 having two parts 1002, 1004 on either side of a cam 1006. Linkages 1008 join adjacent ends of the two parts 1002, 1004. The linkages may be rigidly or pivotably attached to the parts.

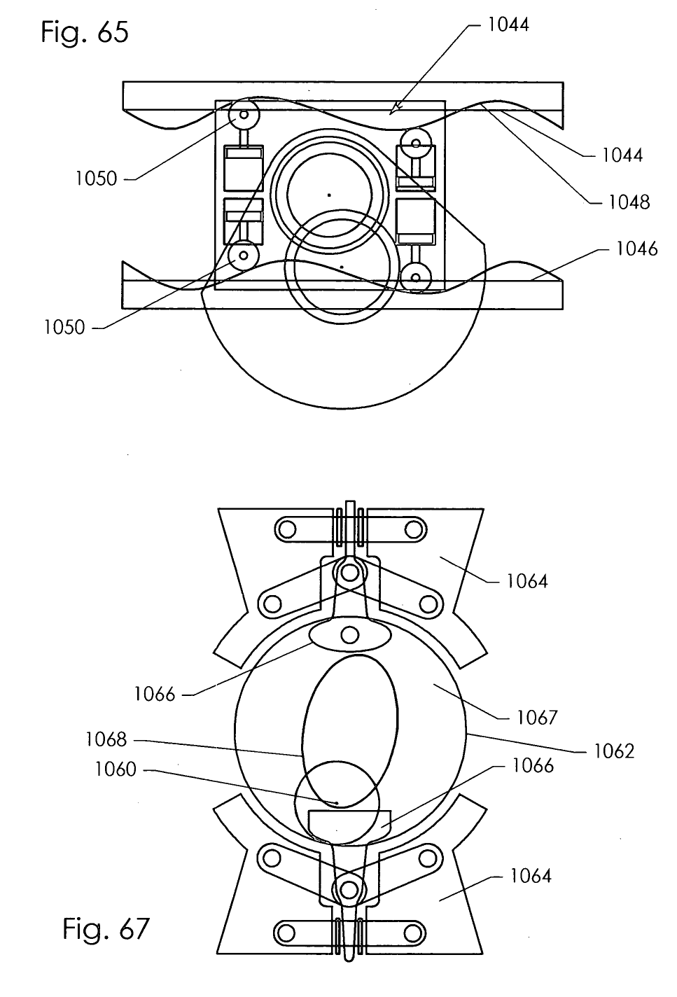

FIG. 65 shows a slide and piston assembly with linear sliding surfaces 1044 and 1046 respectively. The piston assembly has cam surfaces 1048 which are engaged by followers 1050. These followers are connected to pistons 1052 on the slider so as to pump out lubricant as needed. It will be appreciated that the cam/follower/pistons may be reversed so the cam surface is on the slider.

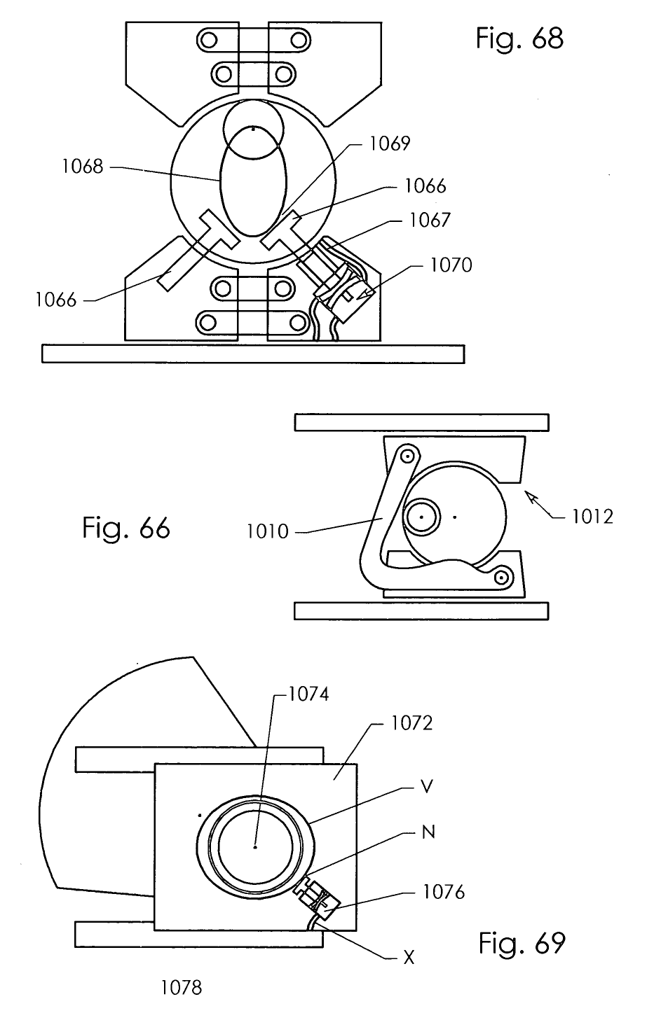

FIG. 66 shows a slider assembly having a linkage 1010 joining diagonally opposite ends of a two part slider assembly 1012.

It will be appreciated that the assemblies described above may have gaps as shown filled with rubber or other elastomeric material.

FIG. 67 shows a crank 1060 having a main, circular cam 1062 which is engaged by slider components 1064. Each slider component has a cam follower 1066. This cam follower is intermittently engaged by a second cam 1068 as the crank rotates.

FIG. 68 shows a variation of the FIG. 67 device in which the cam follower 1066 drives a pump 1070 to intermittently drive oil to various bearing regions.

Cam followers 1066 are spring loaded, being biased towards elliptical cam 1068. An oil reservoir is formed at 1069 and oil enters the reservoir through a one way valve (not shown) from the big end. At one point in its rotation, elliptical cam 1068 causes oil to be decanted from reservoir 1069. This oil is then pumped into the gap between the engagement means and the follower. Oil galley is shown at 1067. A similar configuration is found in FIG. 69, below.

FIG. 69 shows a scotch yoke assembly having a unitary slider 1072 mounted on a big end 1074. The slider 1072 has an oil pump 1076 which is intermittently engaged by a cam 1078 located on the crank.

It is to be understood that the various forms of the slider and the engagement means on the sliders may be used with any of the other forms of the invention in any practical combination possible and the various forms are not limited to use with the components shown in the specific figures.

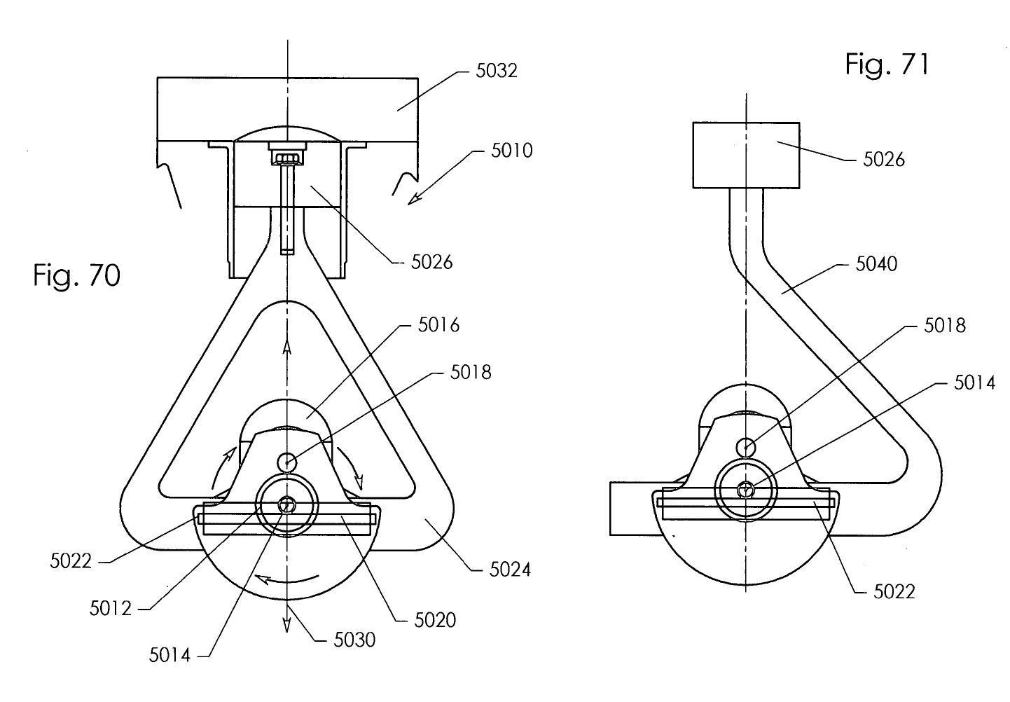

Referring to FIG. 70, there is shown a fluid device 5010 having a crank 5012 which rotates about a crank axis 5014 and has a big end 5016 with a big end axis 5018. Mounted on the big end 5016 is a connecting means 5020, which may rotate on the big end 5016 about big end axis 5018. The connecting means 5020 includes a linear slot 5022 in which an engagement means 5024 is received. The engagement means may move along the slot 5022, by sliding, via roller type bearings or via other means.

Mounted on the engagement means 5024, or integral therewith, is a piston 5026, which is mounted in a cylinder 5028 for reciprocal motion along cylinder axis 5030.

The engagement means 5024 is in the form of a triangular loop and the connecting means 5020 is positioned so that the linear slot 5022 always lies with the big end axis 5018 between the slot 5022 and the piston 5026. The piston 5026 is constrained to move along the cylinder axis 5030 and so, as the crank 5012 rotates, the slot 5022 remains horizontal with the connecting means 5020 moving both vertically (and moving the piston) and side ways, relative to the engagement means 5024.

The effect of this arrangement is that the crank axis may be moved nearer the cylinder head 5032 than otherwise.

FIG. 71 shows a variation of the FIG. 70 embodiment in which all parts and arrangements are the same except for the engagement means. Accordingly, the same numbers are used for the same components.

In the FIG. 71 device, the engagement means 5040 is not a closed loop but is open on one side. This may aid in assembly but functionally the arrangement is identical to that of FIG. 70.

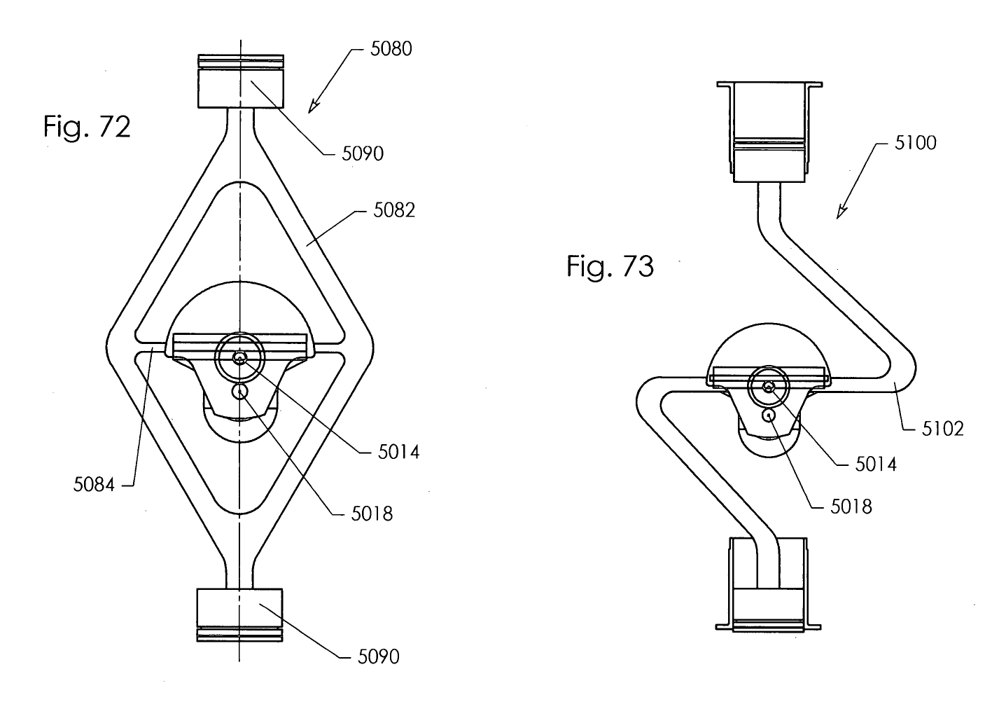

FIG. 72 shows an embodiment of the device 5080 which is based on the FIG. 70 embodiment but includes two co-axially opposed pistons 5090.

In this embodiment, there is provided a common engagement means 5082 which engages the connecting means. The engagement means is effectively the same as two of the engagement means of the FIG. 70 device joined about a common cross-piece 5084.

FIG. 73 shows a further embodiment 5100 having a similar piston, crank and cylinder lay-out to the FIG. 72 device. In this embodiment, the engagement means 5102 is Z-shaped but otherwise the device is functionally equivalent to that of FIG. 72.

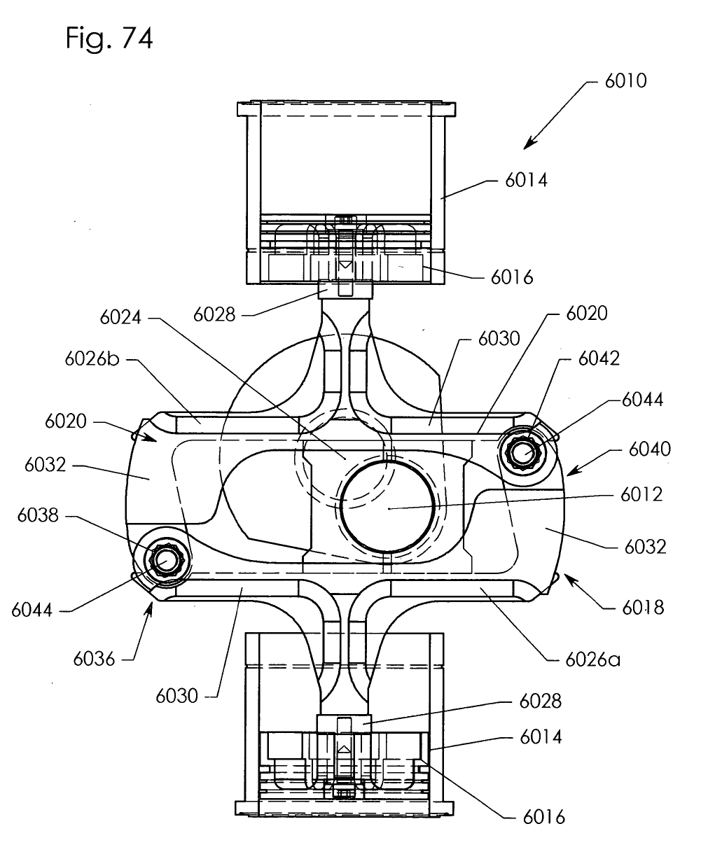

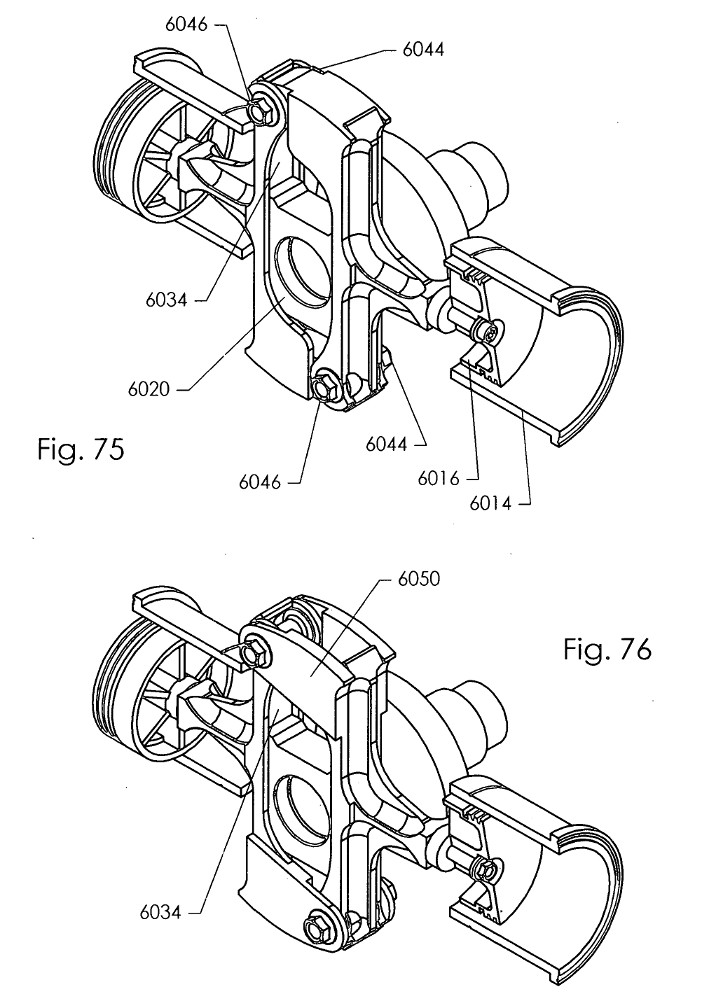

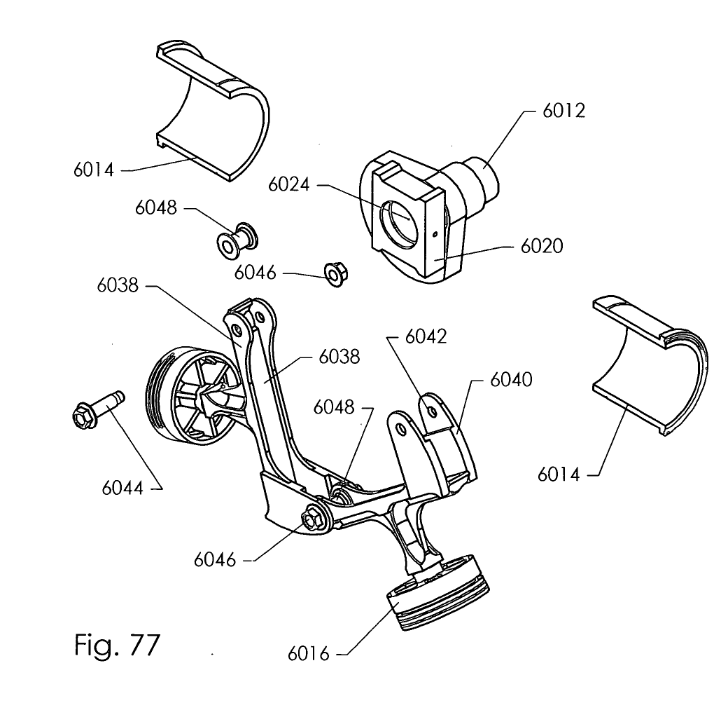

Referring to FIGS. 74 and 75 there is shown an opposed piston scotch yoke device 6010 having a crank 6012, cylinders 6014 on either side of the crank 6012 and two pistons 6016 mounted on a scotch yoke assembly 6018. The scotch yoke assembly 6018 has a slot 6020 in which a slider 6022 slides. The slider 6022 is rotatably mounted on the big end 6024 of the crank. For clarity only half of the crank is shown and in practice the big end would extend through the slider 6022.

The yoke assembly includes two identical pieces 6026a and 6026b. Each piece has a centrally located mounting 6028 on which a piston 6016 mounts, a transverse section 6030 and a longitudinal section 6032.

The transverse section 6030 extends generally perpendicular to the cylinder axes whilst the longitudinal section 6032 extends generally parallel to the cylinder axes.

A channel 6034 extends in the transverse and longitudinal sections 6030, 6032 in which the slider 6032 is located. At the free end 6036 of the transverse section 6030 are bolt holes 6038 whilst at the free end 6040 the longitudinal section there are bolt holes 6042. The two identical parts are joined with the free ends 6036 of the transverse sections 6030 engaging the free ends 6040 of the longitudinal sections 6032 of the other part. The bolt holes 6038 and 6042 align and the two parts are secured together with the bolts 6044 and nuts 6046.

A tubular spacer 6048 is positioned within the channel through which the bolts 6044 pass to prevent over tightening and crushing of the slot. The longitudinal sections 6032 have closed ends 6050.

FIG. 76 shows a variation of the FIGS. 74 and 75 device which is functionally identical except that the end 6050 of each yoke part is not closed. Instead the channel 6034 extends through the end. This aids in manufacturing as the channel 6034 may be easily ground with a grinding wheel, without the ends of the longitudinal section 6032 limiting movement of the grinding wheel. The end 6050 of the longitudinal section 6032 is not required to maintain the slider 6022 in the channel 6034.

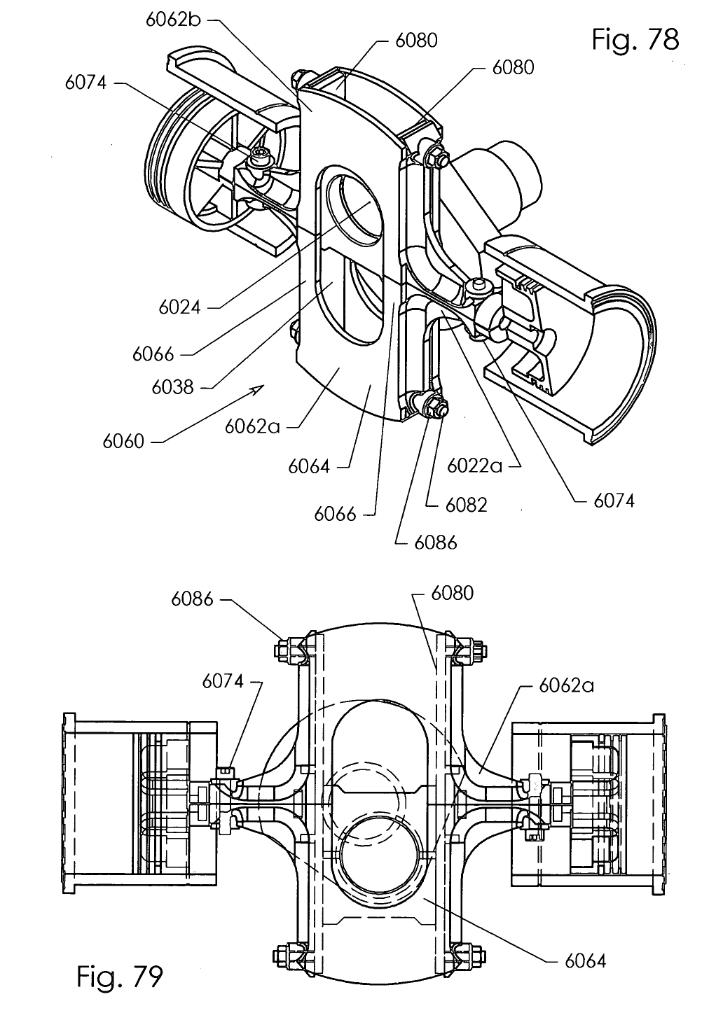

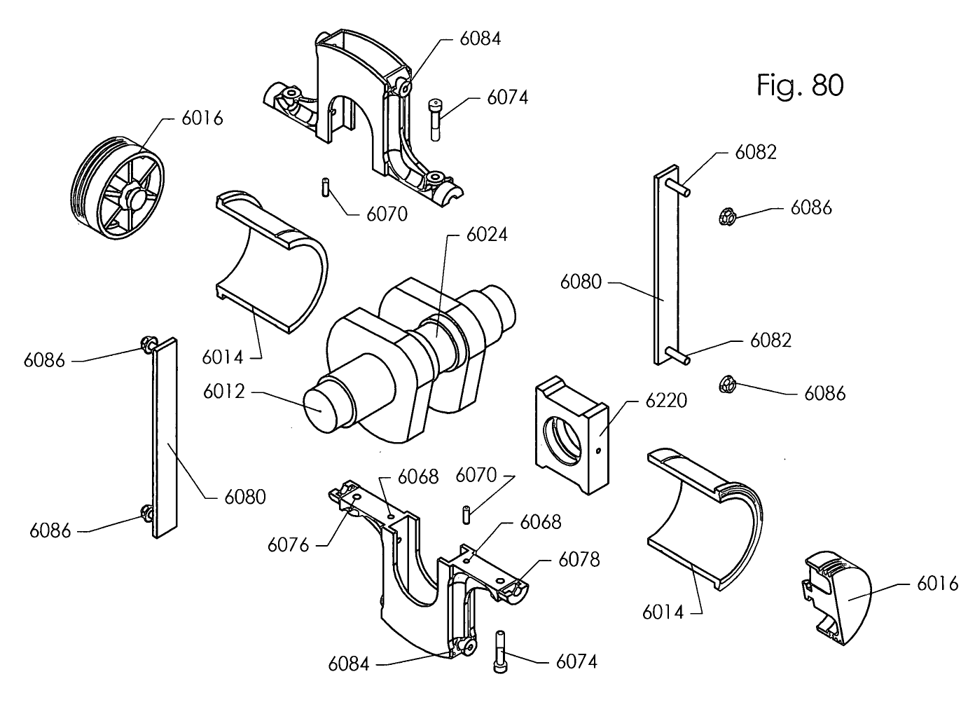

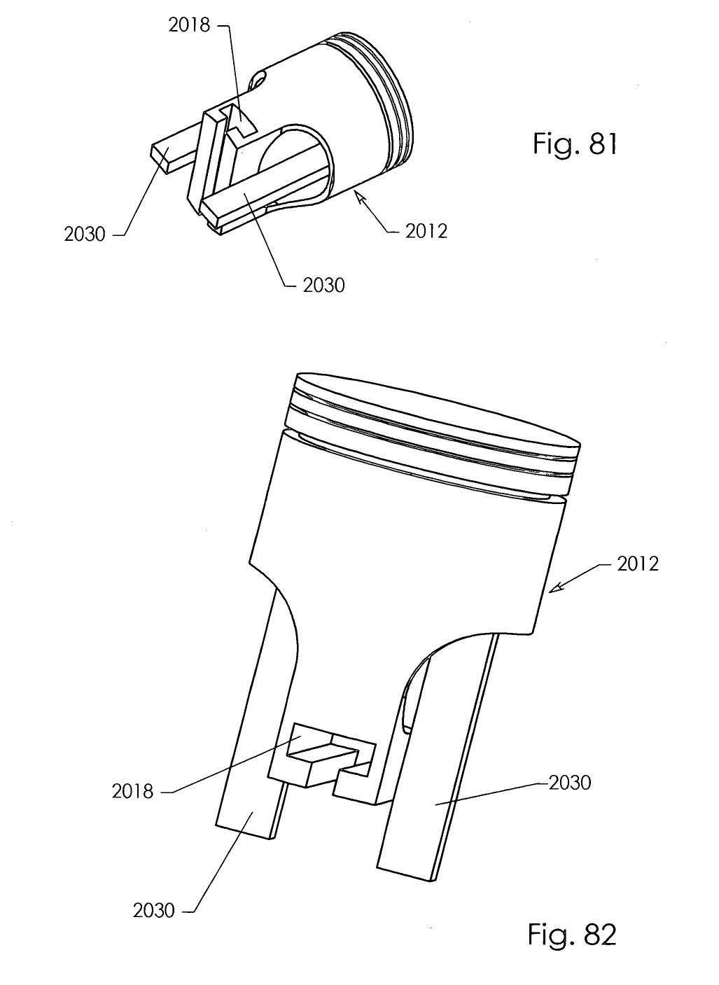

FIGS. 78 to 80 show a further variation of the yoke assembly. In this embodiment the yoke assembly 6060 is split along the cylinder axis to form two identical portions 6062a, 6062b. The portions are U-shaped, having a central body 6064 with axially extending arms 6066. Each portion is symmetrical about a centre line perpendicular to the cylinder axis.

The opposing faces of the two pairs of arms 6066 are each provided with two stud holes 6068 and studs 6070 are provided to locate the two halves together. The two halves are secured together by bolts 6074 which pass through bolt holes 6076 at each end of the arms 6066 and screw into the opposing arm 6066. The ends of the arms 6066, when joined, form a receptacle 6078 into which the piston is mounted. This receptacle allows the piston to rotate about the cylinder axis.

The assembly also includes joining members 6080. These joining members are located within the channel and have threaded studs 6082 which extend through holes 6084. The members 6080 are secured to the two halves by nuts 6086 and serve to resist bending of the two halves of the assembly out of a plane.

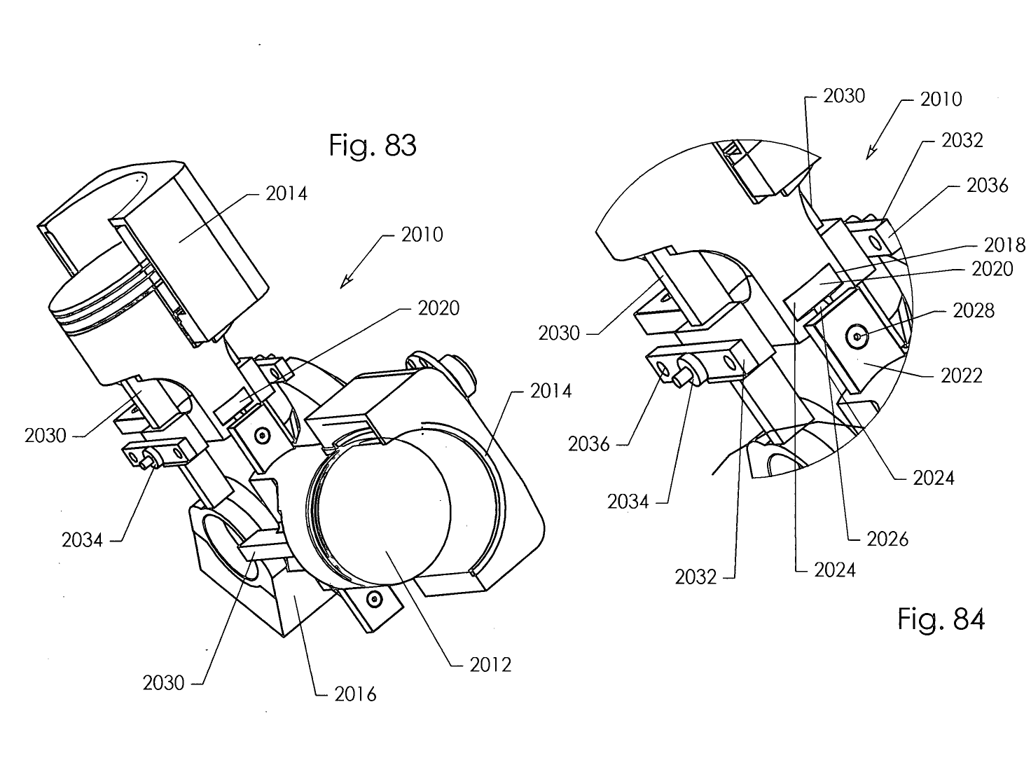

Referring to FIGS. 81 to 84 there is shown a V-twin fluid device 2010 (FIGS. 83 and 84) having two pistons 2012 reciprocating in cylinders 2014 at 90° to each other, although other angles are possible. A connecting means 2016 is rotatably mounted on a big end of a crank (not shown) and slidably engages the two pistons 2012.

Each of the pistons 2012 has a T-shaped slot 2018 which extends diametrically across each piston. The connecting means 2016 has corresponding T-shaped tongues 2020 which engage in the slots 2018. Each of the tongues 2020 has a two part construction—the cross arms are formed of a planar web 2024 which is attached to the vertical web 2026 by bolts 2028.

Located on either side of the slot 2018 are two axially extending restricting means, namely planar webs 2030. These webs 2030 are diametrically opposite each other and extend perpendicularly to the slot 2018 but do not extend out of the footprint of the piston. Webs 2030 extend beyond slot 2018. The webs 2030 are integral with the piston body.

The fluid device has a series of U-shaped guides 2032 which engage the webs 2030, as seen in FIGS. 83 and 84. The guides 2032 are rigidly mounted on the crank case (not shown) and so aid in limiting any wobbling of the pistons as they move within the respective cylinders.

The guides are preferably located on the crank case by way of a locating pin 2034 and then bolted via bolt holes 2036. 384 The guides 2032 serve to limit movement of the pistons both parallel and transverse to the slot 2018 and so enable the skirt length of the piston to be reduced, if desired.

Because the webs 2030 are located to the sides of the slot, rather than at one or both of its ends, the size of the crank case need not be any greater than a conventional crank case. Further, because the webs 2030 do not extend outside the footprint of the piston, an existing crank case can be relatively easily modified to take the crank and piston assembly.

The webs and the slot 2018 may be formed integrally with the piston 2012 and so be formed of the piston material. Alternatively, separate components may be provided and the piston assembly built up from those components. Preferably, the bearing surfaces of the slot 2018 and the webs 2030 are suitably treated to provide a hard wearing surface or are provided with bearings to provide a suitable surface. It is to be understood that oil lubrication will be provided to the bearing surfaces via oil galleries or by oil splashing.

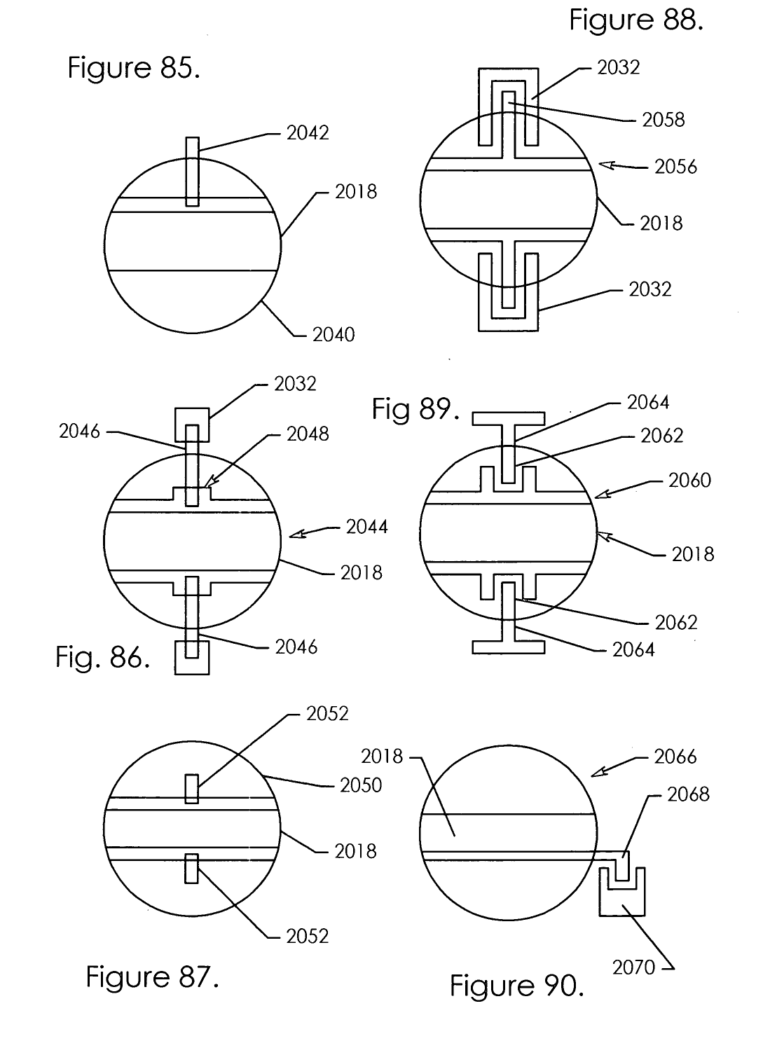

FIGS. 85 to 126 show bottom plan views of different configurations of piston webs or vertical guide means which may be used with the connecting means 2016 shown in FIGS. 83 and 84. The guides which take the place of guides 2032 corresponding to the vertical webs 2030 of each piston in FIGS. 81 to 84 are not always shown but it will be apparent that the guides need to have a shape corresponding to the surface of the webs.

FIG. 85 shows a piston 2040 having a single axial web 2042. The web 2042 extends perpendicularly to the slot 2018 along a radial line. The web 2042 also extends beyond the piston's circumference. The web 2042 may be integral with the piston or a separate component.

FIG. 86 shows a piston 2044 having two parallel webs 2046 extending perpendicularly to the slot 2018 along a diametrical line. The webs 2046 extend beyond the piston bore to engage guides, 2032. Each web is a separate component and engages in an axially extending slot 2048 on the piston.

FIG. 87 shows a piston 2050 having two separate as opposed to integral webs 2052 which engage in slots 2054 in the piston. Otherwise, this structure is similar to that of the FIGS. 81 and 82 pistons.

FIG. 88 shows a piston 2056 with a similar construction to that of the FIGS. 81 and 82 piston except that webs 2058 extend beyond the bore of the piston.

FIG. 89 shows a piston 2060 having two axially extending slots 2062 which engage axially extending webs 2064 mounted on the crank case.

FIG. 90 shows a piston 2066 having an axially extending web 2068 which is located at one end of the slot 2018 and is engaged by a U-shaped guide 2070.

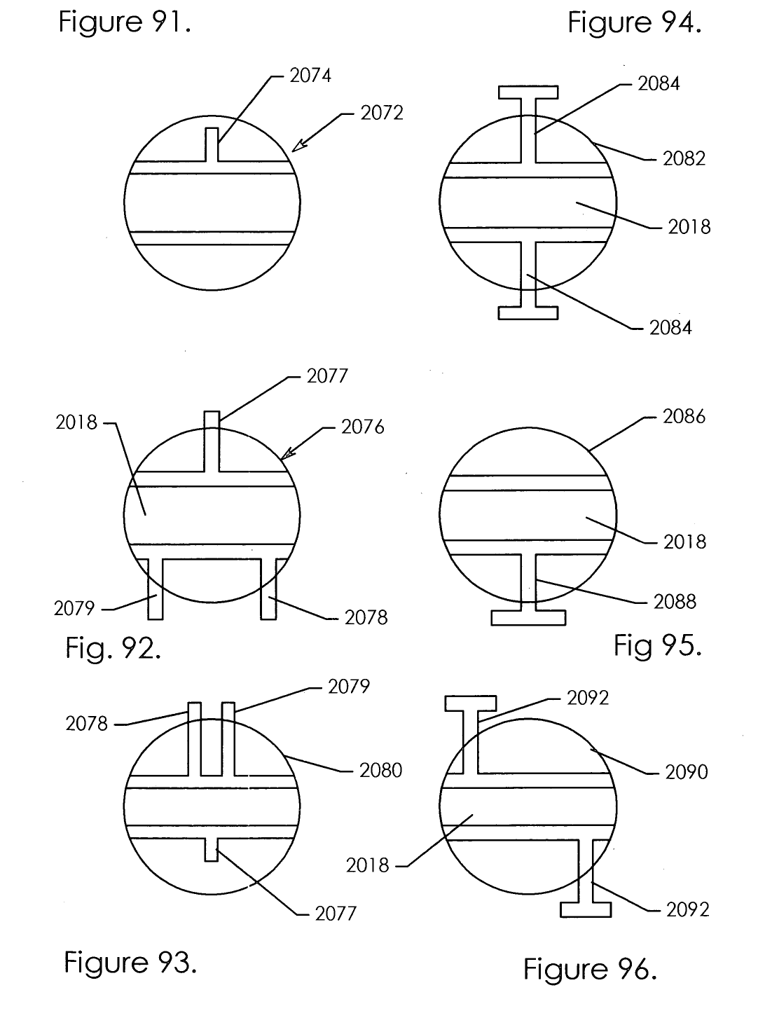

FIG. 91 shows a piston 2072 having a single integral web 2074.

FIG. 92 shows a piston 2076 having three webs 2077, 2078 and 2079. One web 2077 extends perpendicularly to the slot 2018 along the centre line of the piston 2076 whilst the other two webs 2078 and 2079 extend perpendicularly to the slot from the opposite side to web 2077. The webs 2078 and 2079 are spaced apart and located towards the ends of the slot 2018. All three webs extend beyond the piston's circumference.

FIG. 93 shows a piston 2080 similar to that of FIG. 92 except that the two webs 2078 and 2079 are much closer together and located toward the centre of the slot 2018. In addition, the single web 2077 remains within the piston's circumference.

FIG. 94 shows a piston 2082 having two T-shaped webs 2084 extending diametrically opposite to each other perpendicular to the slot 2018.

FIG. 95 shows a piston 2086 similar to that of FIG. 94 but having a single T-shaped web 2088 extending from the middle of the slot 2018.

FIG. 96 shows a piston 2090 having two T-shaped webs 2092 which are offset from the centre of the slot 2018. The offset is symmetrical about the piston's centre, but need not be.

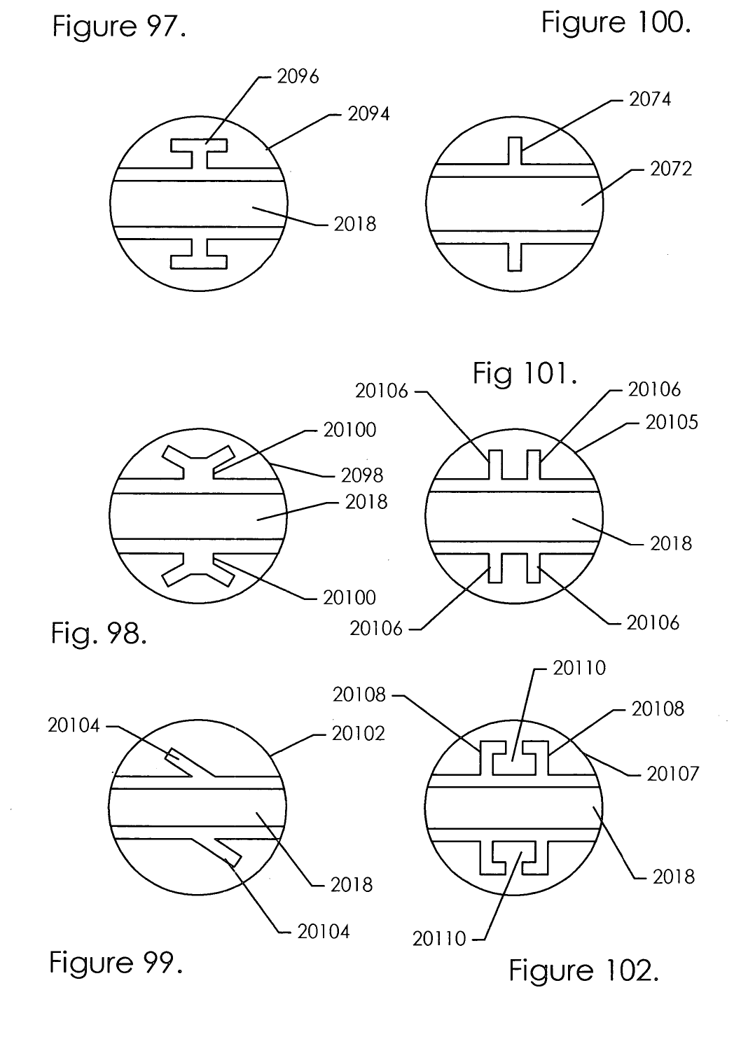

FIG. 97 shows a piston 2094 similar to that of FIG. 94 except that the T-shaped webs 2096 remain within the bore or footprint of the piston.

FIG. 98 shows a piston 2098 having Y-shaped axially extending webs 20100 which extend from the centre of the slot 2018.

FIG. 99 shows a piston 20102 having two webs 20104 extending from the centre of the slot 2018 but inclined at about 45° rather than 90°.

FIG. 100 shows a piston similar to that in FIG. 91, except that there are two integral webs 2074.

FIG. 101 shows a piston 20105 having four webs 20106 extending perpendicularly to the slot 2018. Each web is engaged by a respective guide member (not shown).

FIG. 102 shows a piston 20107 in which two pairs of L-shaped members 20108 define two axially extending T-shaped slots 20110 with which a T-shaped guide member (not shown) engages.

FIG. 103 shows a piston 20112 having two webs 20114, each of which has a concave surface 20116 for engaging a complementary guide means. The surfaces 20116 may be elliptical, circular or any other shape.

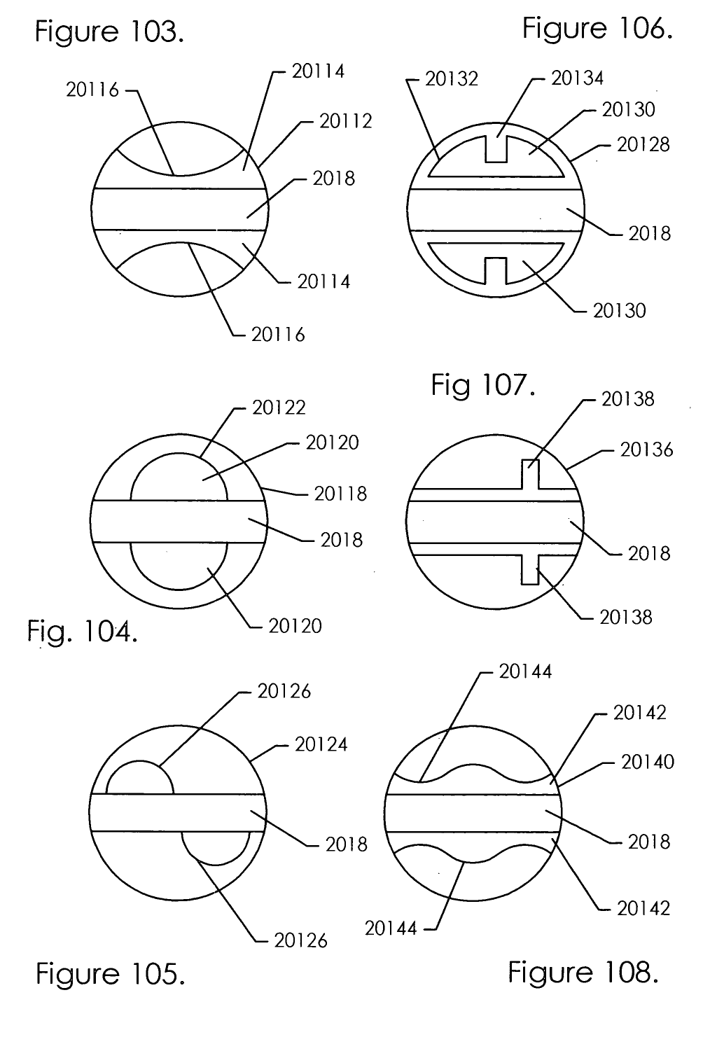

FIG. 104 shows a piston 20118 having two webs 20120 with convex surfaces 20122. These surfaces 20122 may be elliptical, circular or any other shape.

FIG. 105 shows a piston 20124 with two webs 20126 similar to those of the FIG. 104 device but in which the webs 20126 are offset in opposite directions from the centre of the slot 2018. The offset may be symmetrical or asymmetrically.

FIG. 106 shows a piston 20128 with two webs 20130 having convex surface 20132. A slot 20134 extends inwardly from the convex surface 20132 towards the centre of the slot 2018.

FIG. 107 shows a piston 20136 having two webs 20138 extending perpendicularly to the slot 2018. Both webs 20138 are offset from the centre of the piston and are opposite each other.

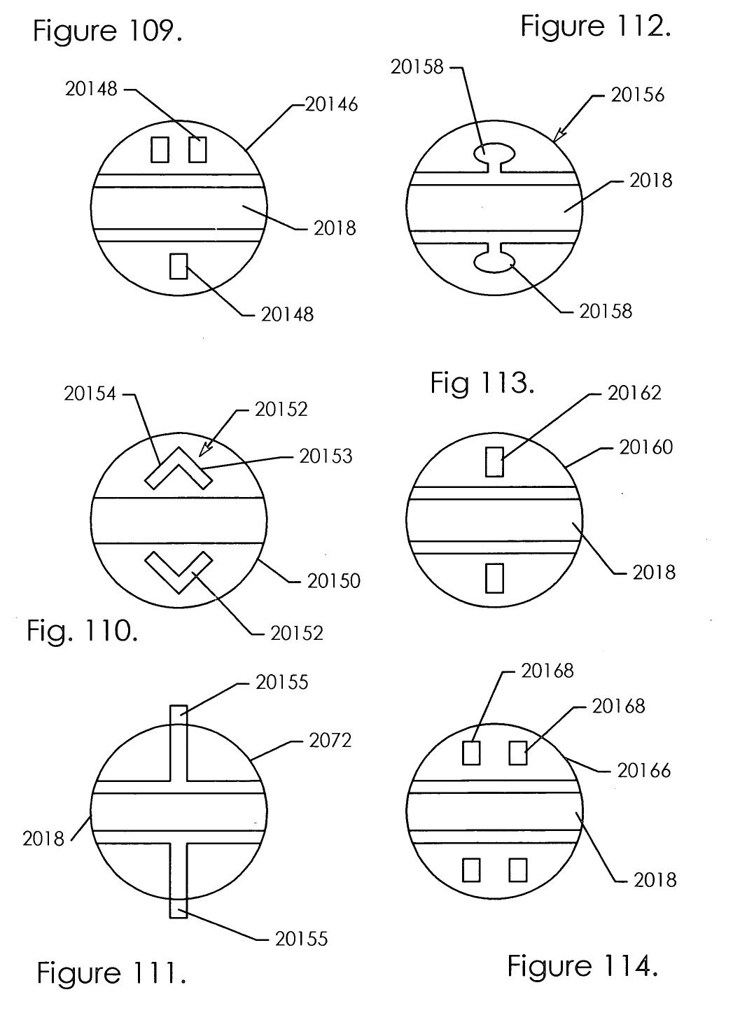

FIG. 108 shows a piston 20140 with two axially extending webs 20142. Each web has an undulating surface 20144 which engages a corresponding guide surface. These undulating surfaces 20144 may be arcuate, ellipsoidal or any other suitable shape. The shape may be regular or irregular.

FIG. 109 shows a piston 20146 similar to that of FIGS. 92 and 93 in having webs 20148 which are rectangular in cross-section. However, the webs 20148 do not engage and are not integral with the housing for the slot 2018. Instead the webs extend from the underside of the piston 20146.

FIG. 110 shows a piston 20150 having two webs 20152 extending downwards from the main body of the piston separately from the housing for the slot 2018. Each web is formed of two arms 20153, 20154 which extend at 900 to each other. The arms may extend at other angles.

FIG. 111 shows a piston 2072, similar to that of FIG. 100, except that webs 20155 extend beyond the footprint of piston 2072.

FIG. 112 shows a piston 20156 with two axially extending webs 20158. The webs 20158 have, in cross section, a mushroom shape.

FIG. 113 shows a piston 20160 with two axially extending webs 20162 which do not engage the housing for the slot 2018.

FIG. 114 shows a piston 20166 similar to that of FIG. 113 but with four axially extending webs 20168. Two of the webs 20168 are located on either side of the slot 2018. The arrangement of the four members is preferably symmetrical about the centre of the piston.

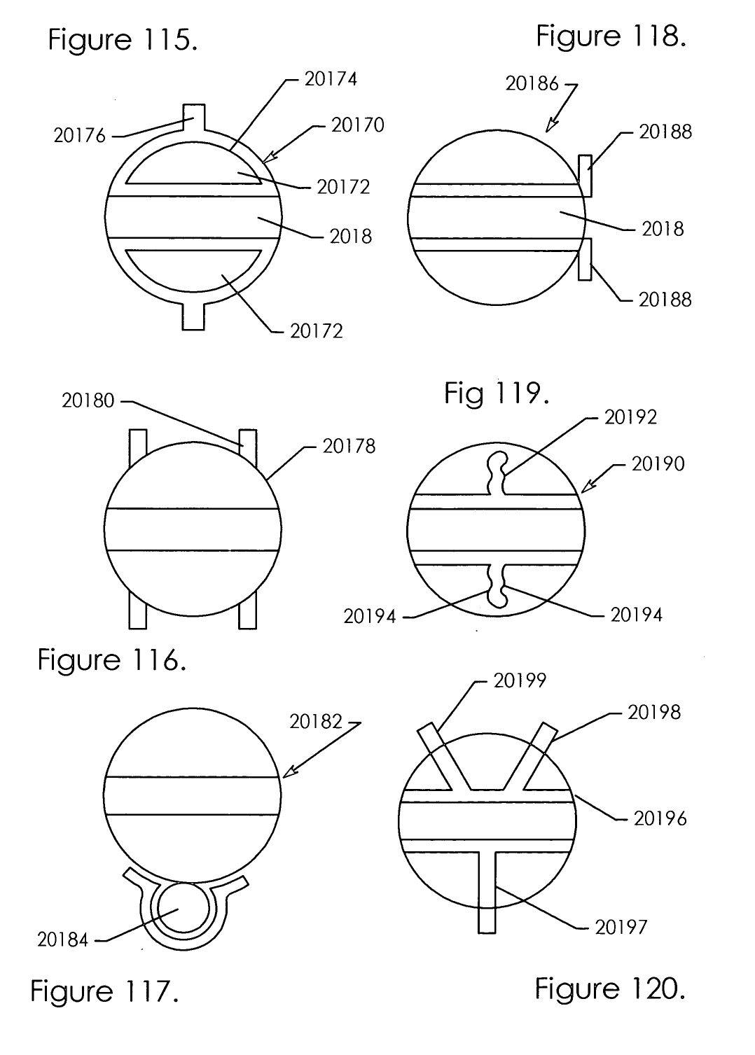

FIG. 115 shows a piston 20170 with two pairs of guide webs. A first pair 20172 extends from the underside of the main body of the piston and has a circular or elliptical outer surface 20174. The other pair 20176 extend from the circular peripheral surface of the piston.

FIG. 116 shows a piston 20178 having four axial guide webs 20180 extending from the circular peripheral surface of the piston.

FIG. 117 shows a piston 20182 having a substantially rod shaped guide web 20184 extending axially. The guide member 20184 is integral with or mounted to the circumference of the piston.

FIG. 118 shows a piston 20186 similar to that of FIG. 90 except that two guide webs 20188 are provided at one end of the slot 2018.

FIG. 119 shows a piston 20190 with two guide webs 20192 extending axially and generally radially from the housing of the slot 2018. Each web 20192 has undulating side surfaces 20194. These may have any shape desired.

FIG. 120 shows a piston 20196 with three guide webs 20197, 20198 and 20199. The guide web 20197 extends perpendicularly to the slot 2018 whilst webs 20198 and 20199 extend divergently to each other from the slot 2018. Preferably, all three webs extend radially-from the slot 2018.

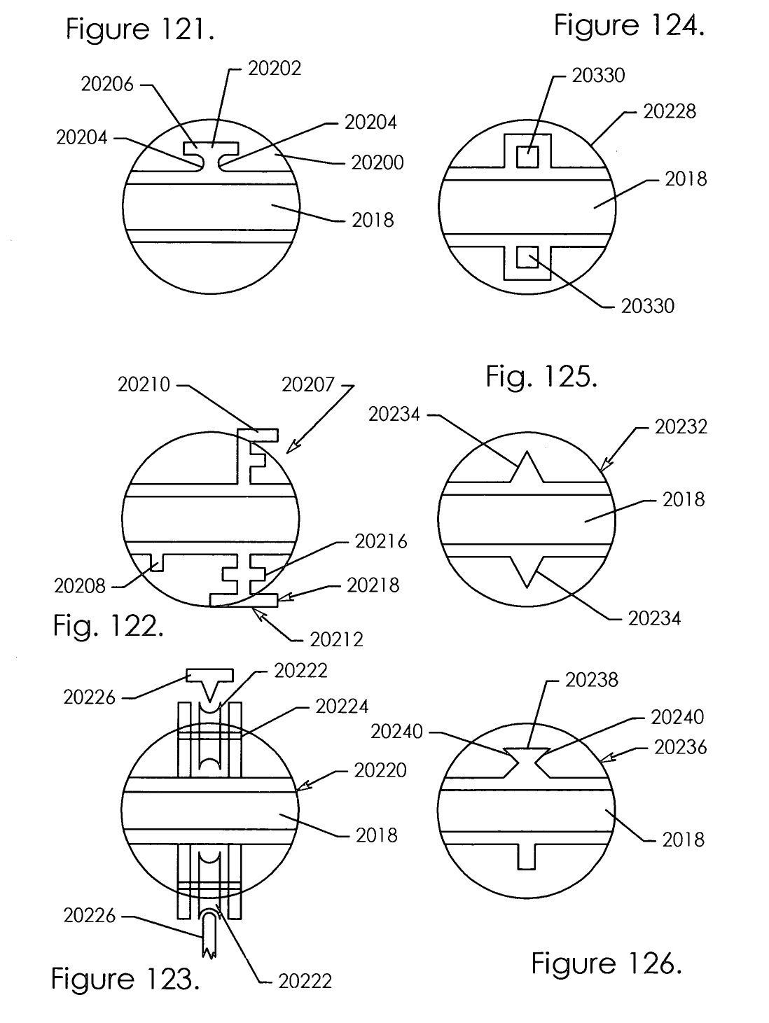

FIG. 121 shows a piston 20200 having a single guide web 20202 having a T-bar extending axially. The guide web 20202 has concave sides 20204 and planar outer surface 20206. Preferably surface 20206 is parallel to the slot 2018.

FIG. 122 shows a piston 20207 having three axially extending guide webs 20208, 20210 and 20212. Guide web 20208 is a simple rectangle in cross section, guide web 20210 is F-shaped in cross section, whilst guide member 20212 has a central spine with arms 20216 and 20218 extending from its side. The arms 20216 and 20218 may have the same or different lengths.

FIG. 123 shows a piston 20220 having at least one roller 20222 mounted on each side of the slot 2018 by axle pins 20224. The rollers 20224 engage an axially extending guide 20226 mounted on the crank case. The piston may be provided with two or more rollers on either side of the slot 2018.

FIG. 124 shows a piston 20228 having two rectangular section tubes 20230 extending axially on either side of the slot 2018. These tubes 20230 are open at least one end and receive axially extending guide rods mounted on the crank case.

FIG. 125 shows a piston 20232 having triangular shaped guide webs 20234 extending axially on either side of the slot 2018.

FIG. 126 shows a piston 20236 having a guide web 20238 with triangular indents 20240 in its two sidewalls.

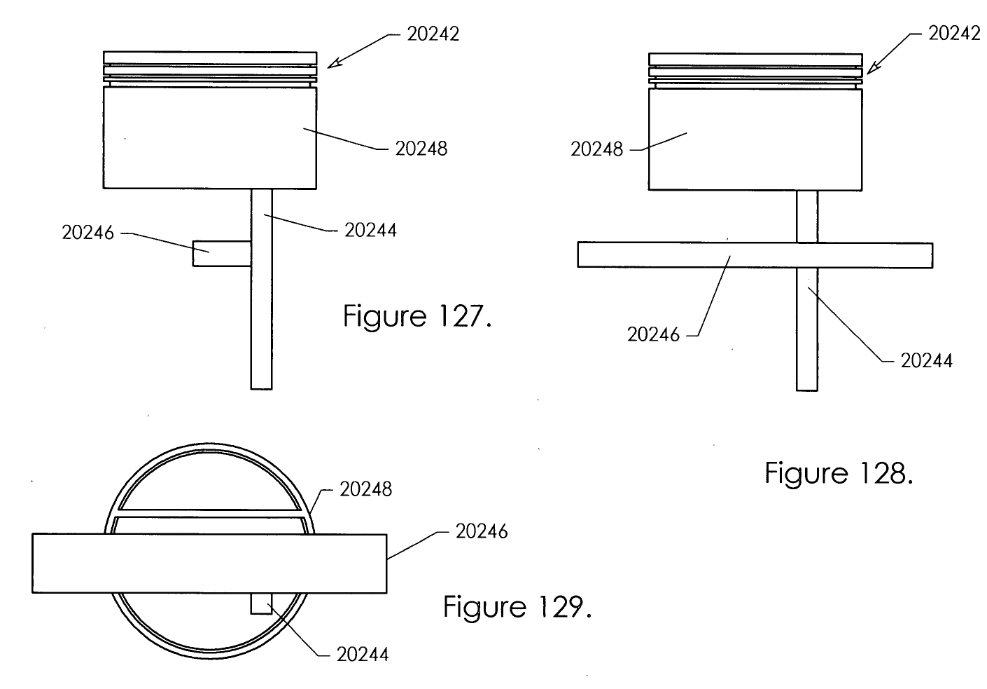

FIGS. 127 to 129 show a piston 20242 with a vertically extending guide bar 20244 and a horizontal slide bar 20246. The bar 20244 extends from the lower surface of the main body 20248 of the piston 20242. The horizontal bar 20246 is mounted on an inner side of the vertical bar 20244. The bar 20246 is engaged by a suitable engagement means on the connecting means whilst the vertical bar 20244 is engaged by a suitable guide surface mounted on the crank case.

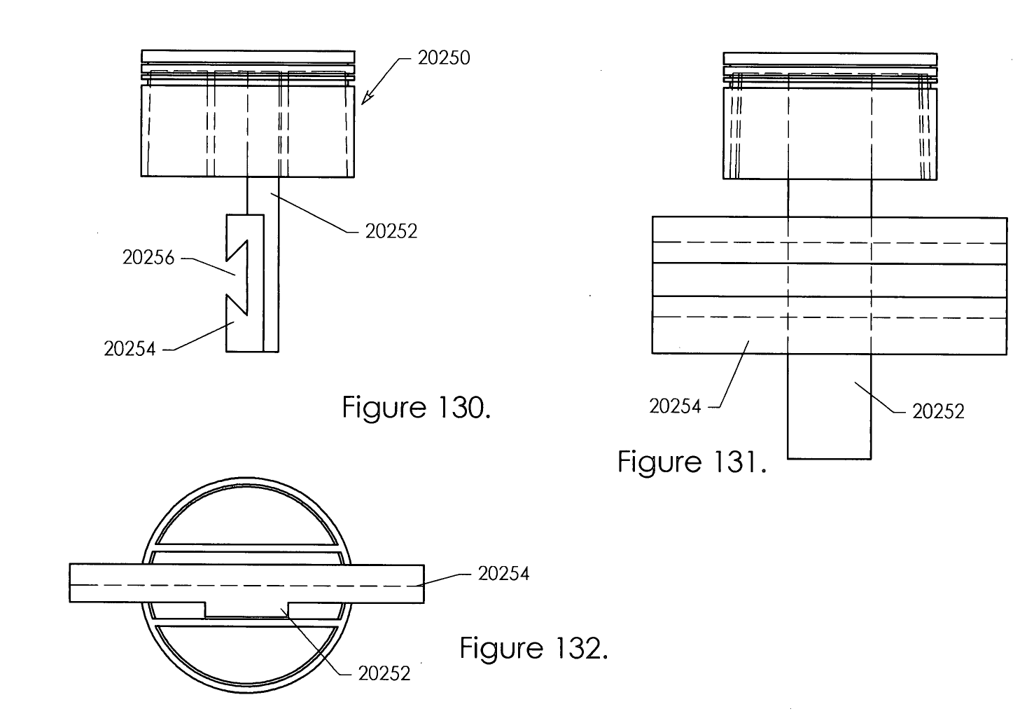

FIGS. 130 to 132 show a piston 20250 with a vertical guide bar 20252 and a horizontal bar 20254. The horizontal bar 20254 has a re-entrant slot 20256 for slidably engaging a corresponding tongue on a connecting means.

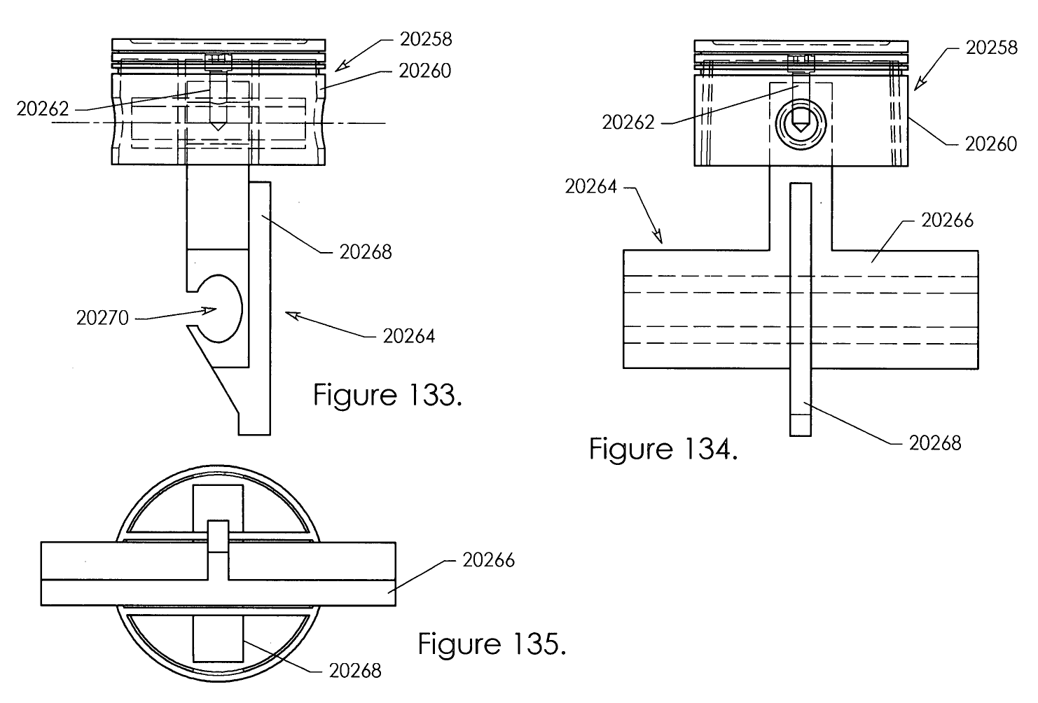

FIGS. 133 to 135 show a piston 20258 having a main body 20260. Rotatably mounted to the main body by a gudgeon pin 20262 is a engagement/guide means 20264. This engagement means includes a horizontally extending portion 20266 and a vertical extending portion 20268. The horizontal portion includes a slot 20270 which slidably receives a complimentary tongue on the connecting means whilst the vertical portion 20268 is engaged by a guide mounted on the crank case. It will be noted that the vertically extending portion extends above and below the horizontally extending portion.

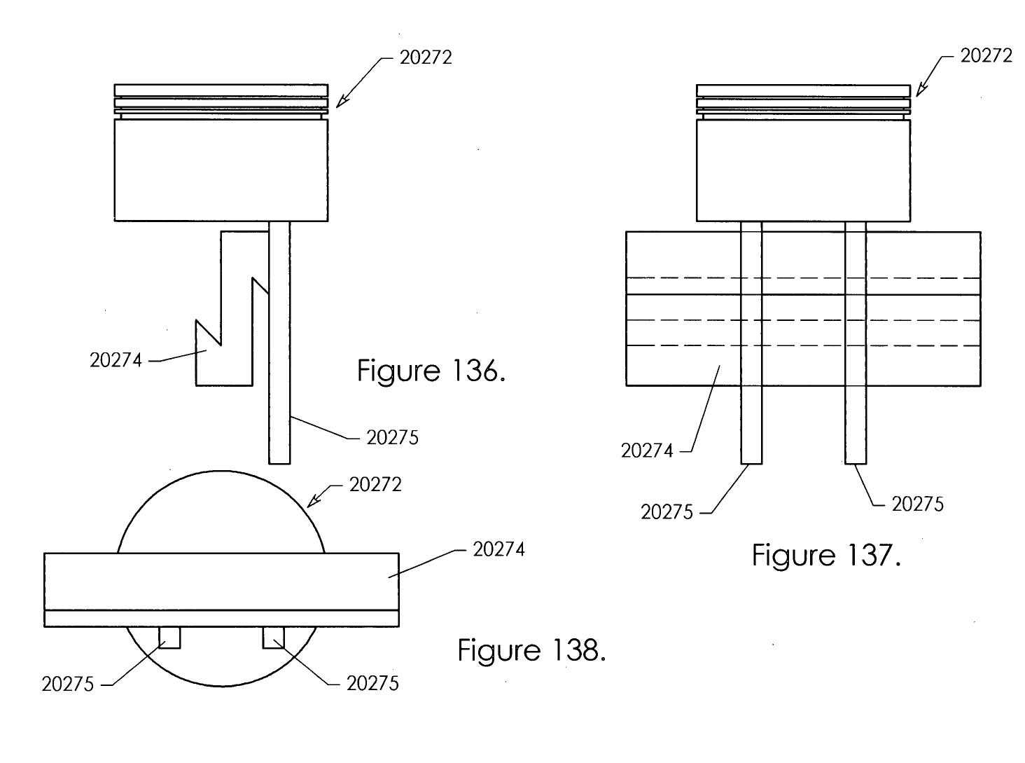

FIGS. 136 to 138 show a piston assembly 20272 with a Z-shaped horizontally extending member 20274 which slidably engages a complimentary surface on the connecting means. Guide webs 20275 engage guides mounted on the crank case.

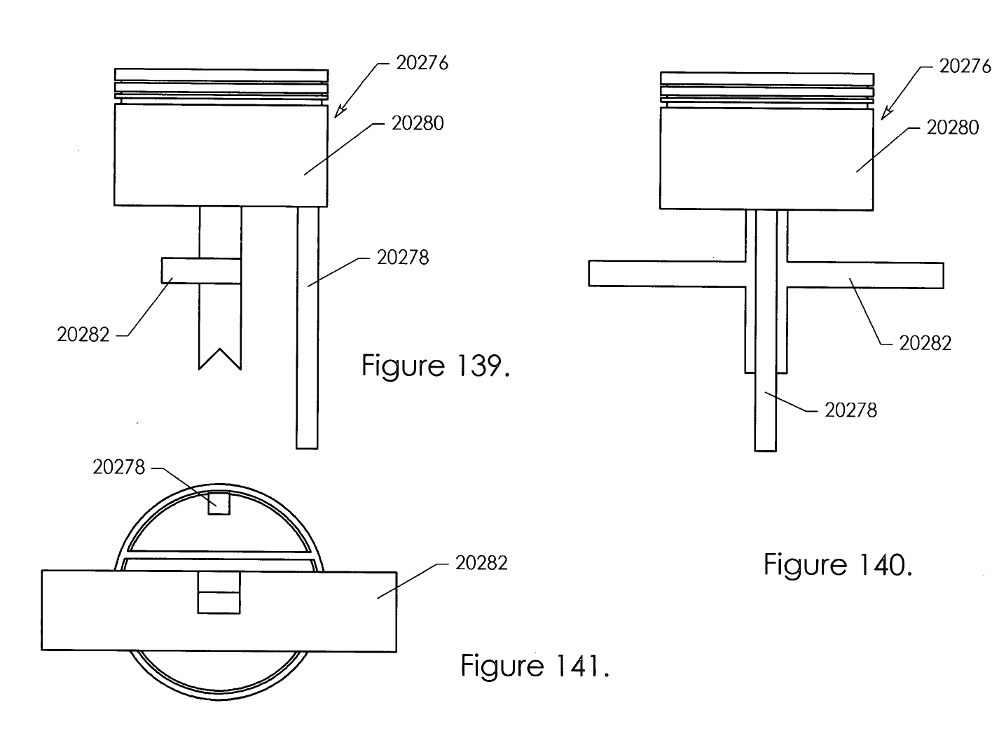

FIGS. 139 to 141 show a piston assembly 20276 in which a vertical guide bar 20278 extends from the base of the main body 20280 of the piston. A horizontal bar 20282 is mounted on the main body 20280 independently of the vertical guide bar 20278.

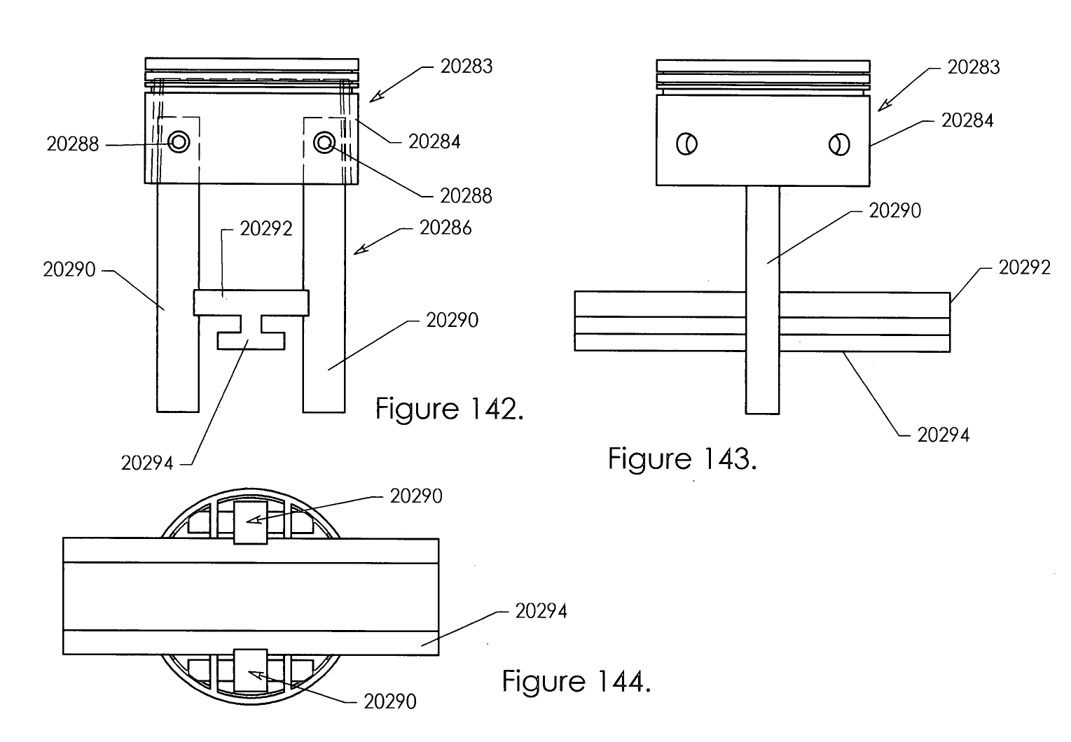

FIGS. 142 to 144 show a piston assembly 20283 having a main body 20284 and an engagement/guide assembly 20286 mounted to the main body by pins or bolts 20288. The engagement/guide assembly 20286 has two vertical legs 20290 and a cross bar 20292. Mounted on the cross bar 20292 is a horizontally extending T-shaped engagement member 20294 which extends perpendicular to the plane of the two vertical guide bars 20290. This member 20294 is engaged by the connecting means.

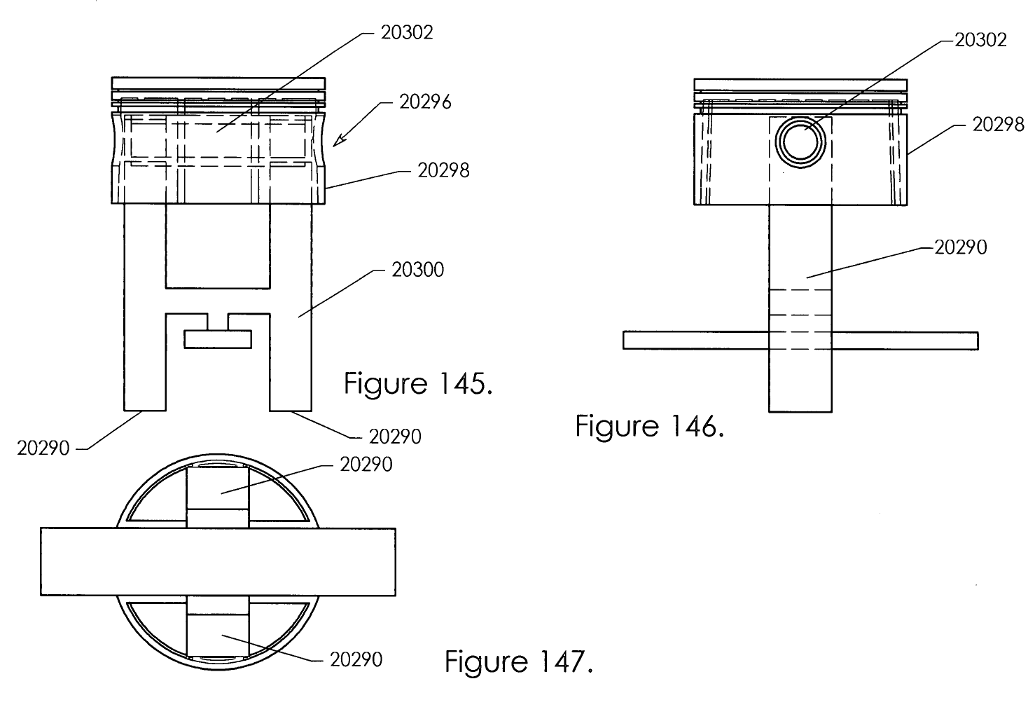

FIGS. 145 to 147 show an assembly 20296 similar to that of FIGS. 142 to 144 and a similar engagement/guide assembly 20300 is mounted to the main body 20298 of the piston 20296. The assembly 20300 is mounted-to the main body 20298 by a gudgeon pin 20302 which extends in the plane of the two legs 20290. The assembly 20300 may pivot about the pins 20302.

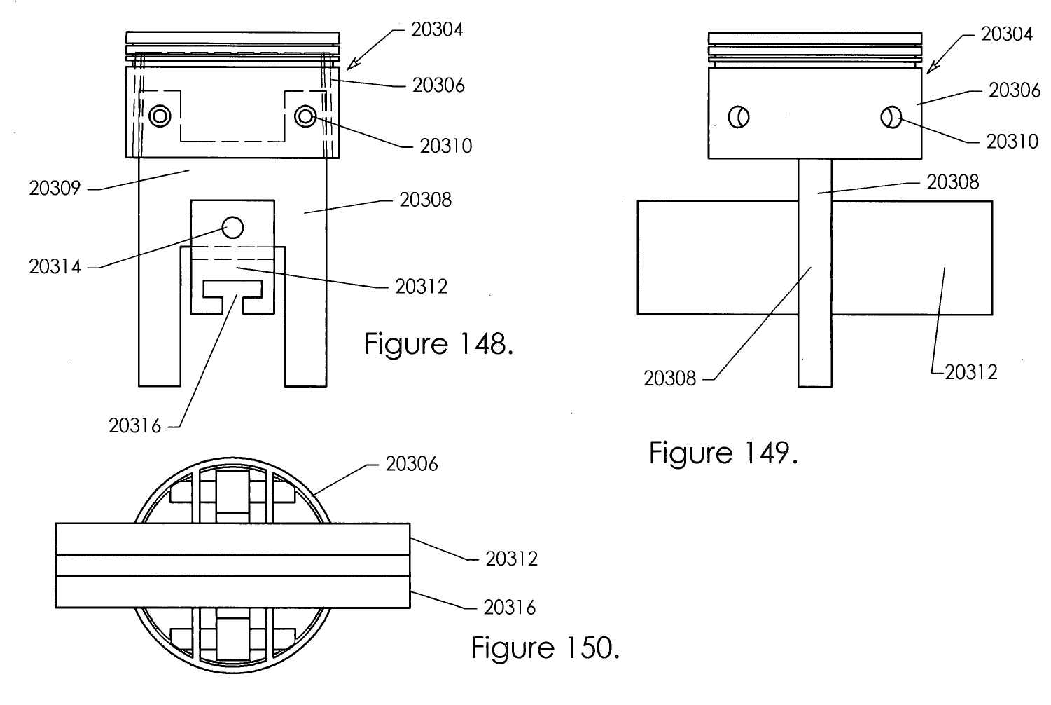

FIGS. 148 to 150 show a piston assembly 20304 having a main body 20306 on which is mounted an H-shaped guide assembly 20308. The assembly is mounted to the main body 20306 via pins 20310. Mounted on the cross bar 20309 of the assembly 20308 is a horizontally extending engagement bar 20312. The bar 20312 is pivotably mounted to bar 20309 via pin 20314. The bar 20312 has a T-shaped slot 20316 for engaging a T-shaped tongue on the engagement means.

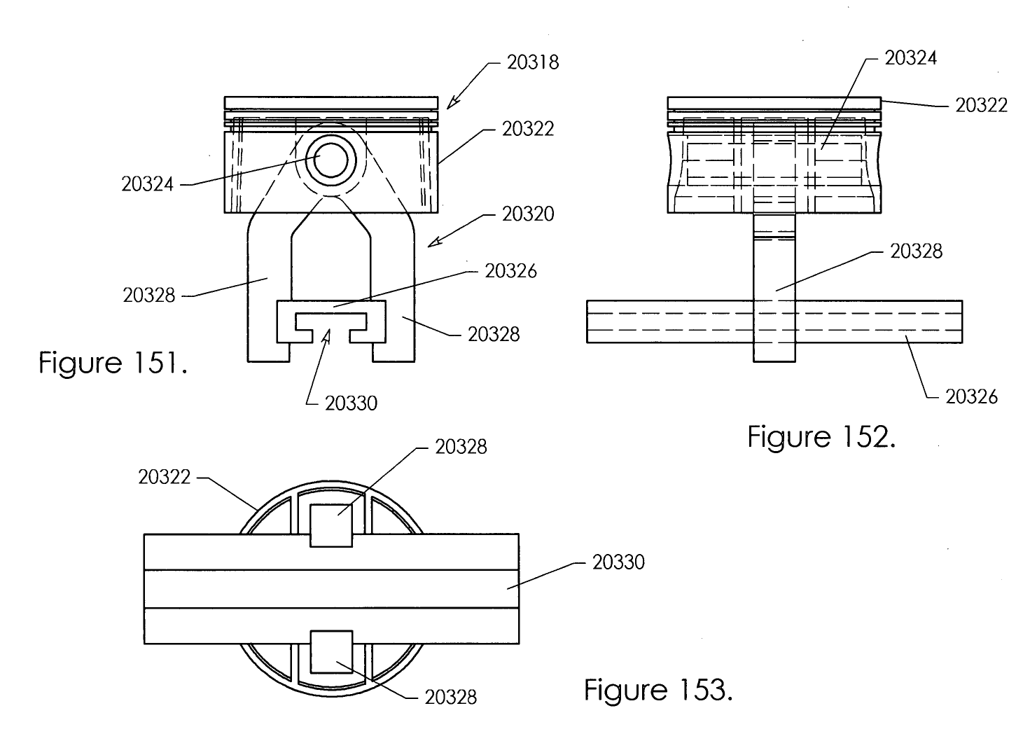

FIGS. 151 to 153 show a piston assembly 20318 having a guide/engagement means 20320 mounted to the main body 20322 via pin 20324. A cross bar 20326 extends between vertical members 20328 and includes a T-shaped slot 20330.

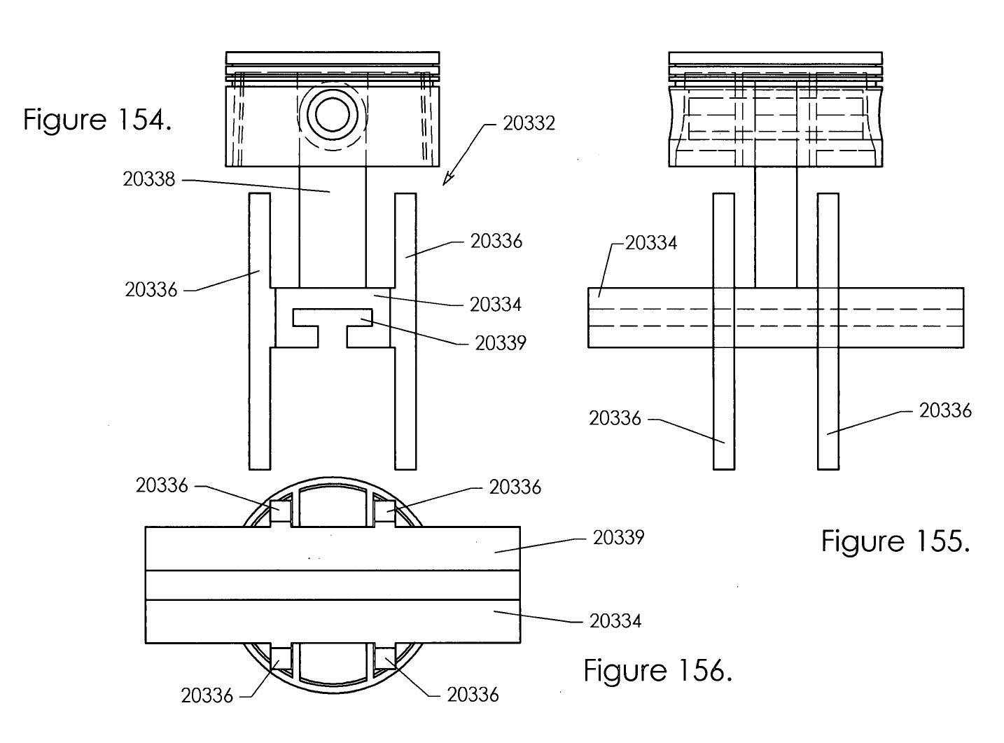

FIGS. 154 to 156 show a guide engagement assembly 20332 having a cross bar 20334, four vertical guide bars 20336 and a central connecting bar 20338. There are two vertical guide bars 20336 on either side of the cross bar 20334. The cross bar has a T-shaped slot 20339.

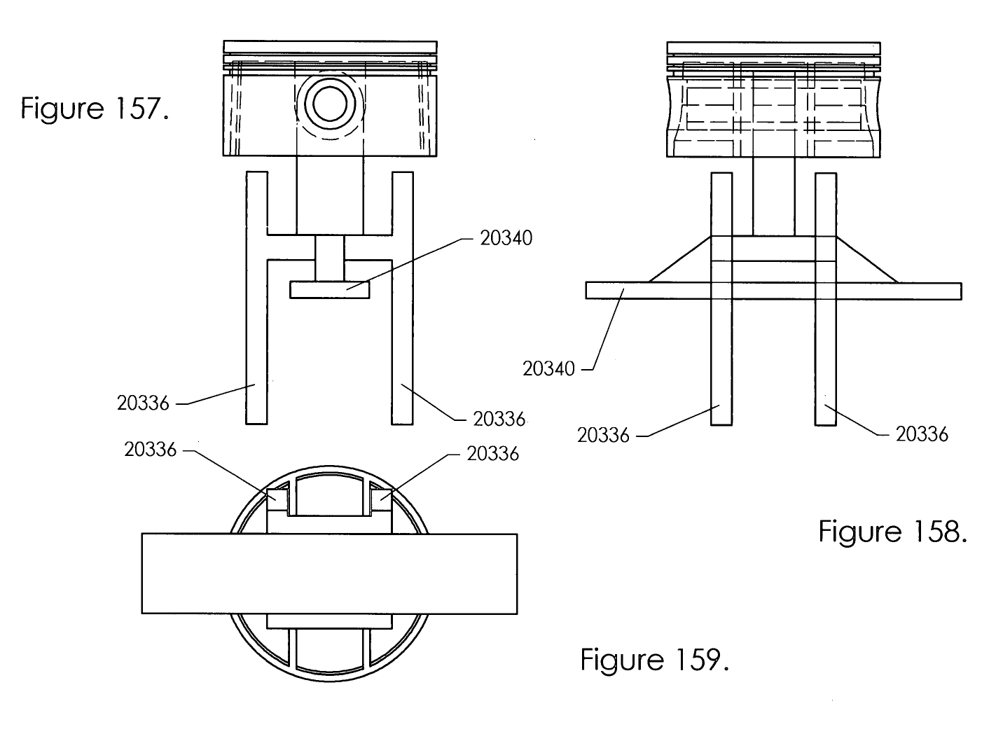

FIGS. 157 to 159 show an assembly similar to that of FIGS. 154 to 156 except that the cross bar 20340 is T-shaped, rather than having a T-shaped slot.

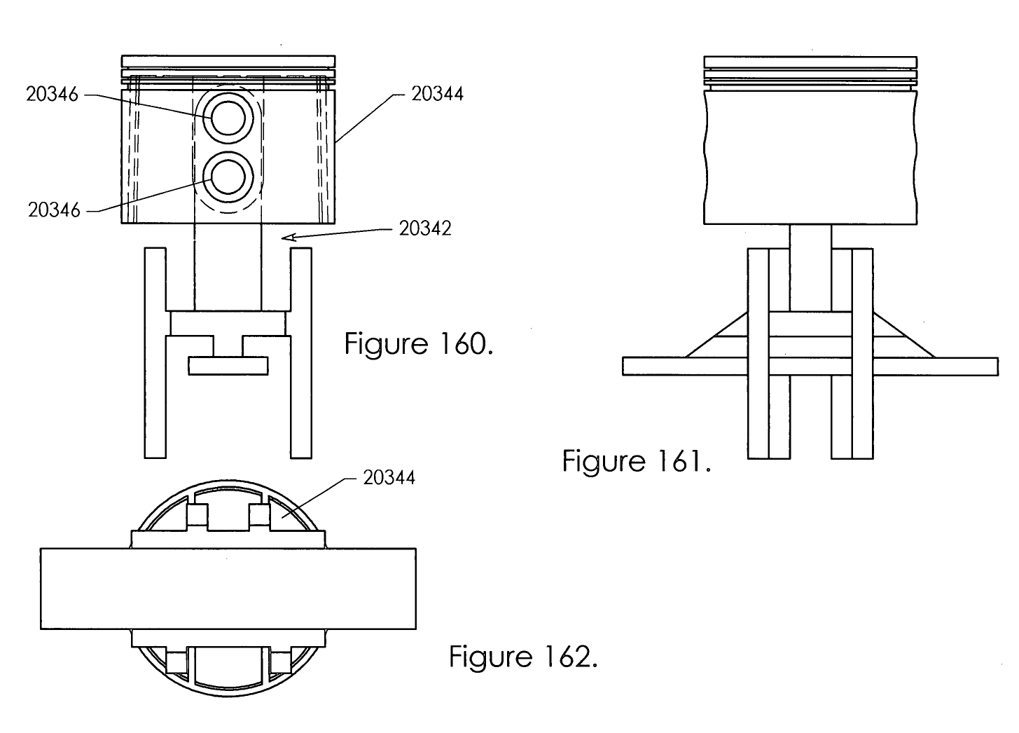

FIGS. 160 to 162 show an assembly 20342 similar to that of FIGS. 157 to 159 attached to a piston body 20344 by two pins 20346 so that pivoting is not possible.

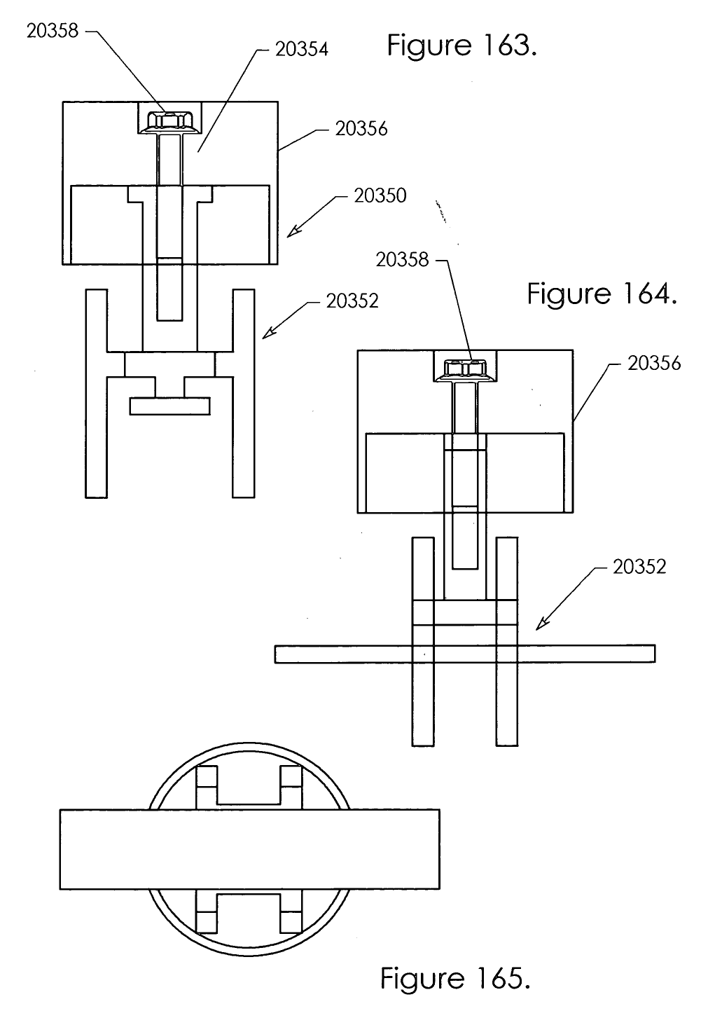

FIGS. 163 to 165 show a piston assembly 20350 having a guide/engagement means 20352 mounted on a pin or cross bar 20354 of the piston body 20356. The pin or cross bar 20354 may be separate from or integral with the body 20356. The assembly is retained on the cross bar 20354 by bolt 20358.

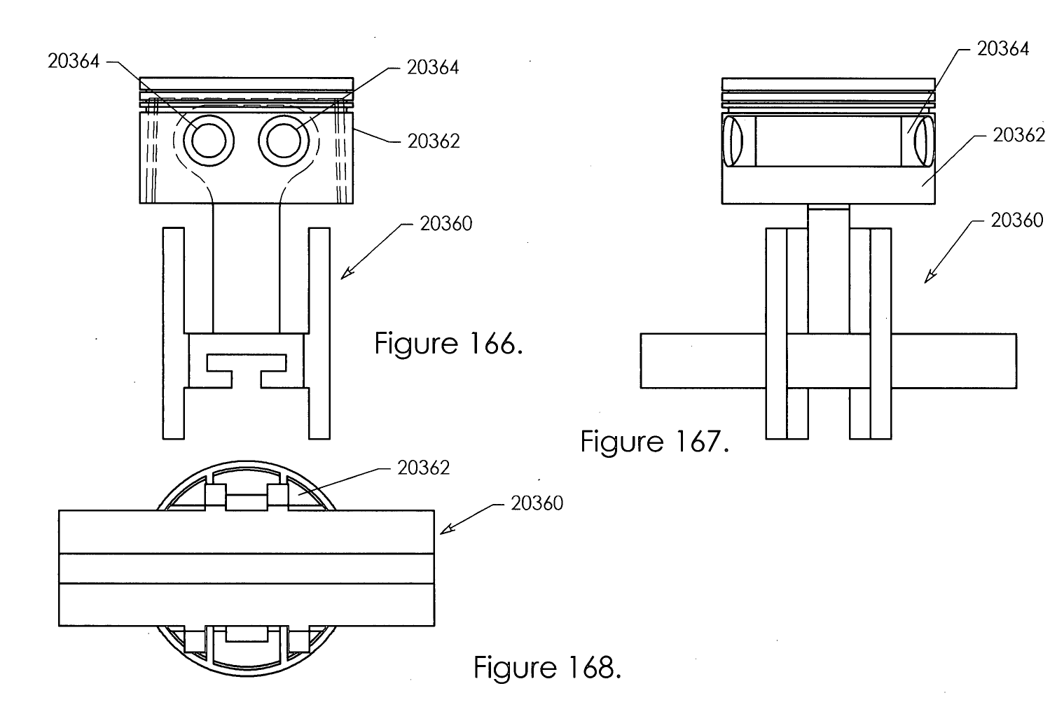

FIGS. 166 to 168 show a guide/engagement assembly 20360 similar to that of FIGS. 154 to 156 but retained on the piston body 20362 by two pins 20364.

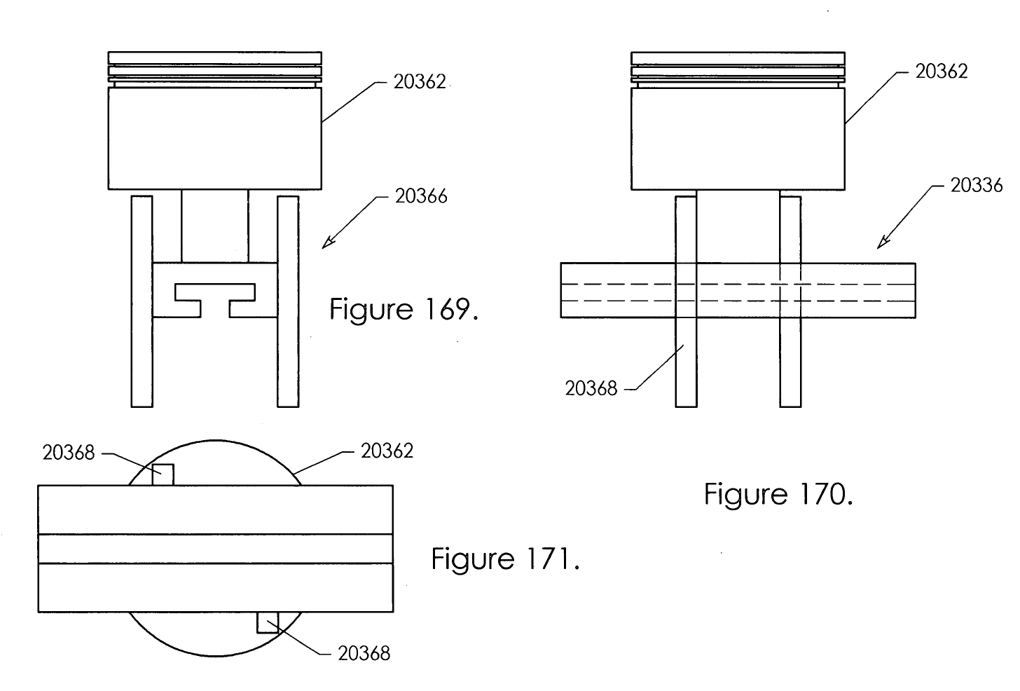

FIGS. 169 to 171 show a piston assembly 20366 functionally identical to that of FIGS. 166 to 168 but in which there is a single unitary structure and only one vertical guide bar 20368 on each side of the horizontal engagement bar as opposed to two.

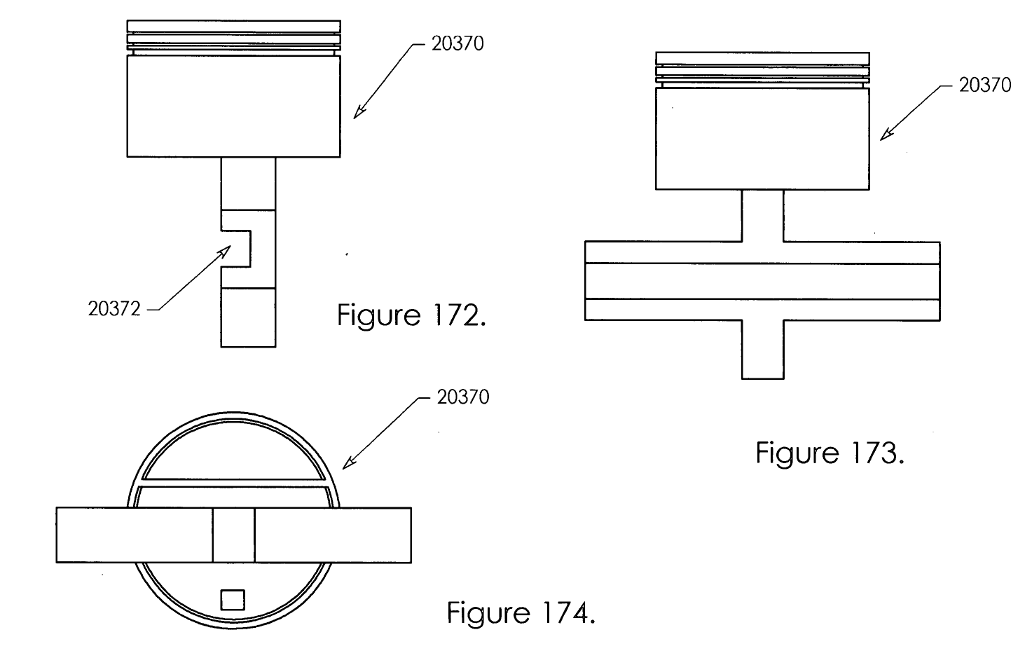

FIGS. 172 to 174 show a piston assembly 20370 similar to that of FIGS. 127 to 129 but in which a horizontal slot 20372 is provided for engagement with the connecting means.

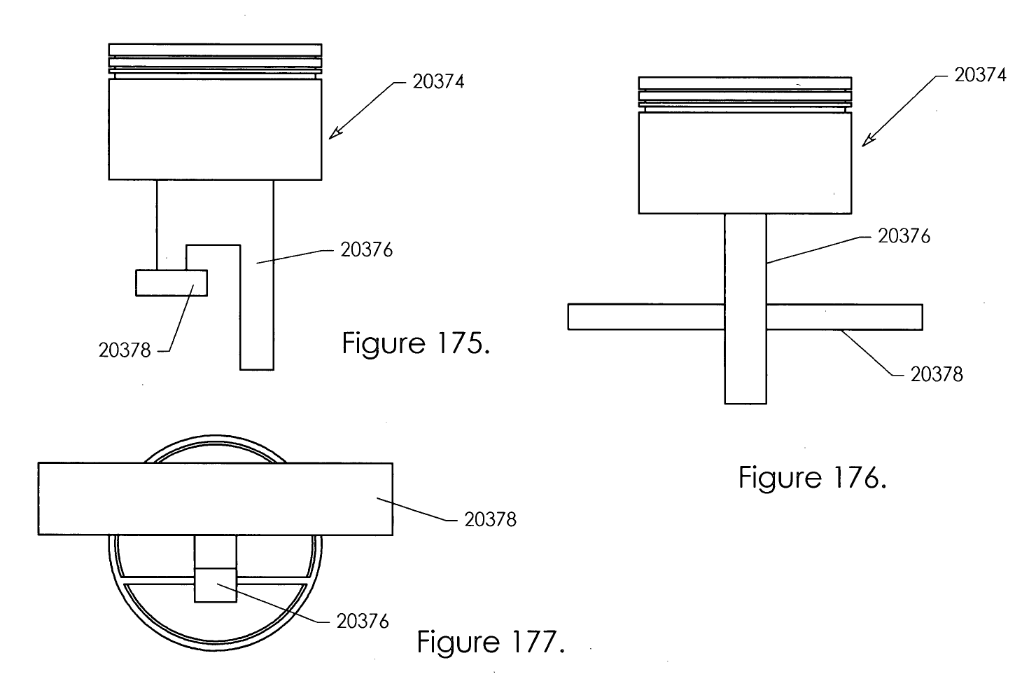

FIGS. 175 to 177 show a piston assembly 20374 having a single vertical guide bar 20376 and a T-shaped engagement bar 20378 depending from the guide bar 20376.

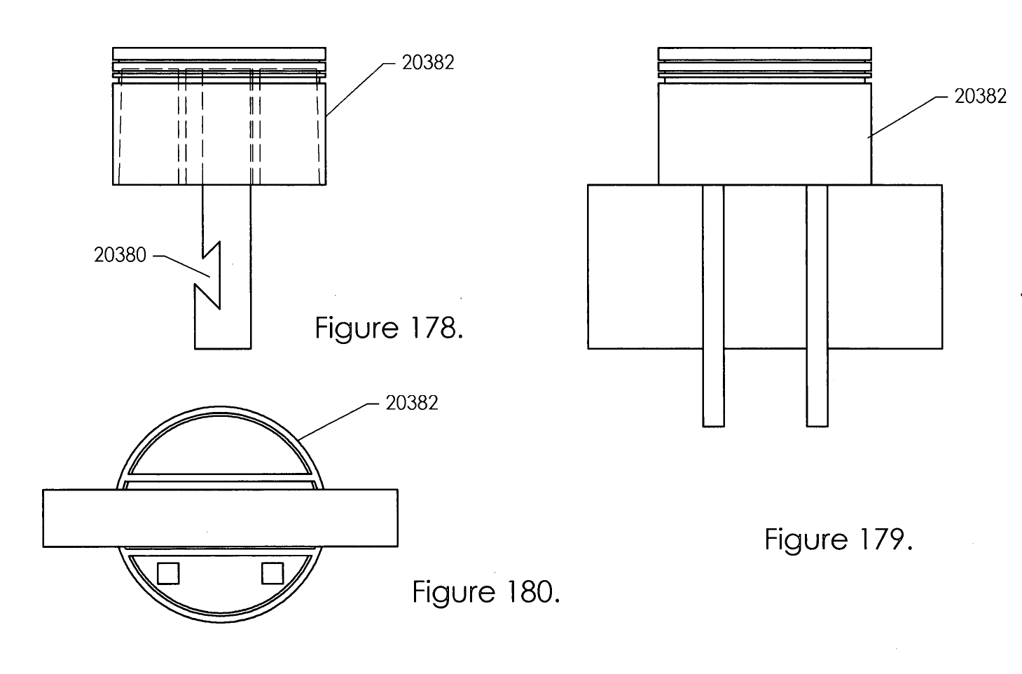

FIGS. 178 to 180 show a piston assembly functionally identical to the FIGS. 130 to 132 embodiment except that the re-entrant slot 20380 is much nearer to the piston body 20382.

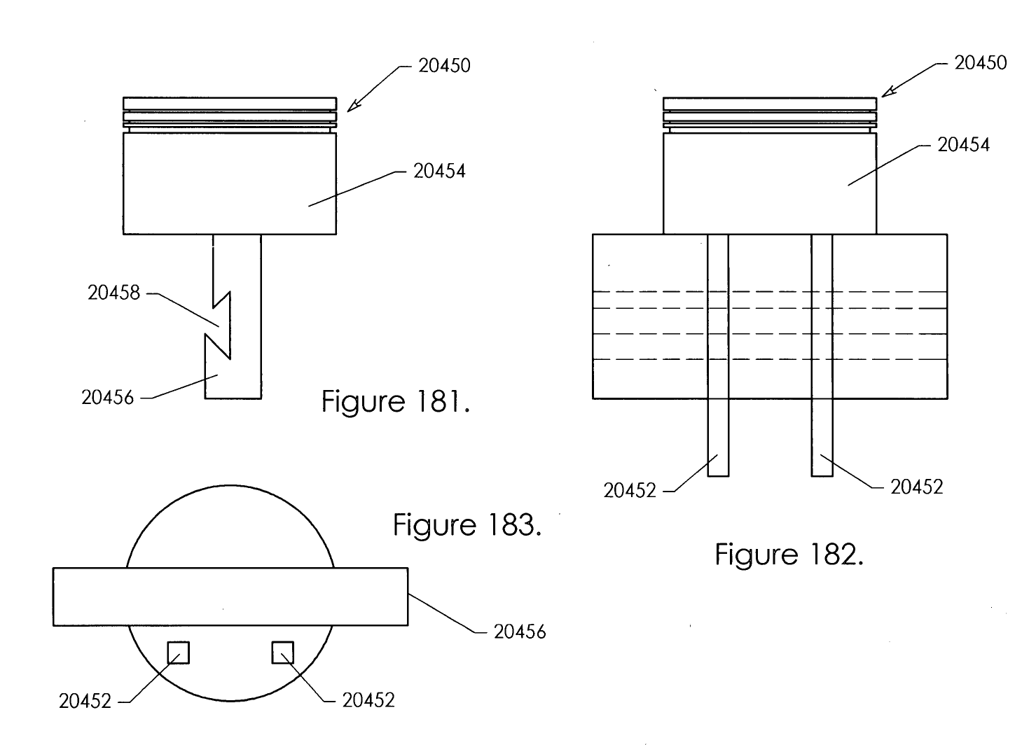

FIGS. 181 to 183 show a piston assembly 20450 having two vertical guide bars 20452 extending from the piston body 20454. A cross bar 20456 is mounted inwardly of the bars 20452 and extends horizontally. The cross bar has a diamond shaped slot 20458 which receives a corresponding tongue mounted on the connecting means. FIG. 181 has omitted guide bars 20452.

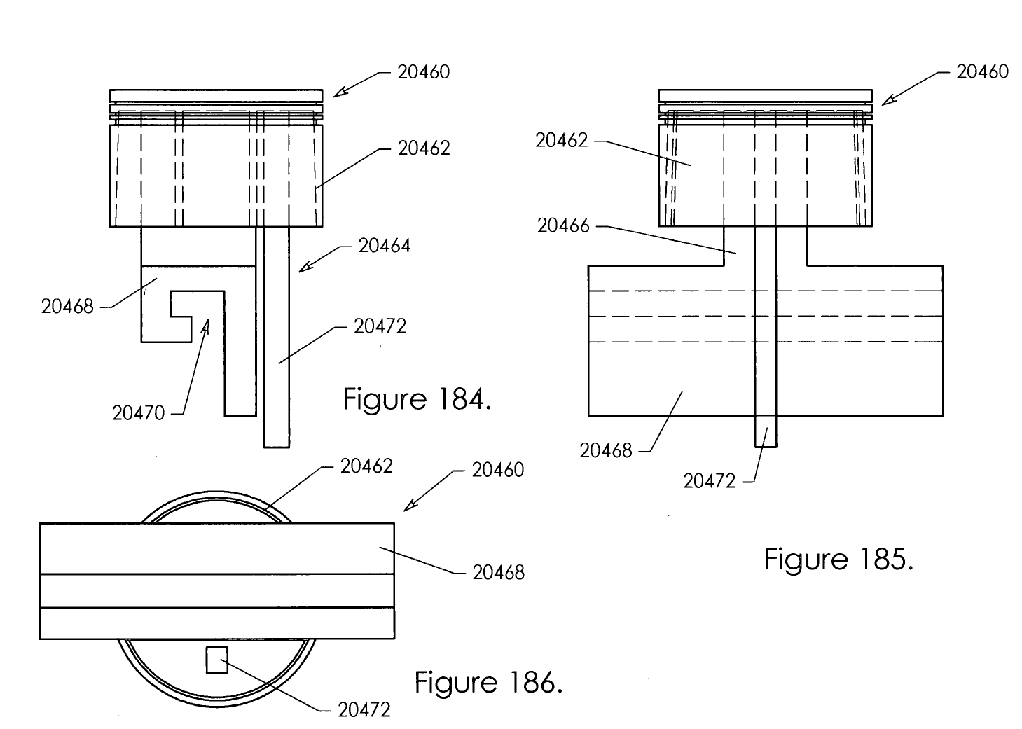

FIGS. 184 to 186 show a piston assembly 20460 having a piston body 20462 from which descends a guide bar/engagement assembly 20464. This assembly 20464 includes a T-shaped engagement portion 20466 having a cross bar 20468 which in turn defines an L-shaped slot 20470 to receive an L-shaped tongue mounted on a connecting means. A vertical guide bar 20472 descends from the piston body 20462. Preferably the guide bar 20472 is integral with the engagement portion 20466 but it may be separate. The guide bar 20472 preferably extends below the horizontal cross bar 20468.

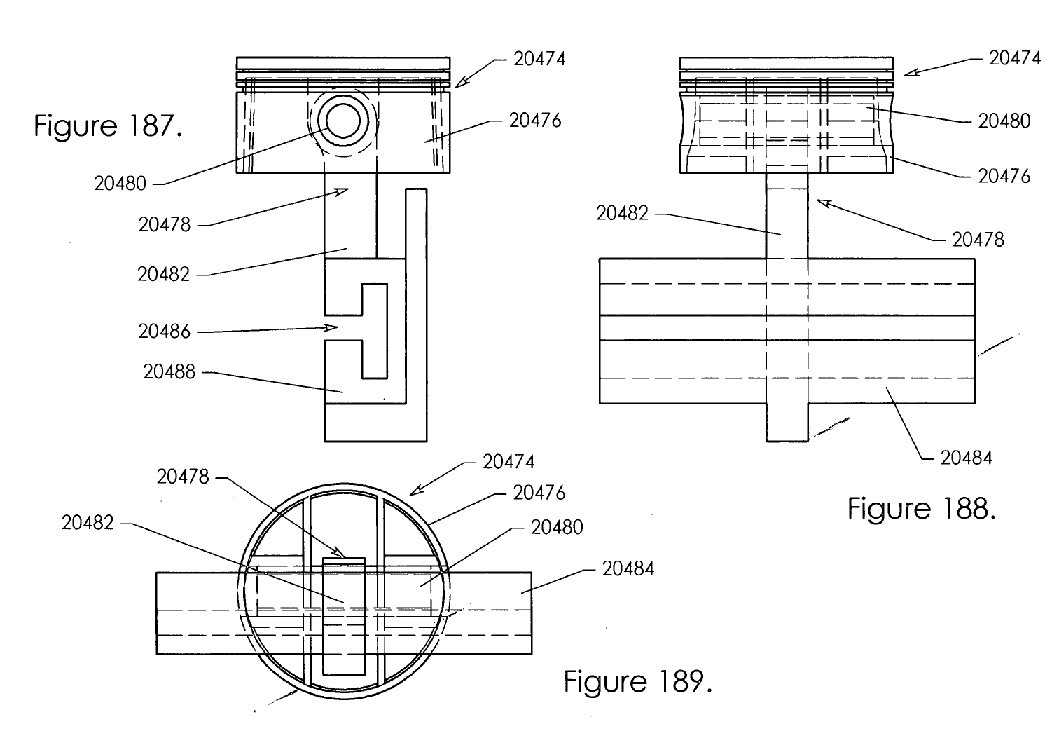

FIGS. 187 to 189 show a piston assembly 20474 having a piston body 20476 and a guide/engagement assembly 20278 pivotably mounted to the body 20476 by gudgeon pin 20480. The assembly 20478 has a T-shaped portion comprising vertical leg 20482 and horizontal cross bar 20484. The cross bar has a T-shaped slot 20486 in a side wall 20488 for receiving a corresponding tongue on the connecting means.

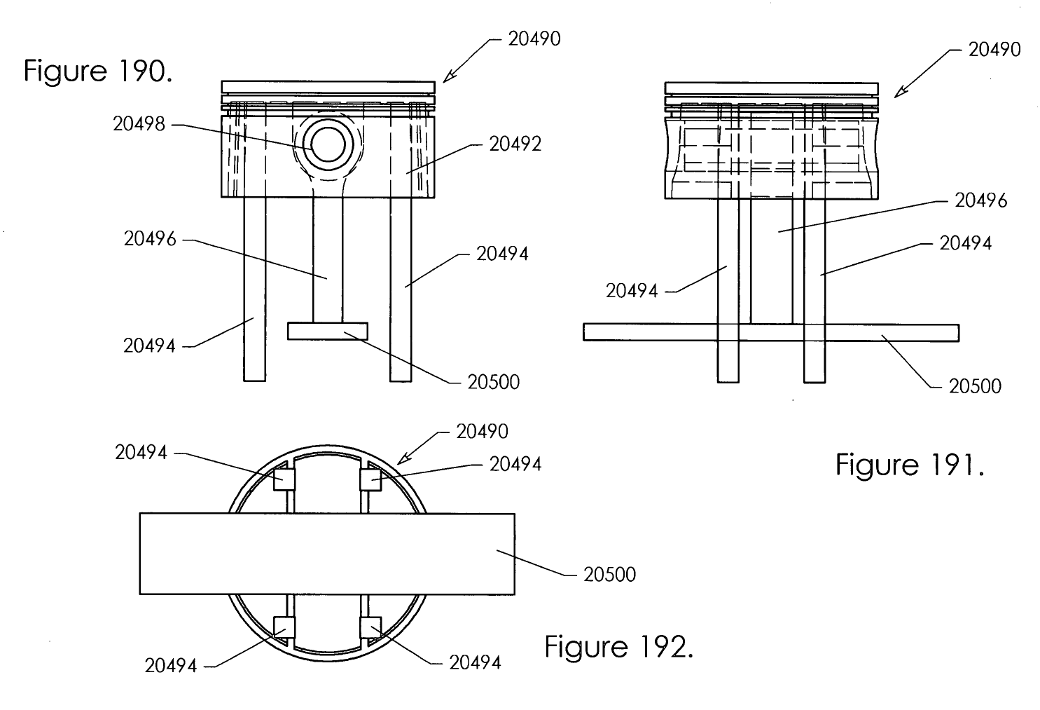

FIGS. 190 to 192 show a piston assembly 20490 having a piston body 20492 with four vertical and parallel guide bars 20494 extending downwards. The four bars 20494 are located at the corners of a square centered on the centre of the piston's circumference.

An engagement means 20496 is pivotably mounted on the piston via gudgeon pin 20498 and is located between the vertical guide bars 20494. The engagement means includes a flat cross bar 20500 which may engage in a T-shaped slot on the connecting means.

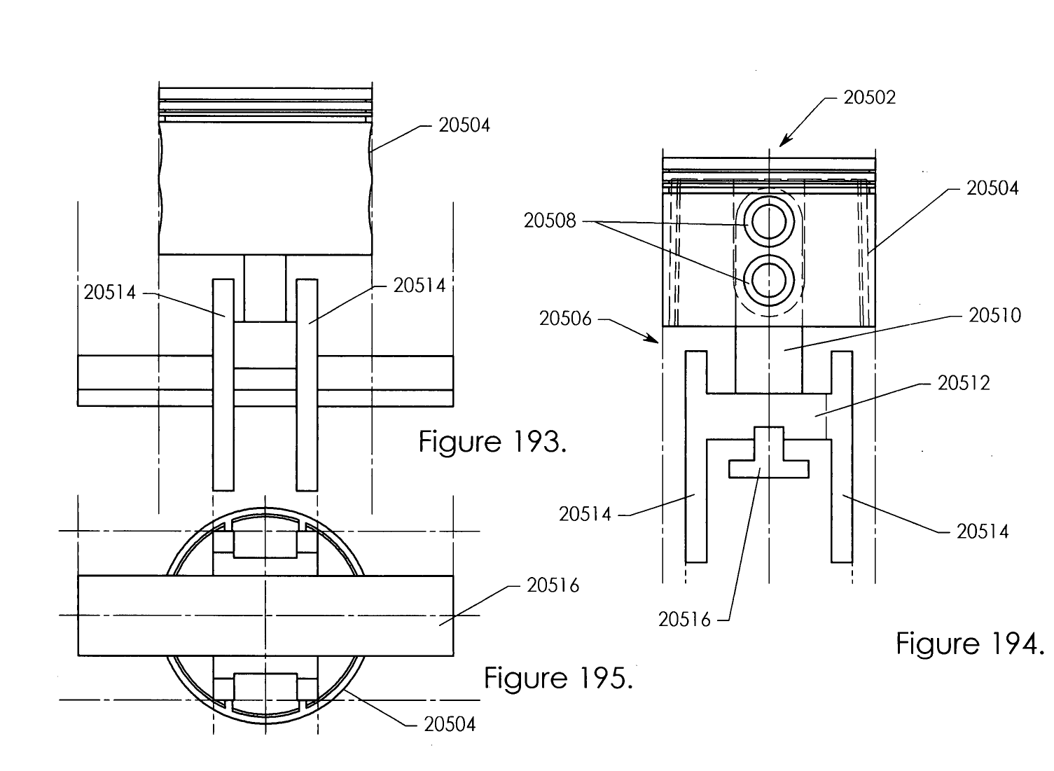

FIGS. 193 to 195 show a piston assembly 20502 having a piston body 20504 with a guide/engagement assembly 20506 attached to the body 20504 by two pins 20508. The assembly 20506 has a vertical post 20510 and a first cross bar 20512 having four vertical guide posts 20514, each arranged at one of its corners. Mounted to the underside of the first cross bar 20512 is a second T-shaped cross bar 20516 which is engaged by a corresponding T-shaped slot on the connecting means.

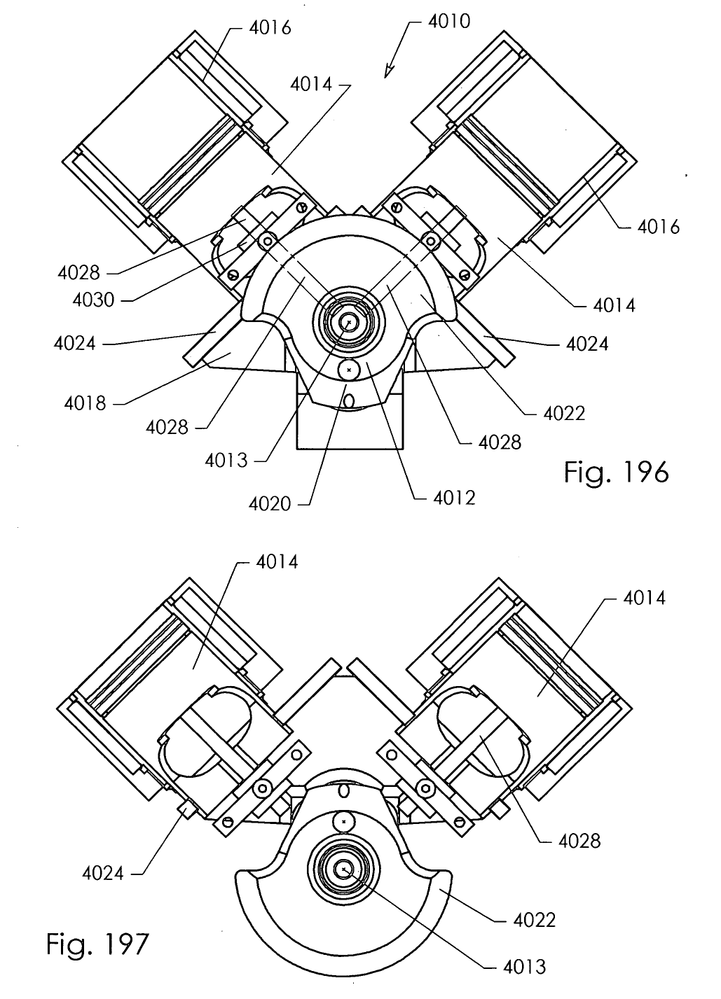

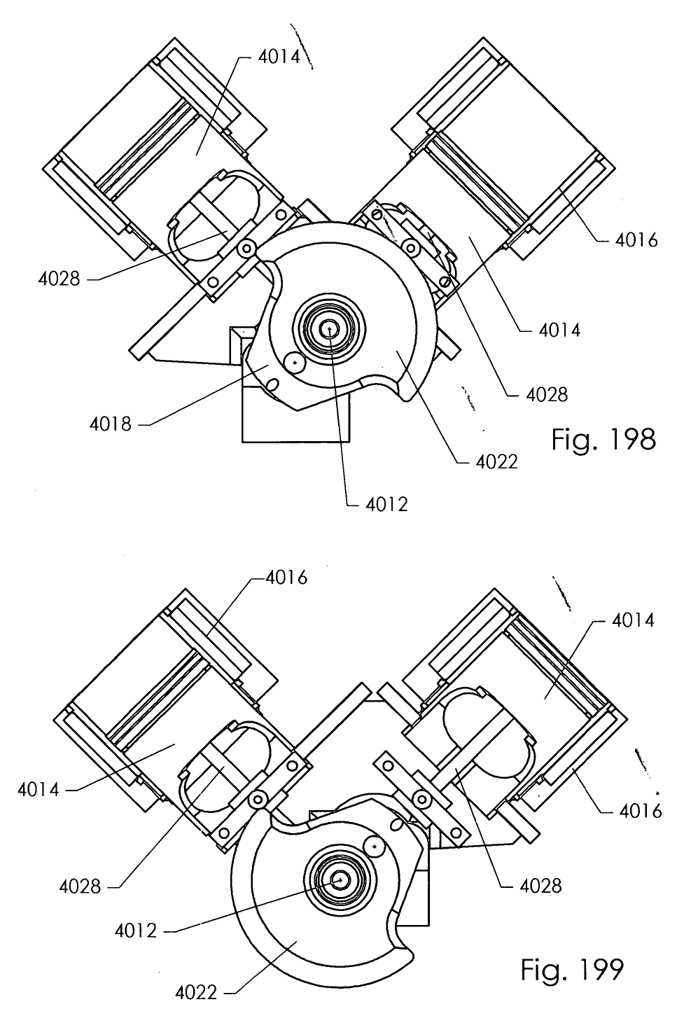

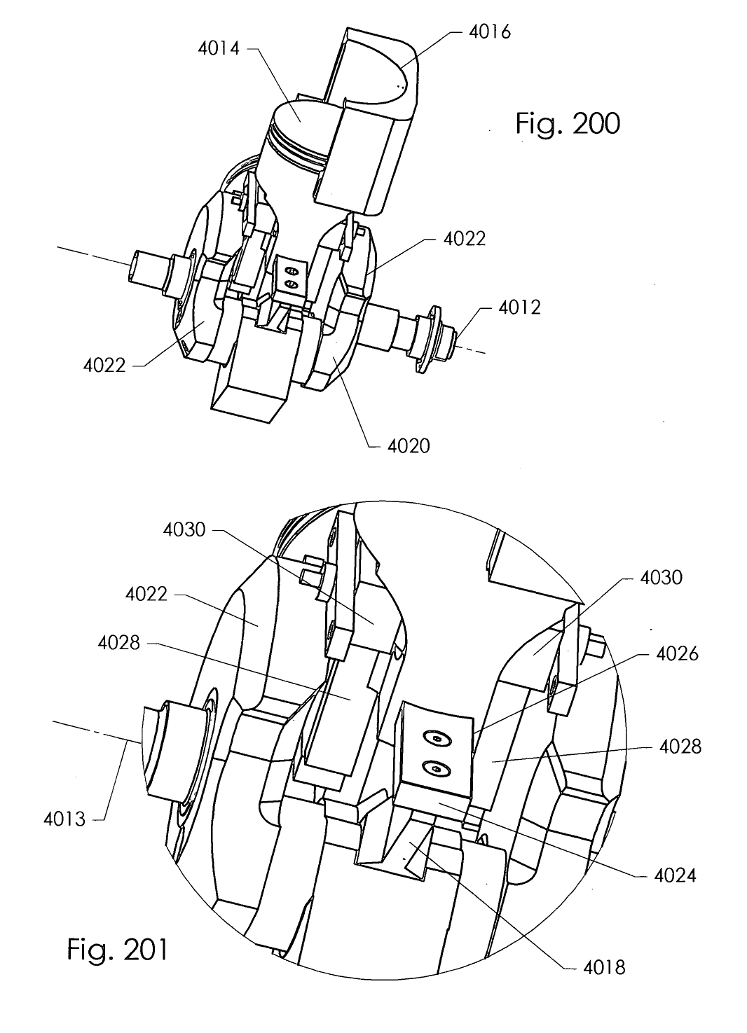

Referring to FIGS. 196 to 203 there is shown a fluid device 4010 having a crank 4012 rotating about a crank axis 4013 and two pistons 4014 reciprocating in cylinders 4016 in a V configuration. The two pistons 4014 are connected to the crank 4012 via a single slider mechanism 4018, which is rotatably mounted on the big end 4020 of the crank 4012. The big end 4020 extends between webs 4022, one of which is shown. The slider 4018 has two T-shaped tongues 4024 which slidably engage in corresponding slots 4026 (see FIG. 201) in the pistons 4014. As the crank rotates the slider 4018 slides relative to the pistons 4014, which are caused to reciprocate in the cylinders.

Extending downwards from the base area of each piston are two guide bars 4028. These bars 4028 extend on either side of the slider 4018 and slot 4026. In addition, each bar extends below the slot 4026 toward the crank axis 4013. Each bar 4028 is able to dip into and out of the volume swept by big end 4020 as it orbits axis 4013. Bar 4028 fits between adjacent big ends 4020 without interfering with them. However, equivalents to bars 4028 could be located outboard of big ends 4020, instead of or in addition to the depicted configuration. This is an important improvement, since it allows the bars 4028 to support the piston 4014 all the way down to cylinder 4016, while having a very short deck height, compared to an arrangement which would have the bars 4028 extending only from the piston crown to a location short of the horizontal slide tongue 4024.

Whilst two bars 4028 per piston are shown, it will be appreciated that only one or more than two bars per piston may be used. Where two or more bars are used it is not essential that they be located symmetrically relative to the cylinder/piston axis; the bars may be positioned to one side of the slot 4026 or asymmetrically on both sides.

A corresponding number of guides 4030 (FIG. 201) are provided for the guide bars 4028 and are attached or integral with the crank case. In the embodiment shown, each guide 4030 includes a U-shaped channel in which the respective guide bar 4028 reciprocates.

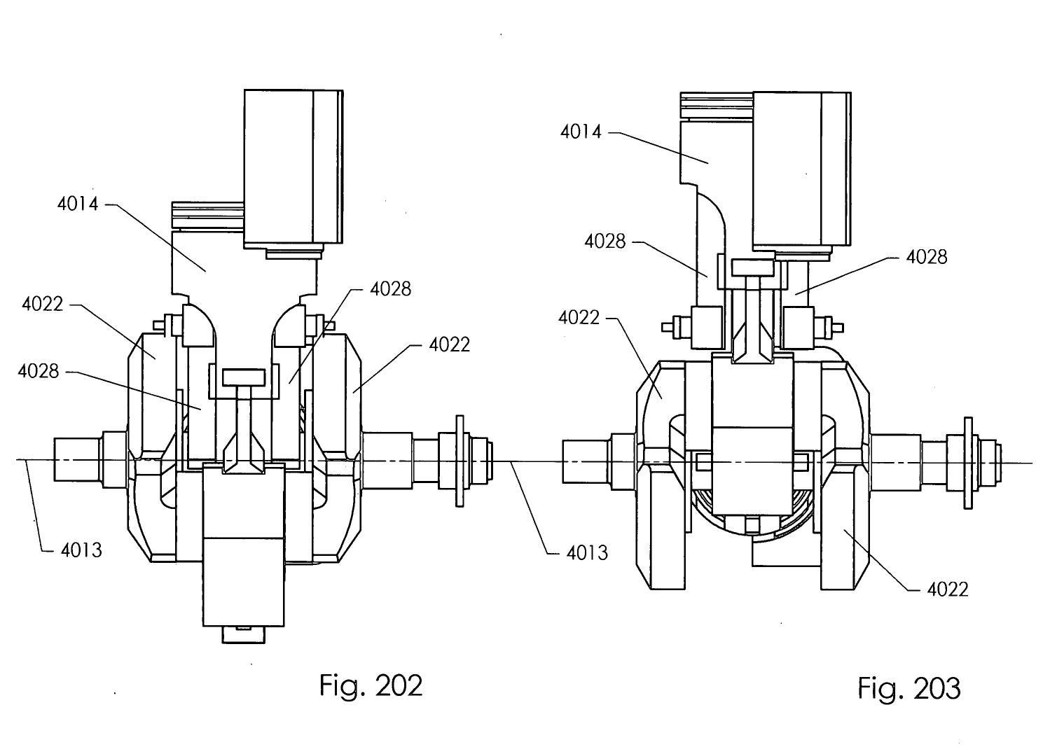

As best seen in FIGS. 202 and 203, the big end 4020 is supported by two webs 4022. The guide bars 4028 are positioned on the piston 4014 to lie between the two webs 4022 when viewed from the side. In addition, as best seen in FIGS. 196 to 199, when viewed on end, the guide bars 4028 extend along the cylinder axis toward the crank axis 4013. Thus the provision of the guide bars does not require additional space in the crank case.

As the crank 4012 rotates, the pistons 4014 reciprocate in their cylinders 4016 and, as seen in FIGS. 196 to 199, the guide bars 4028 move up and down with the pistons 4014 into and out of the volume swept by the big end 4020.

At bottom dead centre (FIG. 196) the guide bars 4028 may extend to be just clear of the sleeve 4034 of the slider 4018 and so allow the guides 4030 to lie as close to the swept volume of the crank shaft as possible. This allows for a compact configuration, with the distance between the piston crown 4036 and crank axis 4013 to be minimized.

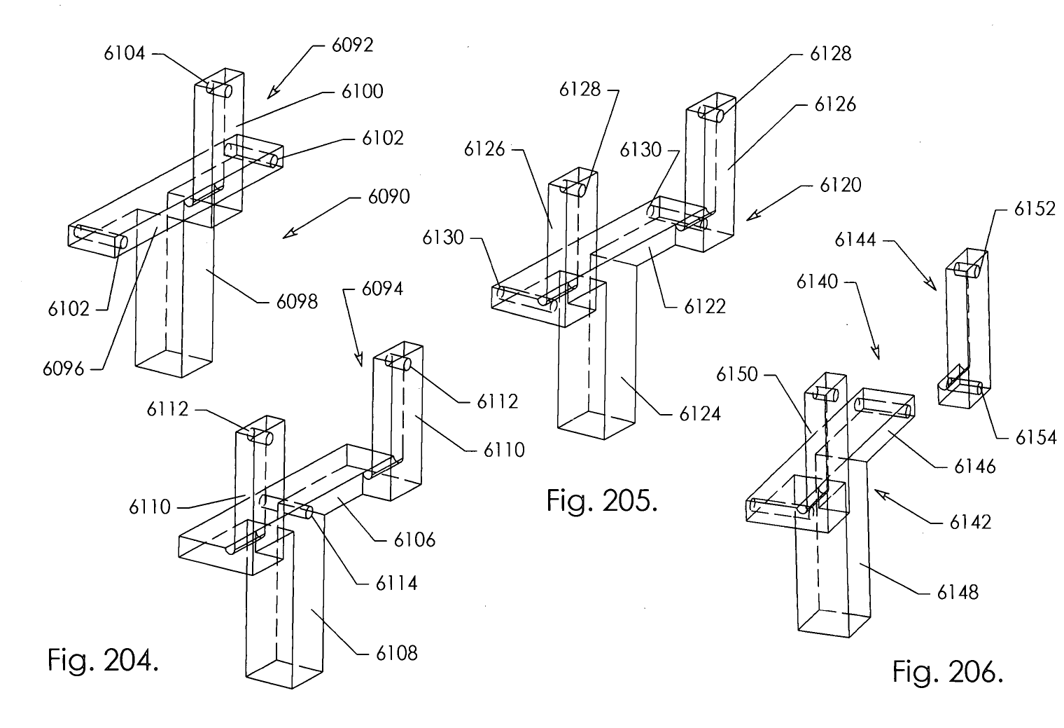

FIGS. 204 to 207 show conceptually components for building up yoke assemblies.

FIG. 204 shows a yoke assembly 6090 comprising two non-identical portions 6092 and 6094. The first portion 6092 has a transverse arm 6096, a piston mounting portion 6098 and a central arm 6100. The ends of the transverse arm 6096 have bolt holes 6102 which extend through the arm 6096 whilst the free end of the central arm 6100 has a single hole 6104.

The other portion 6094 has a transverse arm 6106, piston mounting portion 6108 and two arms 6110 extending from adjacent the ends of the transverse arm 6106. The arms 6110 extend from the same side of the transverse arm 6106 and at their free ends have holes 6112. The transverse arm 6106 has a central bolt hole 6114.

When assembled the central arm 6100 is attached to transverse arm 6106 by a bolt passing through hole 6104 into hole 6114. Similarly arms 6110 are attached to transverse arm 6096 by bolts passing through holes 6112 into holes 6102. The bolt holes 6102 and 6114 may be threaded or unthreaded. Three bolts are required for assembly.

It will be appreciated that this configuration may only be used where the big end does not pass through the yoke.

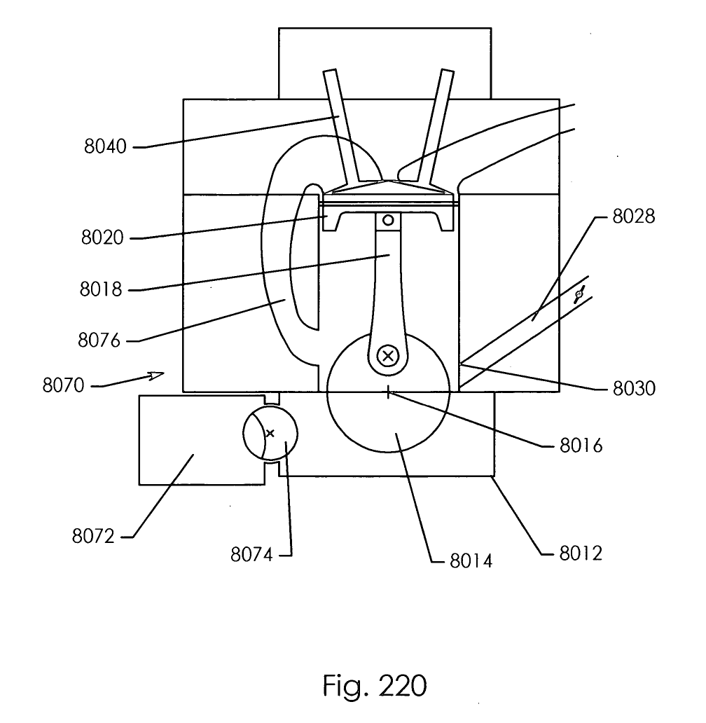

FIG. 205 shows a variation of the twin arm part 6094 of FIG. 220. This variation allows two identical components to be joined together. The component 6120 has a transverse arm 6122, piston mounting 6124 and two arms 6126 extending from the same side of the transverse arm 6122. Bolt holes 6128 are provided in the free ends of arms 6126 and holes 6130 in ends of the arm 6122. Two components 6120 may be assembled with holes 6128 and 6130 aligned and secured together by a bolt being screwed into or passing through holes 6130. Four bolts are required for assembly.

FIG. 206 shows a variation of the FIG. 205 embodiment. FIG. 206 shows a yoke component 6140 having two parts 6142 and 6144. The first part 6142 includes transverse arm 6146, piston mounting 6148 and a single longitudinal arm 6150. The other part 6144 corresponds to the arm 6150 and is provided with bolt holes 6152 and 6154 for mounting to the arms 6146. Whilst this construction has four parts compared to two in the FIG. 205 embodiment, the same number of bolts is required—only four.

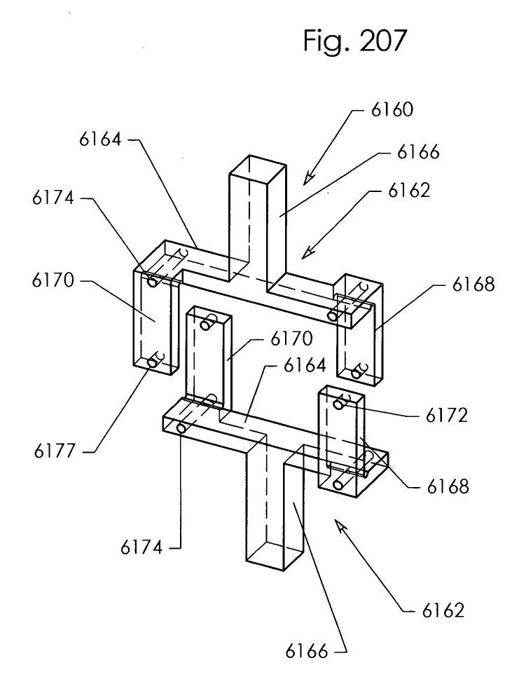

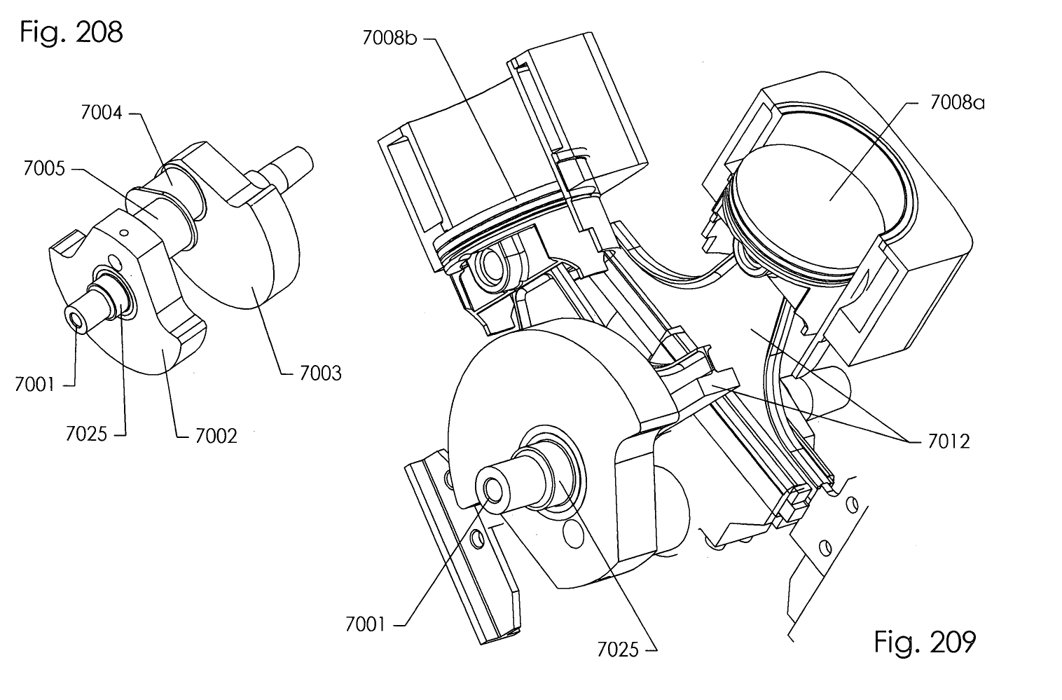

FIG. 207 shows a yoke assembly 6160 comprising two identical parts 6162. Each part includes a transverse arm 6164, a piston mounting 6166 and two longitudinal arms 6168, 6170. In contrast to the FIG. 205 or 206 embodiments, in this embodiment the arms 6168 and 6170 extend from opposite sides of the transverse arm 6164. Bolt holes 6172 and 6174 are provided at the free ends and base of the arms 6168, 6170 to allow the two components to be joined together.

Turning now to FIG. 208, there is shown a crank mechanism with a main axis 7001, having two webs 7002, 7003 extending outwards of the main journal 7025. The webs support big ends 7005 and 7004 which have their own respective axis. The axes are offset to each other by 30° to each other. The crank is used in the fluid device of FIG. 209 wherein the cylinder axes are at an angle to each other of 75°. It can be seen in FIG. 209 that the T-bar engagement surface is on the piston, with the cavity on the connecting means, the reverse of the arrangement previously described.

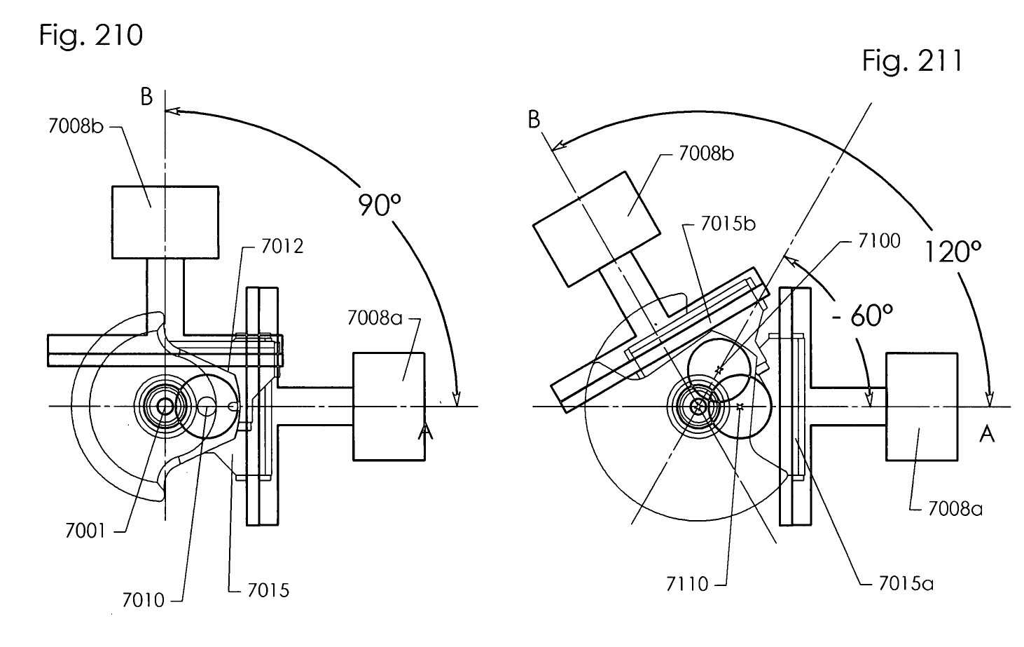

FIG. 210 shows a scotch yoke type device according to the invention wherein the pistons 7008a and 7008b are disposed for reciprocation at 90 degrees about the main axis 7001, the crank has at least one big end and it has only one axis 7010. Note the pistons are constrained to reciprocate along their respective paths A and B, and A and B are at 90 degrees to one another. The pistons 7008a and 7008b are connected to the crank big end/s 7010, by way of sliding engagement means 7012.

In this embodiment, engagement means 7012 are centered on big end axis 7010. For each piston 7008a and 7008b, the engagement means 7012 are located to one side of the big end axis 7010.

FIG. 211 depicts a V scotch yoke type device according to the invention wherein the pistons 7008a, 7008b are disposed about the main axis 7001 at 120 degrees from each other. Path B is 30 degrees rotated anti clockwise from being at 90 degrees to path A. Further, big end axis 7004 is rotated 60 degrees anti clockwise from big end axis 7005. As above, big end 7100 is for the motion of the piston that travels on the path B and big end 7110 is for the motion of the piston that travels on the path A.

It will be appreciated that it is best if the pistons reciprocate in a manner that they are one half of a sinewave out of phase from each other. Provided that the pistons are of the same mass, the engine will be perfectly balanced. It is also obvious that the crank disk and scotch yoke embodiments of the invention that are of V configuration may be balanced in the same way and that X, horizontally opposed or 180 degree configuration devices of the invention may also be balanced similarly.

It is also clear that an engine designer may wish to construct a fluid scotch yoke type device of a type depicted and described herein wherein a degree of imbalance is in some way preferred, accordingly the invention includes devices with their pistons displaced at not quite one quarter of a sine wave out from each other, say up to 10%-20% or even up to 50% of the sine wave out of true balance. This still fits broadly within the scope of the invention.

For the purpose of this discussion, the engine is a 90 degree vee twin, with the cylinders 45 degrees to the left and right of a vertical centre line. The engine is assumed to be rotating clockwise so that when the crankshaft is vertical, the left piston is going up and the right piston is at the same relative position in its cylinder but doing down.

The engine is assumed to be made up of the following components:

Crankshaft whose mass is concentrated in two positions namely the counterweight and the big-end.

Conrod whose mass is concentrated in 3 positions, the left slider, the right slider and the counterweight directly below the big-end.

The left and right pistons whose mass is assumed to be concentrated at the centre of their respective bores and some distance above the respective sliders.

The stationary parts of the engine (crank case, block, etc.) are assumed to be rigidly mounted so they can be disregarded in considering engine balance issue.

Imagine the engine is assembled, starting as follows:

Install a crankshaft which is balanced on its own. That is, its centre of mass is at its centre of rotation, the main bearing. Clearly this is perfectly balanced.

Now add the component referred to as the “con-rod”. Because the left and right slider mechanisms will be above the big-end, the conrod will require its own counterweight located directly below the big-end if we want its centre of gravity to be at the big-end. If to the crankshaft counterweight is added an amount calculated from the total mass of the conrod, the centre of gravity can be kept at the main bearing and the assembly so far will still be perfectly balanced.

Note that the conrod maintains the same orientation all the time so that it is in fact “orbiting”. Because its centre of mass is at the big end, it will have no tendency to rotate as the crankshaft rotates. If the mass of the conrod counterweight is reduced so that the conrod centre of mass was above the big-end, then the conrod would tend to rock as the crankshaft rotated. Provided it is prevented from actually rocking, its centre of mass will still describe a circle of the same radius and can still be perfectly balanced by the crankshaft counterweight.

There is thus a design choice here whether to reduce the load on the slider mechanisms by balancing the conrod or whether to reduce the mass of the conrod and the mass of the crankshaft counterweight thereby reducing inertial forces generally. An alternative would be to prevent the conrod from rotating by other means such as a second crank mechanism.

If the pistons are now added, the engine is put out of balance. However, because the piston motion is perfectly simple harmonic and the pistons are 90 degrees out of phase, the two together are exactly equivalent to one piston mass traveling in a circle. It is necessary, therefore, merely to add to the crankshaft counterweight a mass calculated from the mass of one piston (and adjusted to allow for the ratio of crankshaft throw to crankshaft counterweight distance) and the whole engine remains perfectly balanced.

This is easiest to visualize if one tilts one's head to the left so that the left piston appears to be moving vertically and the right piston moving horizontally. When the left piston is at its highest point, the crankshaft counterweight is at its lowest point. At the same instant, the “right-hand” piston is at mid-stroke and traveling to the right. As far as the horizontal motion of the crankshaft counterweight is concerned, it is at midstroke and traveling to the left. The crankshaft counterweight can therefore be adjusted to exactly balance both pistons.

The centre of mass of all moving parts of the engine remains exactly stationary. There are no higher order effects as in a conventional engine. These arise because the piston motion is not simple harmonic and the motion of a conventionally driven piston is not simple harmonic and the motion of a conventionally driven piston is not symmetrical near top and bottom dead centre.

It is also interesting to note that the internal kinetic energy of the slider engine of this invention is also constant throughout its cycle. Provided the angle of the cylinders is 90 degrees, then the combined kinetic energy of the pistons is constant. This means that there is no tendency for the mechanism to resist rotating at constant angular velocity.

The following is the theory behind the balancing of the engine with offset big ends.

A is the angle between the bores of 2 cylinders in a vee engine.

D is the angle between lines extending from the main axis to the big ends.

If D is set equal to 2*(A−90), the centre of gravity of the two pistons will be found to move in a circle so that it can easily be balanced by a counterweight on the crankshaft.

If the connecting rods are allowed to pivot relative to the pistons, it is assumed that the connecting rods are sufficiently long that the motion of the pistons is simple harmonic. Where pivoting is not allowed or limited to very small amounts the motion will inherently be simple harmonic motion to practical effect.

The mass of the connecting rods is ignored.

Angles are measured positive anticlockwise from the positive X axis.

Assume the first bore is a 0 degrees.

The second bore is at an angle A degrees.

When the big end for the first piston is at 0 degrees (so that the first piston is at TDC) the big end of the second piston is at D degrees.

Consider the general case when the big end for the first piston is at R degrees and the big end of the second piston is at D+R degrees.

The X co-ordinate of the first piston is Cos(R) measured with respect to its mean position.

The Y co-ordination of the first piston is always zero.

The radius of the crankshaft for the second piston is also unit length, but in the general case under consideration, the value of the radius projected onto the axis of the second bore is Cos(A−D−R).

Since it is of interest only to look at variations in the position of the centre of gravity of the pistons, the second piston can be taken to be at:
X=Cos(A−D−R)*Cos(A)
Y=Cos(A−D−R)*Sin(A)

The centre of gravity of the two pistons together can be taken as:
X=Cos(A−D−R)*Cos(A)+Cos(R)
Y=Cos(A−D−R)*Sin(A)+0

Note that these should both be divided by 2, but this is omitted to simplify the appearance of the algebraic expressions.

It turns out that for any value of A, if D is set at D=2*(A−90), then the centre of gravity of both pistons together moves in a circle and can be easily balanced by a counterweight attached to the crankshaft.

That this is the case can be proved by substituting 2*A−180 for D in the above expressions which become
X=Cos(A−2*A+180−R)*Cos(A)+Cos(R)
Y=Cos(A−2*A+180−R)*Sin(A)+0

which become
X=Cos(−A+180−R)*Cos(A)+Cos(R)
Y=Cos(−A+180−R)*Sin(A)+0

which equals
X=−Cos(A+R)*Cos(A)+Cos(R)
Y=−Cos(A+R)*Sin(A)

expanding Cos (A+R) in each case
X=−Cos(A)*Cos(A)*Cos(R)+Cos(A)*Sin(A)*Sin(R)+Cos(R)
Y=−Cos(A)*Cos(R)*Sin(A)+Sin(A)*Sin(R)*Sin(A)

simplifying, we get
X=Sin(A)*(Cos(R)*Sin(A)+Sin(R)*Cos(A))
Y=Sin(A)*(−cos(A)*Cos(R)+Sin(A)*(Sin(R))
or
X=Sin(A)*Sin(A+R)
Y=Sin(A)*Cos(A+R)

This is the equation of a point moving in a circle of radius Sin(A).

Thus the motion of the two pistons together can be counterbalanced by a single mass, equal in mass to one piston mass rotating on a radius of Sin(A) times the crankshaft radius. (The fact that there are actually two pistons compensates for the factor of 2 which was omitted in the expressions for X and Y above).

It will be appreciated that when A=90°, i.e. a 90° V configuration, that D=0°, i.e., the axes of the two big ends are not offset but are coaxial. Thus a 90° V configuration with a single big end is merely a special case where D=0°.

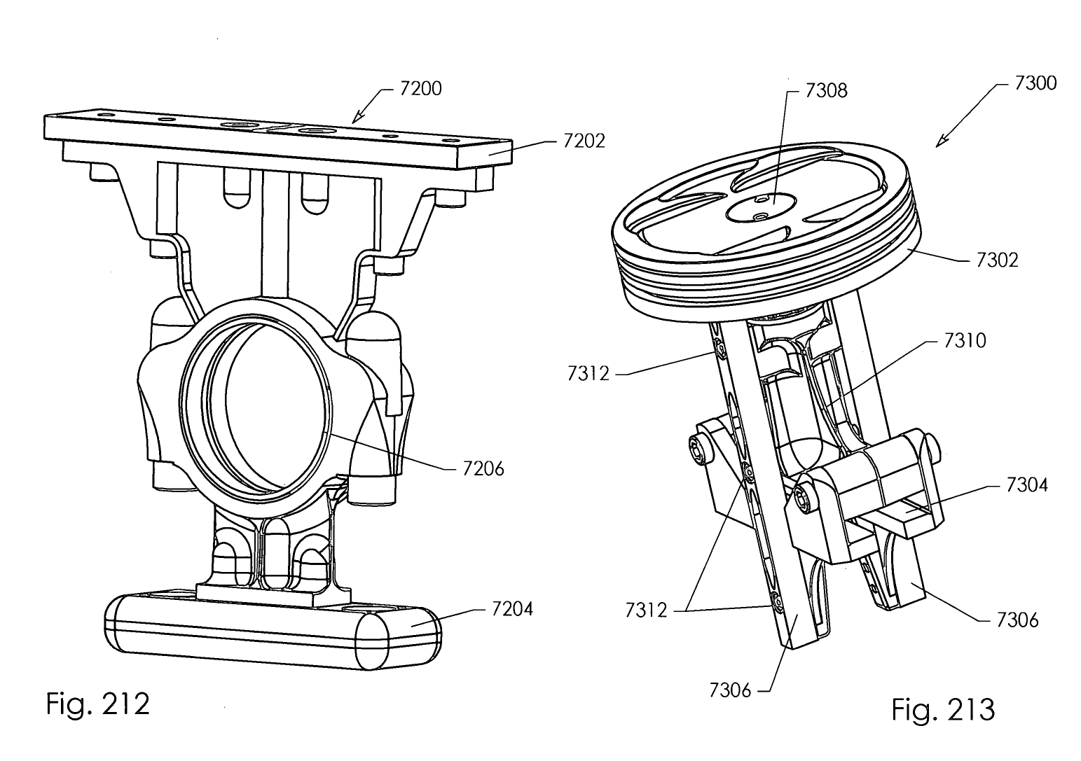

FIGS. 212 and 213 show a connecting rod 7200 assembly and a piston assembly 7300 for use together in a fluid device (not shown) having only one piston assembly 7300 mounted on the or each connecting rod 7200. The connecting rod 7200 has a T shaped engagement means 7202 for sliding engagement with a T shaped slot 7304 on the piston assembly 7300. T-shaped engagement means 7202 may be bolted to its support in any way desired, including those illustrated. A counter weight 7204 is provided on one side of the big end journal 7206 to partially or fully counterbalance the mass of the connecting means located on the other side of the big end journal 7206. The piston assembly 7300 also includes a piston crown 7302 and longitudinally extending guides 7306 for engagement with guide means to constrain the piston assembly 7300 to reciprocate along a linear path. It will be noted that the piston assembly is a made up unit with the various components bolted together. Piston crown 7302 is attached to the central assembly 7310 via a bolt 7308; guides 7306 are attached to the central assembly 7310 via bolts 7312.

It will be apparent to those skilled in-the art that many modifications and variations may be made to the embodiments described herein without departing from the spirit or scope of the invention.

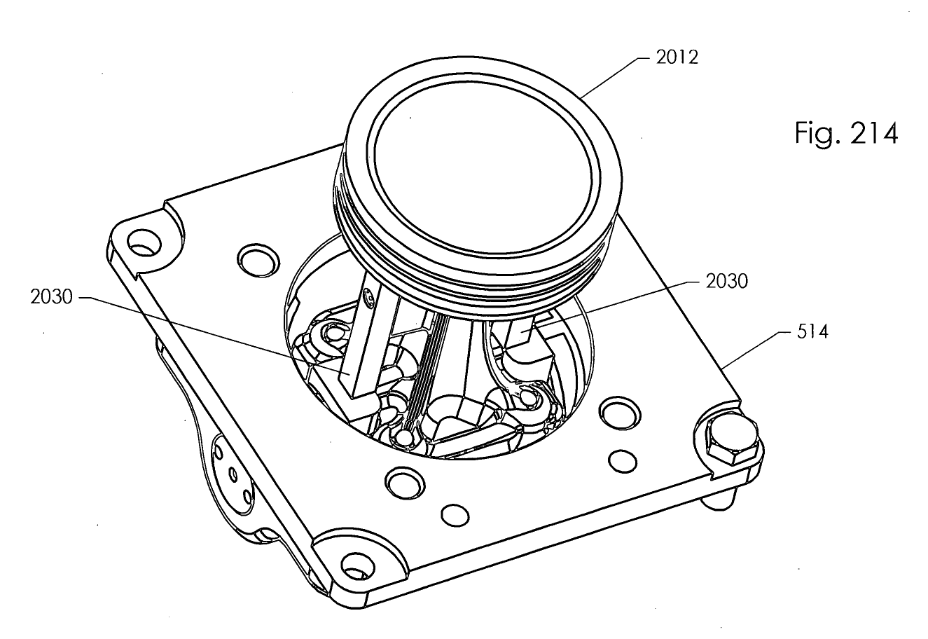

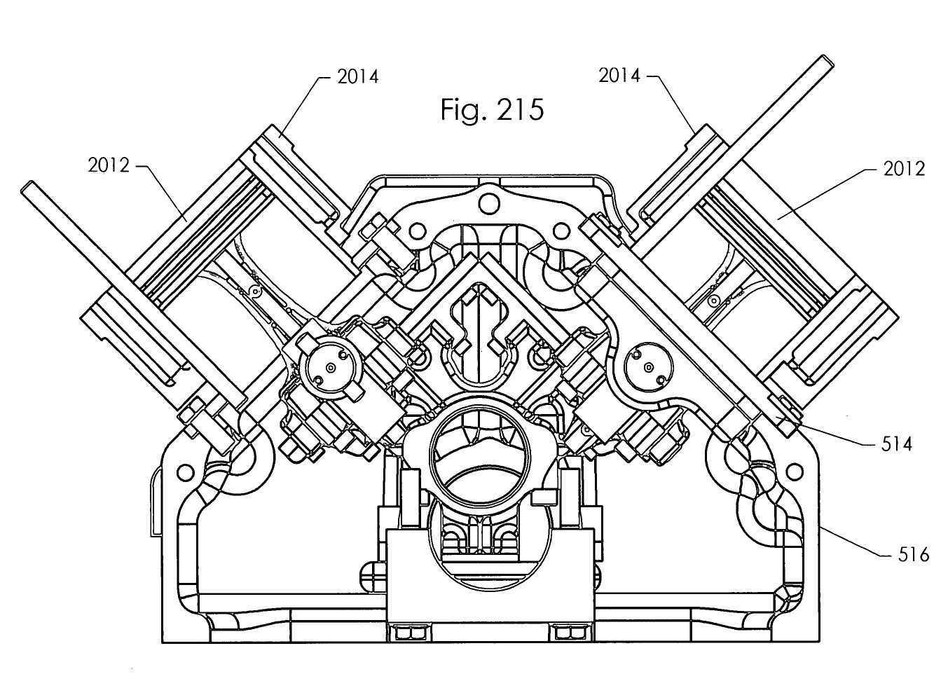

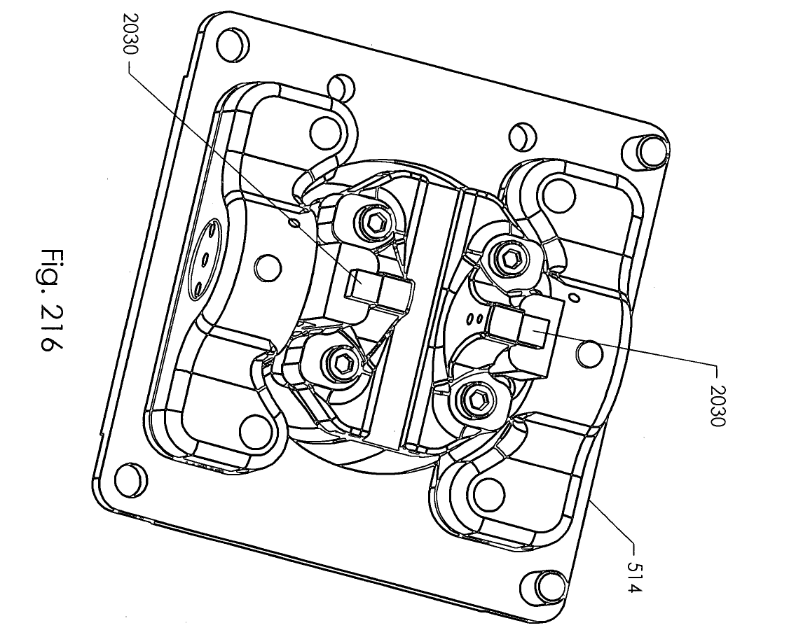

Referring now to FIGS. 214 to 216, block segment is bolted or otherwise affixed to block 516 (refer FIG. 215) but can be changed when desired without the need to manufacture a new block. This can be particularly useful in the case of test engines.

The description of other labeled parts are the same as in the case of FIGS. 81 and 82 herein.

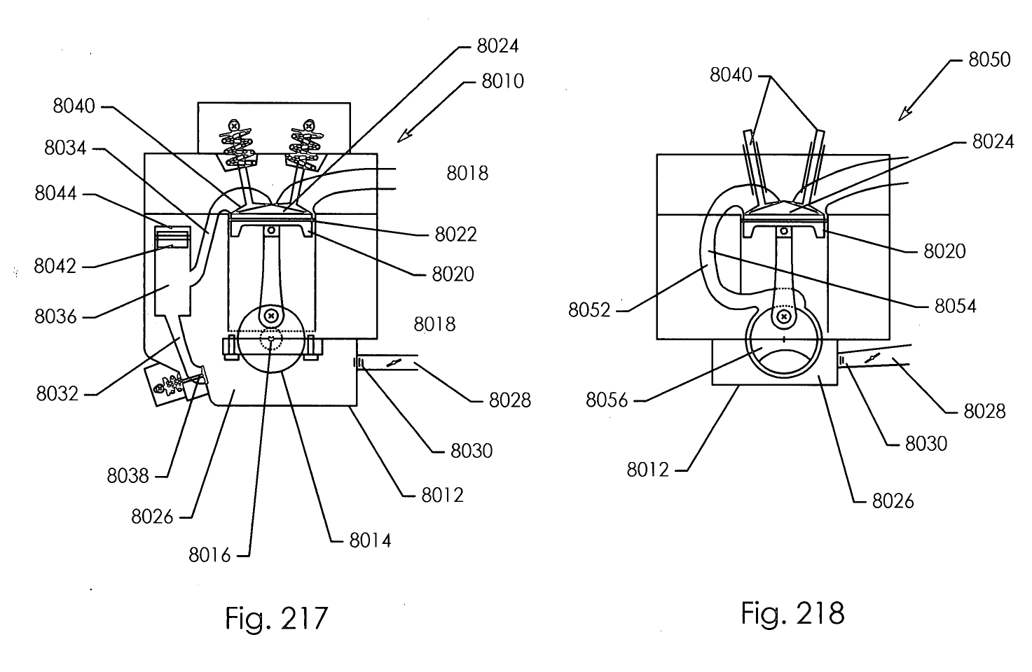

Referring to FIG. 217 there is shown an internal combustion engine 8010 having a crankcase 8012 in which a crank 8014 rotates about axis 8016. Connected to the crank 8014 is a piston 8020, via connecting rod 8018. Rotation of the crank 8014 causes the piston 8020 to reciprocate within cylinder 8022.

The cylinder 8022 and crankcase 8012 form a sealed unit for each piston and so the piston 8020, cylinder 8022 and crankcase 8012 together define a combustion chamber 8024 above the piston 8020 and a crank volume 8026 below the piston.

The crank volume is provided with an air inlet 8028. Communication between the crank volume 8026 and the inlet 8028 is controlled by a reed valve 8030 but a poppet valve or any other suitable valve may be used.

The crank volume 8026 communicates with the combustion chamber 8024 via passageways 8032 and 8034 and an intermediate chamber 8036. Communication between the crank volume 8026 and passageway 8032 is controlled by poppet valve 8038 whilst poppet valve 8040 controls communication between the passageway 8034 and the combustion chamber 8024.

The intermediate chamber 8036 is closed, except for the passageways 8032 and 8034. Located in the chamber 8036 to one side of both the passageways 8032 and 8034 is a movable piston 8042 which thus defines a closed volume 8044.

In operation, assuming the piston is at or near top dead centre and is just commencing a power stroke, the piston 8020 descends, reducing the volume of the crank volume 8026. Poppet valve 8040 is closed, poppet valve .8038 is open and so the pressure in the crank volume 8026 increases, closing or maintaining closed the reed valve 8030. The piston 8020 descends toward bottom dead centre, at an appropriate point in the cycle and the secondary piston 8042 moves to reduce the closed volume 8044 under the increased pressure in the crank volume 8026. At or near bottom dead centre poppet valve 8038 closes, trapping the pressurized gas in the intermediate chamber 8036.

The piston 8020 passes bottom dead centre and ascends on the exhaust stroke and so the reed valve 8030 opens as the pressure in the crank volume 8026 reduces, allowing fresh charge gas to enter the crank volume 8026. At or near top dead centre, at an appropriate point in the cycle, the upper poppet valve 8040 opens, so allowing gas from the intermediate chamber 8036 to enter into the combustion chamber 8024. The secondary piston 8042, under the effect of the closed volume 8044 aids in urging the gas in the intermediate chamber 8040 into the combustion chamber 8024. The secondary piston 8042 can be used to alter the volume of intermediate chamber 8040, it need not in some embodiments actively urge the gas out of intermediate chamber 8040.

The piston 8020 passes top dead centre and starts to descend again, on its induction stroke, increasing pressure in the crank volume 8026. When the pressure in the crank volume 8026 is greater than that in the passageway 8032, the poppet valve 8038 opens, allowing pressurized gas in the crank volume 8026 into the passageway 8032 and thence to the combustion chamber 8024. At or near bottom dead centre, at an appropriate point in the cycle, the poppet valves 8038 and 8040 close and the piston 8020 passes bottom dead centre and starts to ascend on its compression stroke. The valves 8038 and 8042 may close simultaneously or at different points in the cycle. The pressure in the crank volume 8026 decreases, causing reed valve 8030 to open and allowing another fresh charge into the crank volume 8026.

At or near top dead centre, at an appropriate point in the cycle the reed valve 8030 closes and, at an appropriate point in the cycle the poppet valve 8038 opens and the cycle commences again. The valve 8030 may close simultaneously with the opening of valve 8038 or at a different point in the cycle.

FIG. 218 shows an internal combustion engine 8050. Like parts have the same numbering as in FIG. 217. In the internal combustion engine 8050 there is provided a crank volume 8026 which is connected directly to the combustion chamber 8024 via passageway 8052. The crank 8054 serves as or includes a disc valve 8056 to control communication between crank volume 8026 and the passageway 8052. The passageway 8052 serves the same function as the intermediate chamber 8036 of the FIG. 217 device, whilst the crank performs the same function as the poppet valve 8038 of the FIG. 217 device. As can be seen, the disc valve 8056 includes a cut away which opens the crank volume 8026 to the passageway 8052. It will be appreciated that the drawing is schematic and the size, shape and position of the cutaway and the number of cutaways or the disc valve 8056 may be different. It will be further appreciated that a separate disc or sleeve valve may be substituted for the crank valve 8056.

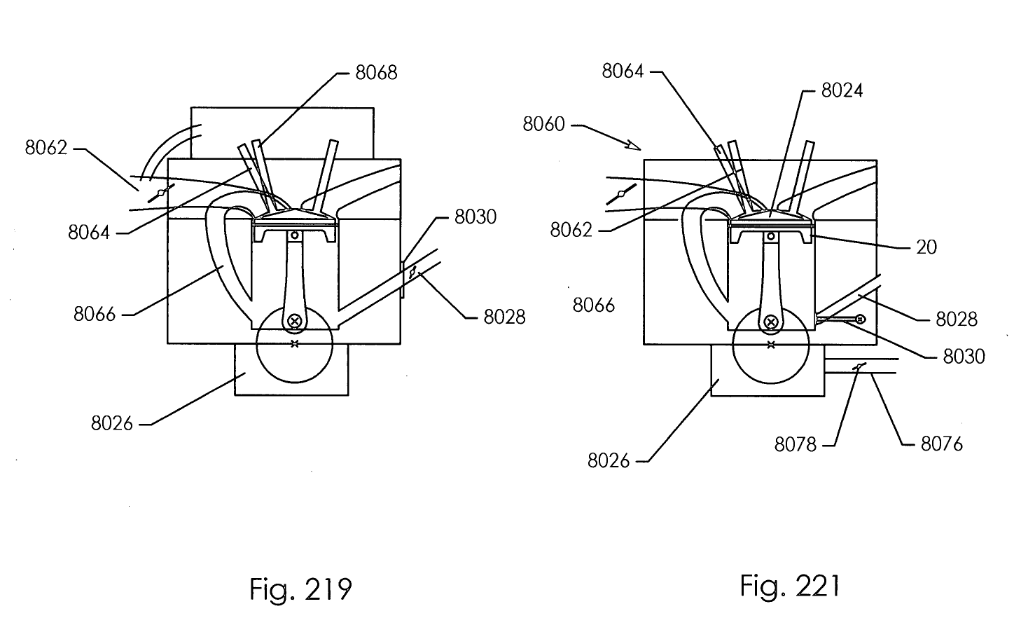

FIG. 219 shows an internal combustion engine 8060 and again like parts are numbered the same.

In this embodiment, the combustion chamber 8024 is provided with two independent inlets. The first inlet 8062 is a conventional inlet and feeds air and vaporized fuel directly to the combustion chamber 8024. Communication is controlled by poppet valve 8064. The crank volume 8026 is supplied with air and vaporized fuel via inlet 8028 and poppet valve 8030. The crank volume 8026 is connected to the combustion chamber 8024 via passageway 8066 and poppet valve 8068.

In use, the internal combustion engine functions as a conventional four stroke engine with air being drawn into the combustion chamber 8024 via inlet 8062 on the downward induction stoke. During this stroke, the reed valve 8030 and poppet valve 8068 are closed and the fuel air mixture in the crank volume 8026 is pressurized. At or near bottom dead centre at an appropriate point in the cycle, the poppet valve 8064 closes. At about the same point in the cycle, the poppet valve 8068 opens, allowing the pressurized fluid in the crank volume 8026 to pass into the combustion chamber 8024. Thus the amount of air and fuel in the combustion chamber 8024 is increased compared to a conventional normally aspirated internal combustion engine. The poppet valve 8068 closes whilst the piston 8020 is still near bottom dead centre, so trapping the extra fluid in the combustion chamber 8024. As the piston 20 rises on the compression stroke, a fresh charge is drawn into the crank volume 8026 via inlet 8038 and reed valve 8030. The reed valve and poppet valve remain closed until the commencement of the next induction stroke as previously described.

FIG. 220 shows a internal combustion engine 8070 having a crank volume 8026 which communicates with a secondary chamber 8072 via a rotary valve 8074. The crank volume 8026 communicates with the combustion chamber 8024 via passageway 8076 and poppet vale 8040. Again air and fuel is received into crank volume 8026 via inlet 8028 and reed valve 8030.

During a power stroke the poppet valve 8040 and reed valve 8030 are closed and the rotary valve 8074 is open, allowing the gas in the secondary chamber 8072 to be pressurized. At or near bottom dead centre the rotary valve 8074 closes, so that on the exhaust stroke a fresh charge is drawn into the crank volume 8026. At or near top dead centre, the reed valve closes and the poppet valve 8040 and rotary valve 8074 open, so allowing the pressurized gas in the crank volume 8026 to pass into the combustion chamber 8024 as the piston 8020 descends on the induction stroke. At or near bottom dead centre the poppet valve 8040 and rotary valve 8074 close and a second fresh charge is drawn in from the inlet 8028 as the piston 8020 ascends on the compression Stroke.

FIG. 221 shows a variation of the FIG. 219 device in which the crank volume 8026 is provided with a vent 8076 and valve 8078. The valve 8078 serves to selectively vent pressure in the crank volume 8026. The vent 8076 may be connected to the normin inlet 8062 or to the crank volume 8026 or inlet 8062 of another piston in a multi cylinder engine. The use of the vent 8076 ensures that the pressure in the crank volume 8026 is below the pressure in the inlet 8028 when it is desired for need valve 8030 to open. If the pressure in the crank volume 8026 is above that in the inlet 8028, reed valve 8030 will not open.

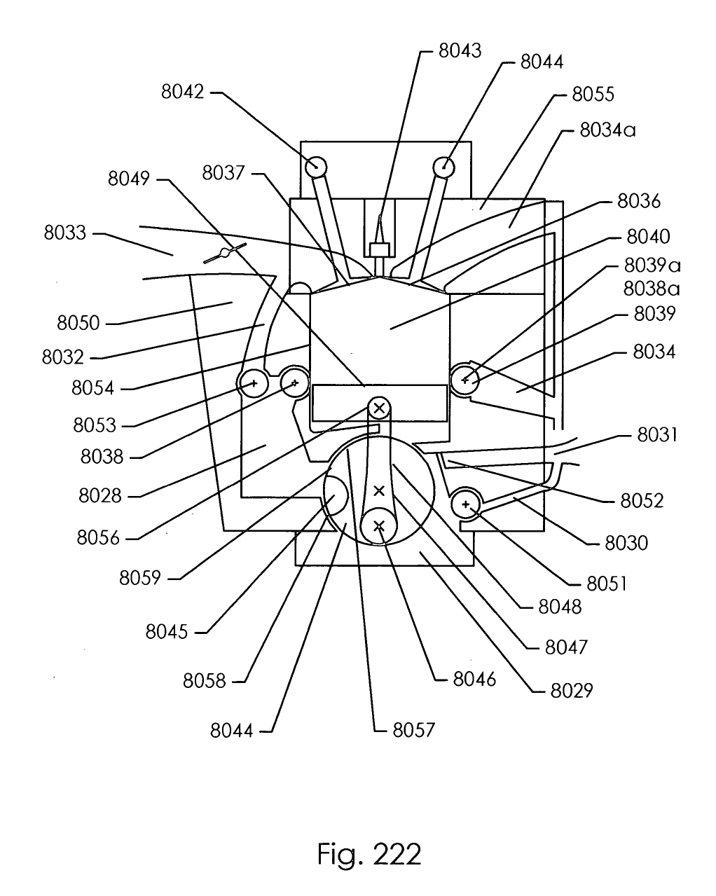

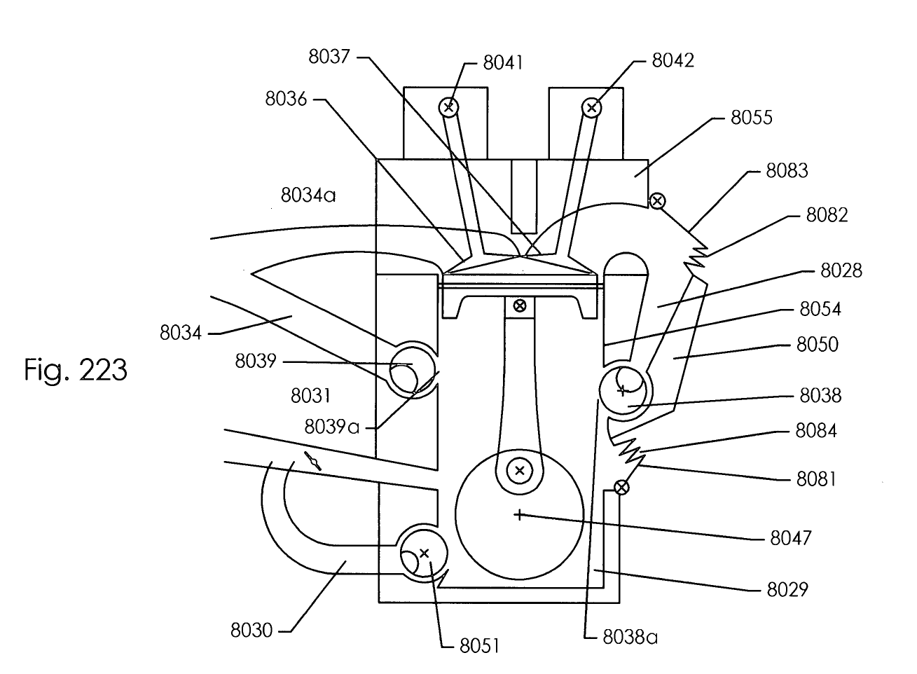

FIGS. 222 and 223 show preferred embodiments of the invention, i.e., an engine capable of operation either as a 2 stroke or a 4 stroke. The engine, when operating as a 2 stroke, may use an intake cylinder port for induction purposes and, the exhaust valves and tracts, that are located in the head, exclusively for exduction, or it may use the exhaust and intake ports [situated in the cylinder walls] exclusively, or it may use the cylinder wall intake port to induct the combustible fluid or working gas, and an exhaust port combined with “head situated exhaust valves” to exduct the spent gases. Or, further, it may use the cylinder wall exhaust port exclusively for exduction or may use the “head situated exhaust valves” and their tracts for induction. In fact, any combination that is desirable may be used.

When operating as a 4 stroke engine, in some embodiments it may use only the cylinder wall intake port to induct working gas and the cylinder wall exhaust port to exduct spent gas, or, in another preferred embodiment, the cylinder wall exhaust port and head situated exhaust valves in conjunction with the cylinder wall intake port and/or head situated intake valves and tracts, or a combination of both sets of port and head situated valves or a combination of one or more or less of each type of respiratory means.

The engine may be run as a normally aspirated 4 stroke engine, or in the one cycle, It may have a normally aspirated intake respiration phase and a forced induction phase, or it may have a forced induction phase with no normally aspirated phase, and, furthermore these phases may overlap if desired.

This is an engine that may be used as a constant volume or constant pressure engine. The engine may be used as a 2 stroke plus steam engine, in that out of a 720 degree cycle, the first 360 respirates and operates as a 2 stroke and the second 360 as a steam engine (a compound 2 stroke steam engine, if you like).

This engine may utilize in-cylinder injection or in-cylinder air and fuel injection or stratified charge principles or pre-combustion chambers or Miller cycle associated technologies or principles. This engine may be used as a compressor or engine brake in an automobile or industrial machine or other suitable application. This engine may change its operating principles on the fly, swapping from 2 stroke to 4 stroke and vice versa, of whatever respiratory format, that is best suited to or operator chosen for a given set of performance requirement/s. This engine may utilize an external super or turbo charging means, and may be provided with separate or combined exhaust systems for different operating parameters e.g. 2 or 4 stroke and their various cross-bred versions described herein.

FIGS. 222 and 223 show an engine block 9050, and a cylinder head 9055, a crank shaft axis 9047, a crank big end axis 9046, a connecting rod 9048, a gudgeon pin 9056, a piston 9049, a cylinder wall 9054, a variable volume chamber 9040, a crank case volume 9029, a head situated intake valve 9037, a head situated exhaust valve 9036, head situated intake and exhaust valve cam shafts 9042, 9041, cylinder wall intake port 9038am cylinder wall exhaust port 9039a, and their respective rotary valves 9038 and 9039, exhaust tracts 9034 and 9034a, intake tracts or volumes 9028, 9032, 9033, 9031, reed valve 9052, pressure bleed valve 9051, and its tract 9030, crank web disc valve 9044, and its ported cut out 9045, and its sealing regions 9058 and 9057.

Volume 9032 and its valve 9053 may be used to bleed off or dump excess pressure in intake volume 9028 and/or crank case volume 9029 and/or volume 9030. Intake tract 9030 and its valve 9051 may be used to bleed off or dump excess pressure in crank case volume 9029 intake volume 9028 and/or intake volume 9032. Excess pressure in any of the intake volumes may be dumped into intake manifold 9031 or 9033 or into the earth's atmosphere. Part 9028 is an intermediate chamber. Parts 9034 and 9034a are exhaust pipes. Rotary valves 9053, 9038, 9044, 9051, 9039 have been illustrated in these drawings mainly because they are easy to portray; other valve arrangements including ones not listed herein specifically are perhaps useful and in any case a person skilled in the art would doubtless find many alternative devices and layouts that would fit the spirit of the invention herein described without departing from the intent and purposes of it.

In FIG. 223 there are shown a variable intake tract volume means 9083, 9082, and variable crankcase volume means 9081, 9084. Like numbers in FIGS. 222 and 223 mean the same thing or are analogous. Looking at FIGS. 222 and 223 exhaust valves 9036 and 9039 may be timed to operate according to design requirements as with intake valves 9038, 9037, 9053, 9051, 9058. Part 9043 may be a spark plug or injector probe.

FIGS. 222 and 223 can be further understood by reading the general description of FIGS. 217 to 221; the intention is the same except a few variations have been added.

If variable compression ratios are desirable and said variance is caused by lifting or lowering the crank, the exhaust ports and intake ports and/or their valves' timing may be altered to suit new piston height. This is true for engines made in accordance with the teachings of these patent applications and for 2 stroke engines of normal construction.

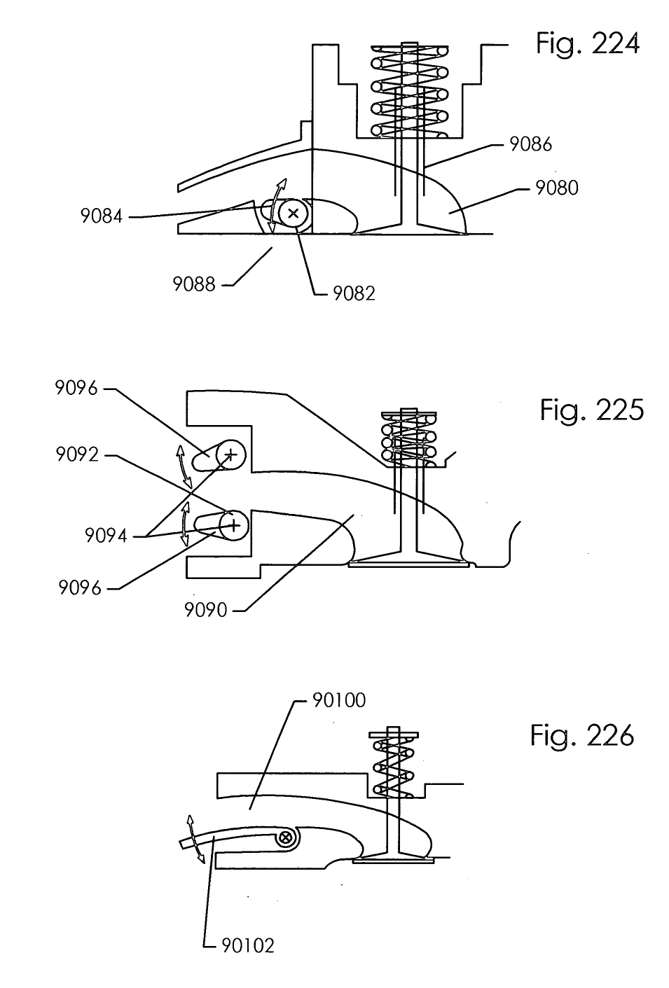

FIGS. 224 to 227 show arrangements for adjusting the velocity of fluid flowing into or out of a combustion chamber, whether in a conventional internal combustion engine or in an internal combustion engine of the present invention. These arrangements are applicable to all inlets where two or more separate inlets are provided, such as in the FIG. 219 embodiment and to the exhaust outlets.

FIG. 225 shows an inlet passageway 9080 having a rotating cam 9082 upstream of poppet valve 9086, which controls communication with the combustion chamber 9088. The cam 9082 rotates constantly and so periodically the lobe 9084 extends into the inlet passageway 9080, reducing the inlet passageway's cross sectional area. This has the effect of reducing the fluid flow or increasing the velocity of fluid flowing into the combustion chamber 9088, or both.

FIG. 224 shows an inlet passageway 9090 having two opposed cams 9092 which oscillate about respective axes 9094 so as to periodically extend lobe 9096 into the inlet passageway 9090. It will be appreciated that a single cam may be used instead.

FIG. 226 shows an inlet passageway 90100 having an oscillating arm 90102 to one side of the passageway. The arm 90102 oscillates about axis 90104 and so periodically extends into the passageway.

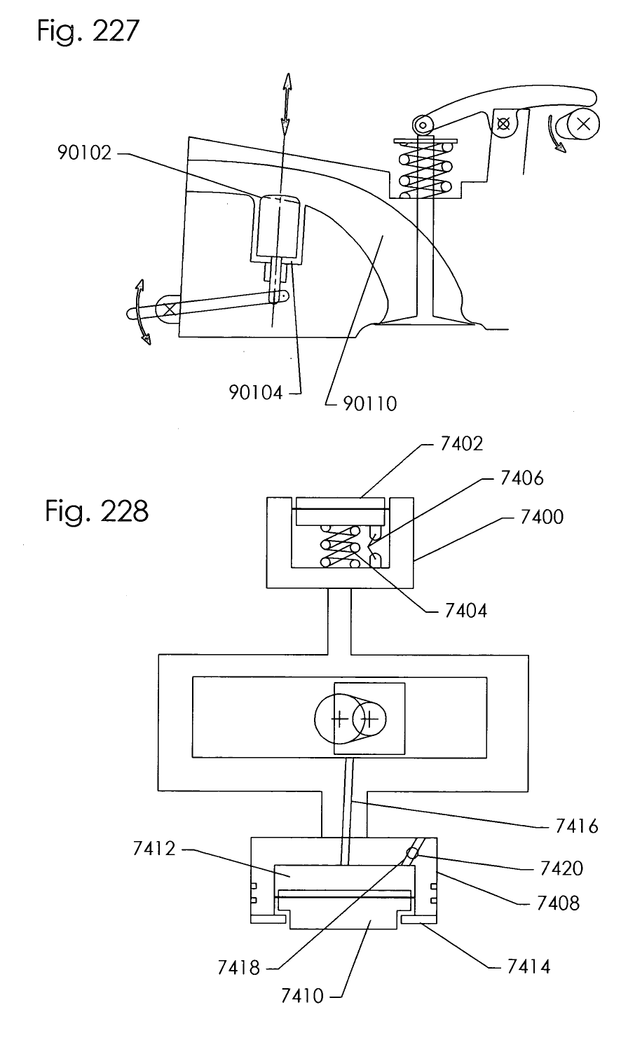

FIG. 227 shows an inlet passageway 90110 having an arm 90112 which reciprocates up and down in recess 90104 so as to periodically extend into the inlet passageway. The arm is controlled by lever arm 90106, but may be controlled by other means, such as hydraulically or electrically or by any suitable means.

In FIG. 228, there is shown a piston 7400 having located internally a displaceable member 7402 and a spring 7404 for resiliently modifying motion of member 7402. Keeper 7406 limits movement of member 7402 which in effect forms part of the crown of piston 7400.

For convenience, there is shown in FIG. 228 a second embodiment of the displaceable member, although in practice the second embodiment may not usually be combined with the first embodiment on the same scotch yoke fluid device.

In the second embodiment, piston 7408 has a displaceable member 7410 and a resilient modifier 7412, such as an oil reservoir or rubber block. Movement of member 7410 beyond the crown of piston 7408 is prevented by stop 7414.

This embodiment also includes fluid delivery passageway 7416 and decant or pressure overload passageway 7418, having a pressure overload valve 7420.

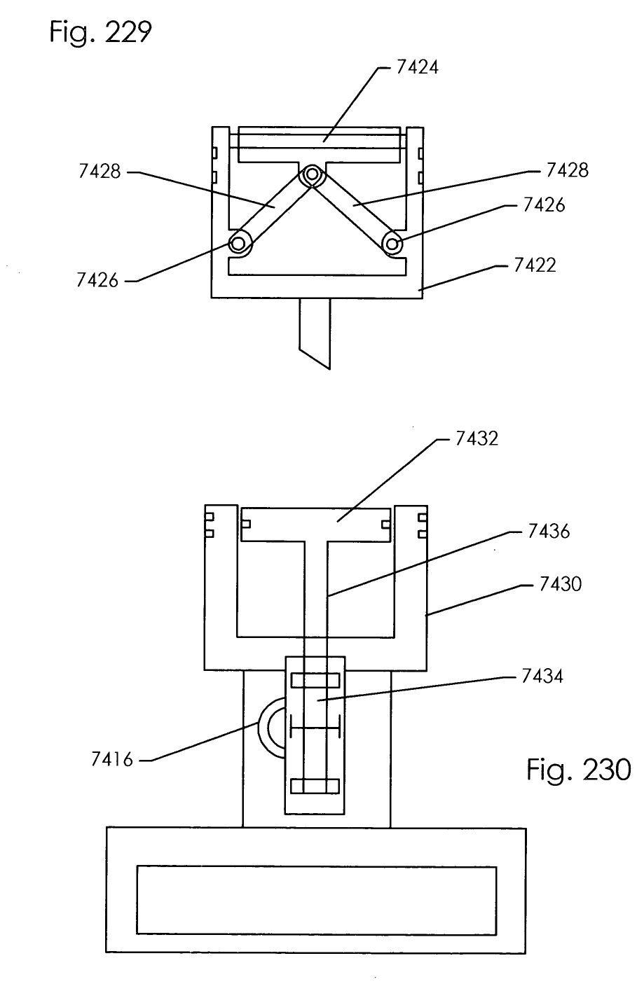

With reference to FIG. 229, piston 7422 includes displaceable member 7424, the upward motion of which is modified by modifier 7426 and connections 7428, connecting member 7424 to piston 7422.

In FIG. 230, piston 7430 includes displaceable member 7432. Hydraulic ram 7434 is connected to member 7432 by connector 7434.

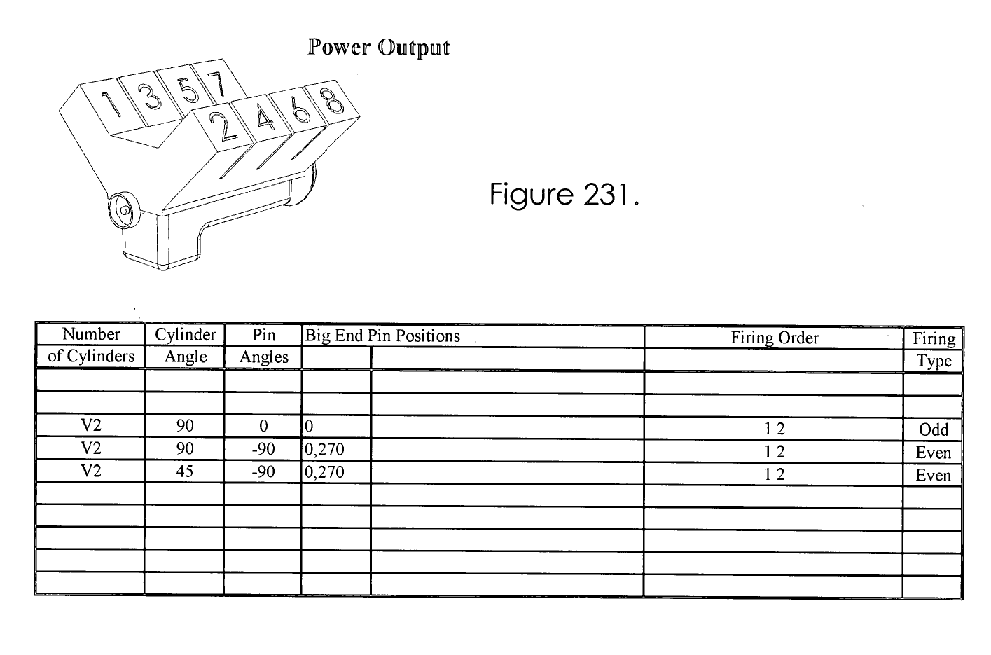

Turning now to the tables in FIGS. 231-235, it will be appreciated that the design illustrated at the top of each table is not necessarily indicative of the number of cylinders referred to in each row of each table. For example, in the table forming FIG. 231, there are only two cylinders, although the design at the top of the table shows eight cylinders.

As shown in FIG. 231, the method of varying power output invention where there are two cylinders can have a cylinder angle of 90 or 45 degrees. The pin angle (the offset between each set of big ends) is chosen as shown in the table. In the case of each of the combinations in FIG. 231, firing order is, first cylinder one and then cylinder two.

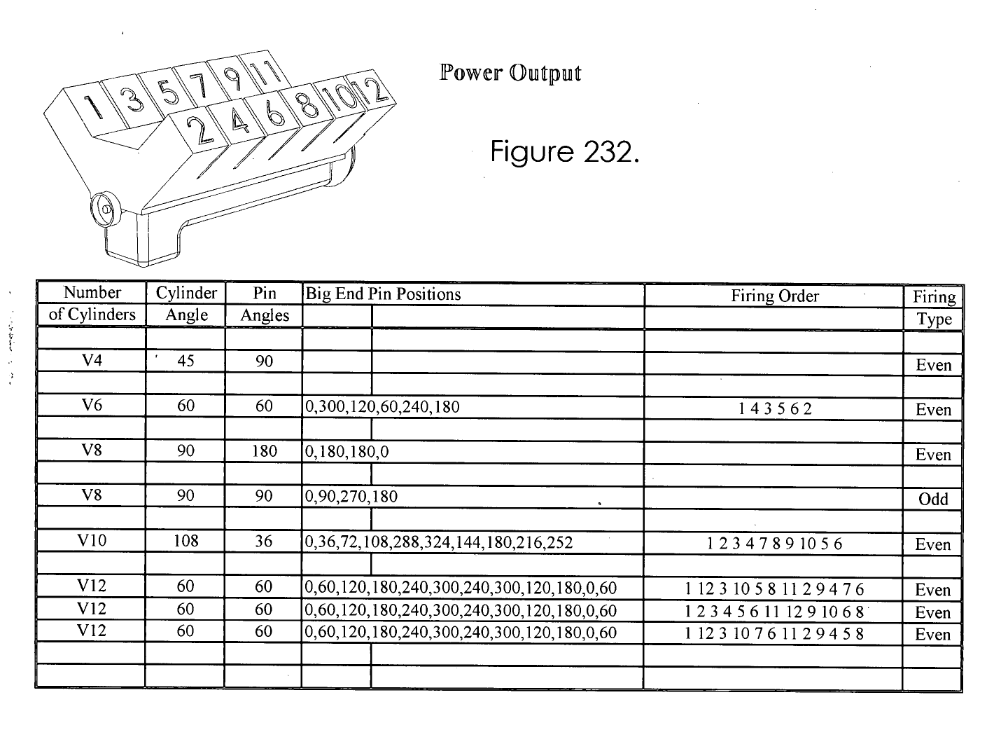

The table in FIG. 232 has a number of cylinders varying between four and twelve, in all cases in a “V” configuration.

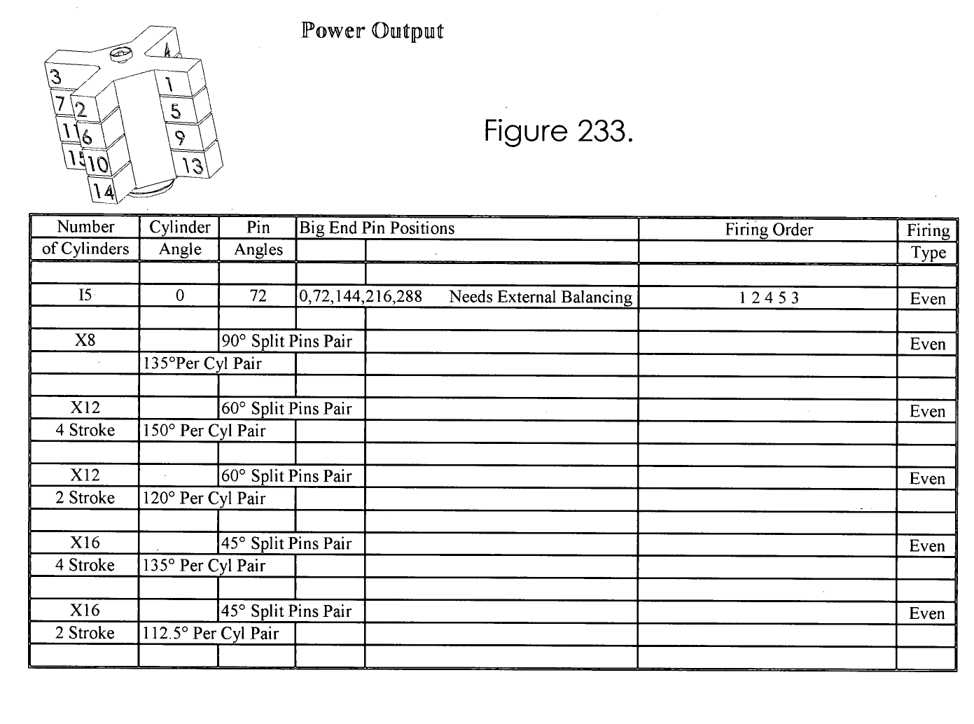

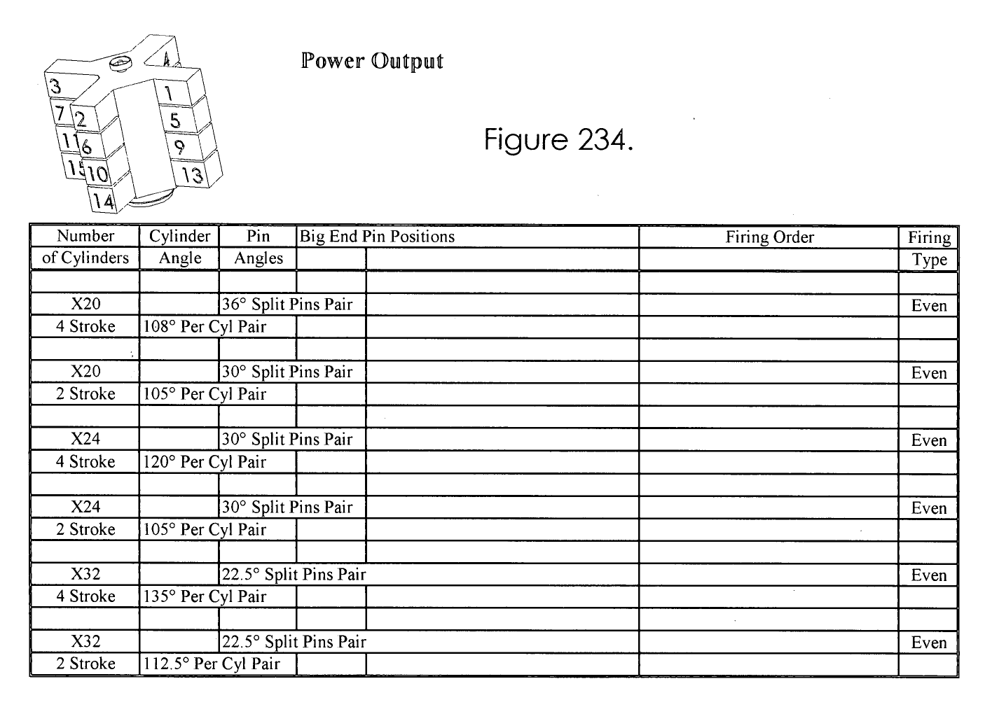

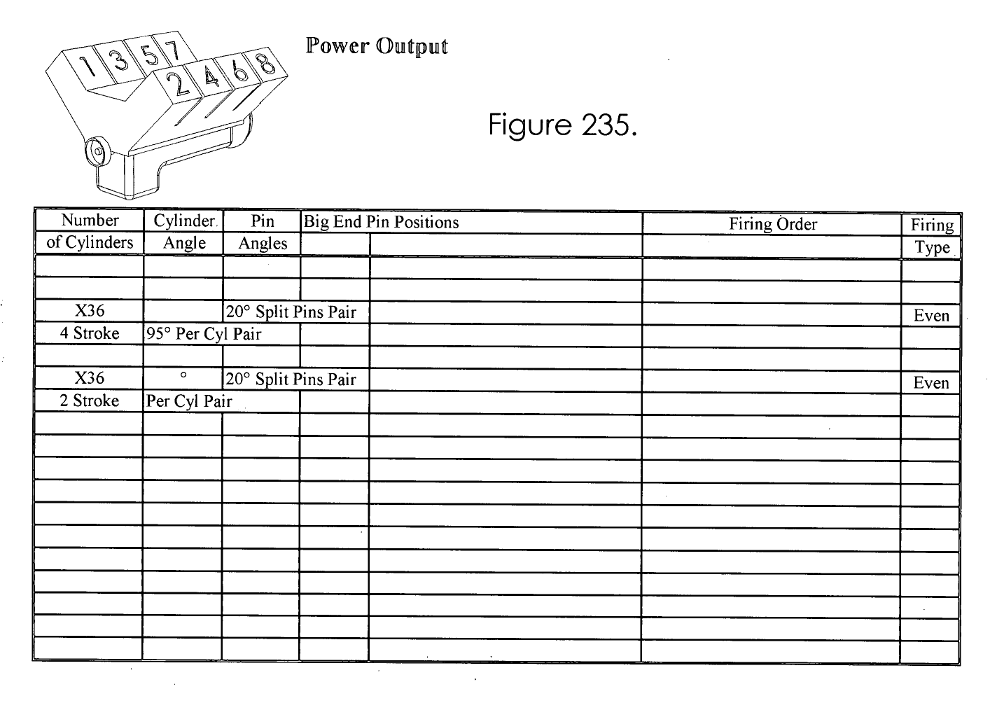

In the table comprising FIG. 233, in some cases the cylinders are arranged in an “X” configuration and can use four stroke or two stroke techniques. The same can be said for the table in FIGS. 234 and 235.

### INDUSTRIAL APPLICABILITY

The invention has industrial applicability in relation to fluid devices in general and more specifically to internal combustion engines and pumps.

What is claimed is:

1. A scotch yoke device for use in an internal combustion engine or fluid device comprising:
a crankcase or block arrangement including main bearing means and at least one guide bearing arrangement;
a crank arrangement, the crank arrangement comprising:
a crank having a main axis;
a big end bearing having a big end axis which orbits about the crank main axis; and
connecting means mounted on the big end bearing, the connecting means comprising engagement means; and
a piston arrangement, the piston arrangement comprising:
(a) at least one piston mounted for reciprocal motion in a cylinder along a cylinder axis of the cylinder, the piston having a piston axis and a piston cross-sectional area perpendicular to the piston axis;
(b) at least one first guide means, the first guide means including a linear bearing surface perpendicular to the piston axis, the first guide means bisecting a volume defined by the piston cross-sectional area projected along the piston axis and the first guide means engaging the engagement means on the connecting means; and
(c) at least one restricting means for constraining the piston to move along the cylinder axis,
wherein the piston arrangement, or a co-reciprocating member, is limited to a singular angular orientation relative to the cylinder axis.

2. The scotch yoke device according to claim 1, wherein the restricting means is located within the volume defined by the piston cross-sectional area projected along the piston axis, but the restricting means is not located along the centre line of the bisection formed by the first guide 5 means.

3. The scotch yoke device according to claim 1, wherein the at least one guide bearing means mounted on or attached to the crank case or block engages the at least one restricting means in the volume defined by the piston cross sectional area projected along the piston axis.

4. The scotch yoke device according to claim 1, wherein the restricting means extends both above and below the first guide means.

5. The scotch yoke device according to claim 1, wherein the connecting means is limited to a single angular orientation relative the cylinder axis by way of its engagement with the first guide means.

6. The scotch yoke device according to claim 1, wherein the piston arrangement is caused to reciprocate substantially parallel the cylinder axis by way of its engagement with connecting means.

7. The scotch yoke device according to claim 1, wherein the projected volume of the piston cross sectional area is passed through by the crank big end journal during the crank's cycle around its main axis.

8. The scotch yoke device according to claim 1, wherein the big end sweeps a volume in its orbital path around the crank main axis and the restricting means reciprocates partially into and then wholly out of the volume so swept.

9. The scotch yoke device according to claim 1, wherein the cyl axis is aligned along a plane which is perpendicular to the crank main axis.

10. The scotch yoke device according to claim 1, wherein the restricting means is caused to follow a linear path substantially parallel to the cylinder axis, whereby the pathway is defined by the at least one guide bearing arrangement of the crank case or block.
